(19) United States
(12) Patent Application Publication
(10) Pub. No.: US 2024/0303521 A1
(43) Pub. Date: Sep. 12, 2024

(54) RECONFIGURABLE QUBIT ENTANGLING SYSTEM

(71) Applicant: Psiquantum, Corp., Palo Alto, CA (US)

(72) Inventors: Mercedes Gimeno-Segovia, San Jose, CA (US); Terence Rudolph, San Francisco, CA (US); Mihir Pant, Mountain View, CA (US); Hector Bombin Palomo, Kyoto (JP); Naomi Nickerson, San Francisco, CA (US)

(73) Assignee: Psiquantum, Corp., Palo Alto, CA (US)

(21) Appl. No.: 18/273,745

(22) PCT Filed: Jan. 24, 2022
(86) PCT No.: PCT/US2022/013578

§ 371 Date: Jul. 21, 2023

Related U.S. Application Data
(60) Provisional application No. 63/140,784, filed on Jan. 22, 2021.
(60) Provisional application No. 63/293,592, filed on Dec. 23, 2021.

(51) Int. Cl. G06N 10/40

(52) U.S. Cl. CPC G06N 10/40

(57) ABSTRACT

According to some embodiments, a system includes a first input coupled to a first qubit and a first switch, wherein the first switch includes a first output, a second output, and a third output. The system further includes a first single qubit measuring device coupled to the first output of the first switch and a second single qubit measuring device coupled to a first output of a second switch. The system further includes a first two qubit measuring device coupled to the second output of the first switch and a second output of the second switch and a second two qubit measuring device coupled to the third output of the first switch and a third output of the second switch.

### CROSS-REFERENCE TO RELATED APPLICATION

This application claims priority to U.S. Provisional Application No. 63/140,784, filed Jan. 22, 2021, entitled “Fusion Based Quantum Computing” and U.S. Provisional Application No. 63/293,592, filed Dec. 23, 2021, entitled “Reconfigurable Qubit Fusion System”, each of which is incorporated by reference herein in its entirety.

### TECHNICAL FIELD

One or more embodiments generally to quantum technology devices (e.g., hybrid electronic/photonic devices) and, more specifically, to quantum technology devices for generating entangled states of qubits (e.g., entangled states that can be used as resources for quantum computing, quantum communication, quantum metrology, and other quantum information processing tasks) and systems and methods to generate syndrome graph data that can be used for quantum error correction within a fault tolerant quantum computing system. One or more embodiments of the present disclosure relate generally to quantum computing devices and methods and, more specifically, to fault tolerant quantum computing devices and methods.

### BACKGROUND

In fault tolerant quantum computing, quantum error correction is required to avoid an accumulation of qubit errors that then leads to erroneous computational outcomes. One method of achieving fault tolerance is to employ error correcting codes (e.g., topological codes) for quantum error correction. More specifically, a collection of physical qubits can be generated in an entangled state (also referred to herein as an error correcting code) that encodes for a single logical qubit that is protected from errors.

In some quantum computing systems, cluster states of multiple qubits, or, more generally, graph states can be used as the error correcting code. A graph state is a highly entangled multi-qubit state that can be represented visually as a graph with nodes representing qubits and edges representing entanglement between the qubits. However, various problems that either inhibit the generation of entangled states or destroy the entanglement once created have frustrated advancements in quantum technologies that rely on the use of highly entangled quantum states.

Furthermore, in some qubit architectures, e.g., photonic architectures, the generation of entangled states of multiple qubits is an inherently probabilistic process that may have a low probability of success.

Accordingly, there remains a need for improved systems and methods for quantum computing that do not necessary rely on large cluster states of qubits.

### SUMMARY

Described herein are embodiments of a reconfigurable qubit entangling system in accordance with one or more embodiments.

According to some embodiments, a method can comprise: receiving a plurality of quantum systems, wherein each quantum system of the plurality of quantum system includes a plurality of quantum sub-systems in an entangled state, and wherein respective quantum systems of the plurality of quantum systems are independent quantum systems that are not entangled with one another; performing a plurality of destructive joint measurements (such as fusion operations) on different quantum sub-systems from respective ones of the plurality of quantum systems, wherein the destructive joint measurements destroy the different quantum sub-systems and generate joint measurement outcome data and transfer quantum state information from the different quantum sub-systems to other unmeasured quantum sub-systems from the plurality of quantum systems; and determining a logical qubit state based on the joint measurement outcome data. The logical qubit state can be determined in a fault tolerant manner.

According to some embodiments, a method can comprise: receiving a plurality of quantum systems, wherein each quantum system of the plurality of quantum system includes a plurality of quantum sub-systems in an entangled state, and wherein respective quantum systems of the plurality of quantum systems are independent quantum systems that are not entangled with one another; performing a logical qubit gate by performing a plurality of destructive joint measurements (such as fusion operations) on different quantum sub-systems from respective ones of the plurality of quantum systems, wherein the destructive joint measurements destroy the different quantum sub-systems and generate joint measurement outcome data and transfer quantum state information from the different quantum sub-systems to other unmeasured quantum sub-systems from the plurality of quantum systems; and determining a result of the logical qubit gate based on the joint measurement outcome data. The result of the logical qubit gate can be determined in a fault tolerant manner.

According to some embodiments, a quantum computing apparatus can comprise: a qubit entangling system to generate a plurality of quantum systems, wherein each quantum system of the plurality of quantum systems includes a plurality of quantum sub-systems in an entangled state, and wherein respective quantum systems of the plurality of quantum systems are independent quantum systems that are not entangled with one another; a qubit fusion system to perform a plurality of destructive joint measurements on different quantum sub-systems from respective ones of the plurality of quantum systems, wherein the destructive joint measurements destroy the different quantum sub-systems and generate joint measurement outcome data and transfer quantum state information from the different quantum sub-systems to other unmeasured quantum sub-systems from the plurality of quantum systems; and a classical computing system to determine a logical qubit state based on the joint measurement outcome data.

According to some embodiments, a quantum computing apparatus can comprise: a qubit entangling system to generate a plurality of quantum systems, wherein each quantum system of the plurality of quantum systems includes a plurality of quantum sub-systems in an entangled state, and wherein respective quantum systems of the plurality of quantum systems are independent quantum systems that are not entangled with one another; a qubit fusion system to perform a logical qubit gate by performing a plurality of destructive joint measurements on different quantum sub-systems from respective ones of the plurality of quantum systems, wherein the destructive joint measurements destroy the different quantum sub-systems and generate joint measurement outcome data and transfer quantum state information from the different quantum sub-systems to other unmeasured quantum sub-systems from the plurality of quantum systems; and a classical computing system to determine a result of the logical qubit gate based on the joint measurement outcome data.

According to some embodiments, a system includes a first input coupled to a first qubit and a first switch, wherein the first switch includes a first output, a second output, and a third output. The system further includes a first single qubit measuring device coupled to the first output of the first switch and a second single qubit measuring device coupled to a first output of a second switch. The system further includes a first two qubit measuring device coupled to the second output of the first switch and a second output of the second switch and a second two qubit measuring device coupled to the third output of the first switch and a third output of the second switch.

In some embodiments, the system further includes a fusion network controller circuit that is coupled to the first and second switch.

In some embodiments, the system further includes a decoder coupled to an output of the first single qubit measuring device, an output of the second single qubit measuring device, an output of the first two qubit measuring device, and an output of the second two qubit measuring device.

In some embodiments, the first qubit is entangled with one or more other qubits as part of a first resource state and the second qubit is entangled with one or more other qubits as part of a second resource state and none of the qubits from the first resource state are entangled with any of the qubits from the second resource state.

In some embodiments, the first and second two qubit measuring device are configured to perform destructive joint measurements on first qubit and the second qubit and to output classical information representing joint measurement outcomes.

In some embodiments, the first qubit and second qubit are photonic qubits.

In some embodiments, the coupling between the first and second qubits and the first and second switched includes a plurality of photonic waveguides.

In some embodiments, the first single qubit measuring device is configured to measure the first qubit in a Z basis.

In some embodiments, the second single qubit measuring device is configured to measure the second qubit in a Z basis.

In some embodiments, the first two qubit measuring device is configured to perform a projective Bell measurement between the first qubit and the second qubit.

In some embodiments, the second two qubit measuring device is configured to perform a projective Bell measurement between the first qubit and the second qubit.

In some embodiments, the projective Bell measurement is a linear optical Type II fusion measurement.

In some embodiments, the projective Bell measurement is a linear optical Type II fusion measurement.

The following detailed description, together with the accompanying drawings, will provide a better understanding of the nature and advantages of the claimed invention.

### BRIEF DESCRIPTION OF THE DRAWINGS

Aspects of the present disclosure are illustrated by way of example. Non-limiting and non-exhaustive aspects are described with reference to the following figures, wherein like reference numerals refer to like parts throughout the various figures unless otherwise specified.

FIGS. 1A-1C are diagrams illustrating a cluster state and corresponding syndrome graph for an entangled state of physical qubits in accordance with some embodiments.

FIG. 2 shows a quantum computing system in accordance with one or more embodiments.

FIGS. 3A-3D shows a quantum computing system in accordance with some embodiments.

FIG. 4A illustrates an example of fusion network in accordance with some embodiments.

FIG. 4B shows a quantum computing system in accordance with some embodiments.

FIG. 5 shows one example of qubit fusion system in accordance with some embodiments.

FIG. 6 shows a resource state in accordance with some embodiments.

FIG. 7 shows one example of qubit fusion system in accordance with some embodiments.

FIGS. 8A-8C show an example of a fusion network along with the explicit definition of certain groups in accordance with some embodiments.

FIGS. 9A-9E show an example of a fusion network along with the explicit definition of certain groups in accordance with some embodiments.

FIGS. 10A-10E show an example of a fusion network in accordance with some embodiments.

FIG. 11 shows numerically computed error tolerances for various fusion networks and resource states in accordance with some embodiments.

FIG. 12 shows numerically computed error tolerances for various fusion networks and resource states in accordance with some embodiments.

FIGS. 13A-13D illustrate a simple example of how primal and dual boundaries can be created by measuring certain qubits in the Z basis in accordance with some embodiments.

FIGS. 14A-14E show an example of a fusion router that provides routing that generates the 6-ring fusion network using photonic resource state generators, optical routing and linear optical fusion in accordance with some embodiments.

FIGS. 15A and 15B show two other embodiments of networked RSG circuits that could be employed, e.g., in a matter based qubit architecture, such as trapped ions, superconducting qubits and the like in accordance with some embodiments.

FIG. 16 shows an example of a quantum circuit which employs logical feedforward in accordance with some embodiments.

FIG. 17 shows a diagram of the classical information flowing into and out of a quantum computing system in accordance with some embodiments.

FIG. 18 shows an example configuration of a decoding system that include both buffering and decoder parallelization in accordance with some embodiments.

FIG. 19 shows photonic hardware components within a linear optical quantum computer in accordance with some embodiments.

FIG. 20 shows an example of a multiplexed single photon source in accordance with one or more embodiments.

FIG. 21 shows one possible example of a fusion site as configured to operate with a fusion controller to provide measurement outcomes to a decoder for fault tolerant quantum computation in accordance with some embodiments.

FIGS. 22A-22C illustrates a fusion based quantum computing scheme for fault tolerant quantum computation in accordance with one or more embodiments.

FIGS. 23A-23C show one example of a lattice preparation protocol for fusion based quantum computing in accordance with some embodiments.

FIGS. 24A-24B show one example of a lattice preparation protocol for fusion based quantum computing in accordance with some embodiments.

FIGS. 25A-25E shows a flow chart and example lattice preparation protocol for illustrating a method for fusion based quantum computing in accordance with one or more embodiments.

FIGS. 26A-26E show representations of dual-rail-encoded photonic qubits and photonic circuits for performing unitary operation on photonic qubits in accordance with some embodiments.

FIGS. 27A-27B show representations of dual-rail-encoded photonic qubits and photonic circuits for performing unitary operation on photonic qubits in accordance with some embodiments.

FIG. 28 shows photonic implementations of beam splitters that may be used to implement one or more spreaders, e.g., Hadamard gates, according to some embodiments.

FIG. 29 shows photonic implementations of beam splitters that may be used to implement one or more spreaders, e.g., Hadamard gates, according to some embodiments.

FIG. 30 shows one example of a Bell state generator circuit that can be used in some dual-rail-encoded photonic embodiments.

FIG. 31 shows an example of a Type II fusion circuit for a polarization encoding according to some embodiments.

FIG. 32 shows an example of a Type II fusion circuit for a path encoding according to some embodiments.

FIGS. 33A-33D shows effects of fusion in the generation of a cluster state according to some embodiments.

FIG. 34 shows examples of Type II fusion gates boosted once in polarization and path encodings according to some embodiments.

FIG. 35 shows a table with variations of the Type II fusion gate for different measurement basis in a polarization encoding.

FIG. 36 shows examples of photonic circuit variations of the Type II fusion gate for different choice of measurement basis in a path encoding according to some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

### I. Introduction to Quantum Computing

Quantum computation is often considered in the framework of ‘Circuit Based Quantum Computation’ (CBQC) in which operations (or gates) are performed on physical qubits. Gates can be either single qubit unitary operations (rotations), two qubit entangling operations such as the CNOT gate, or other multi-qubit gates such as the Toffoli gate.

Measurement Based Quantum Computation (MBQC) is another approach to implementing quantum computation. In the MBQC approach, computation proceeds by first preparing a particular entangled state of many qubits, commonly referred to as a cluster state, and then carrying out a series of single qubit measurements on the cluster state to enact the quantum computation. In this approach, the choice of single qubit measurements is dictated by the quantum algorithm being run on the quantum computer. In the MBQC approach, fault tolerance can be achieved by careful design of the cluster state and using the topology of this cluster state to encode logical qubits that are protected against any logical errors that may be caused by errors on any of the physical qubits that make up the cluster state. In practice, the value of the logical qubit can be determined, i.e., read out, based on the results (also referred to herein as measurement outcomes) of the single-particle measurements that are made on the cluster state's physical qubits as the computation proceeds.

However, the generation and maintenance of long-range entanglement across the cluster state and subsequent storage of large cluster states can be a challenge. For example, for any physical implementation of the MBQC approach, a cluster state containing many thousands, or more, of mutually entangled qubits must be prepared and then stored for some period of time before the single-qubit measurements are performed. For example, to generate a cluster state representing a single logical error corrected qubit, each of the collection of underlying physical qubits can be prepared in the |+ [symbol] state and a controlled-phase gate (CZ) can be applied between each physical qubit pair to generate the overall cluster state. More explicitly, a cluster state of highly entangled qubits can be described by the undirected graph G=(V, E) with V and E denoting the sets of vertices and edges, respectively, and can be generated as follows: 1) initialize all the physical qubits to be in the |+ [symbol] state, where

$$\vert + 〉 = \frac{( \vert 0 〉 + \vert 1 〉 )}{\sqrt{2}} ;$$

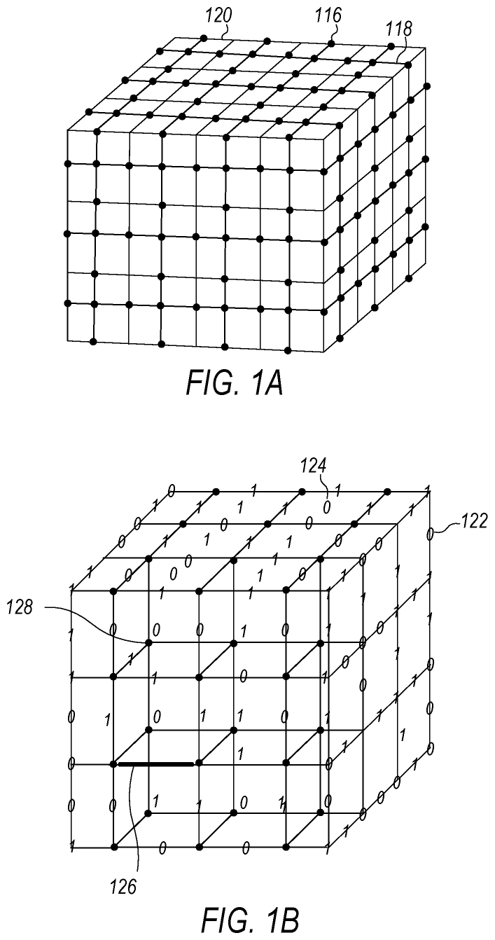

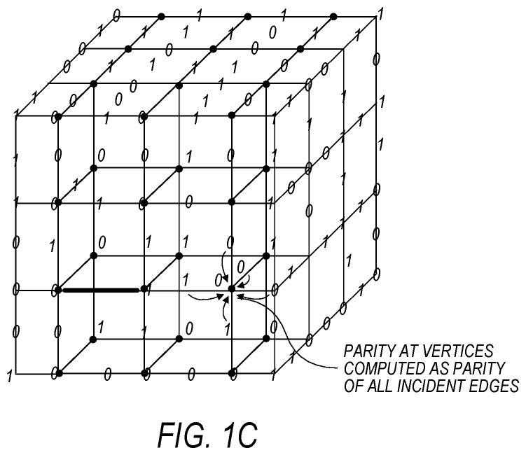

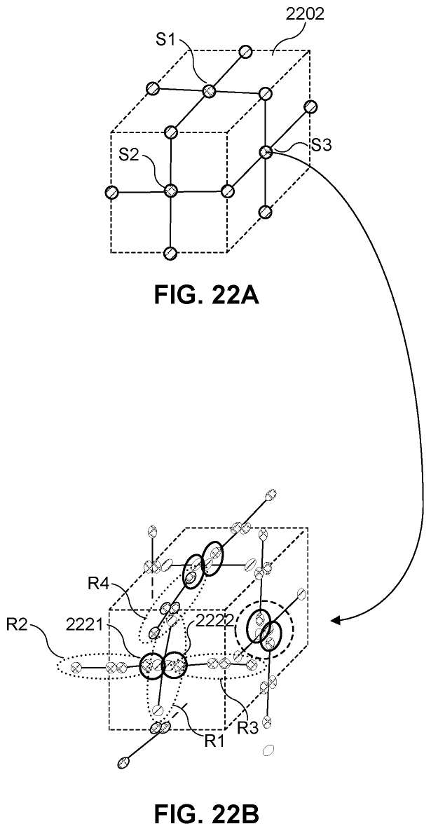

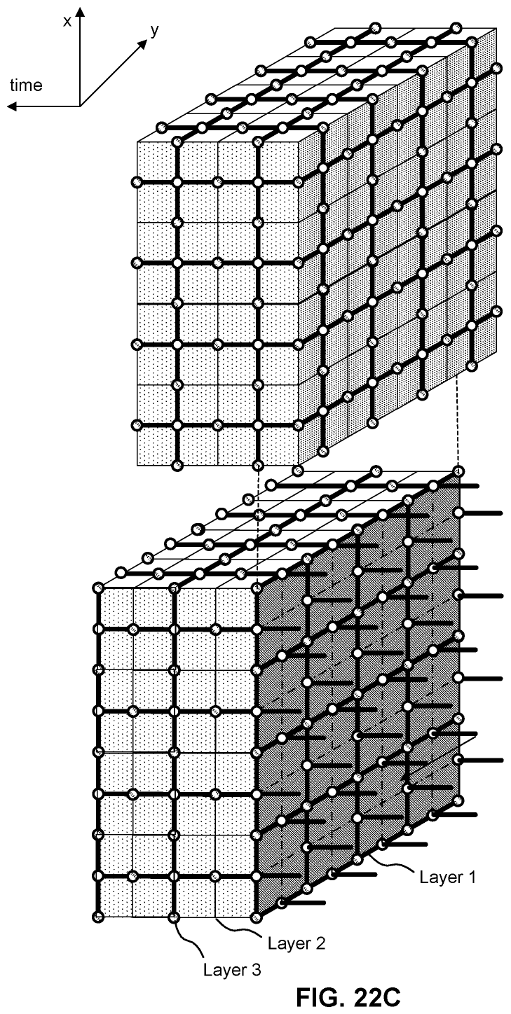

and 2) apply the controlled-phase gate (CZ) to each pair i,j of qubits. Accordingly, any cluster state, which physically corresponds to a large entangled state of physical qubits, can be described as

$${{\vert Ψ 〉}_{graph} = {\prod }_{( i , j ) ∈ E} {CZ}_{i , j} \vert + 〉}^{⊗ \vert V \vert} \qquad ( 1 )$$

where the CZ_{i,j} is the controlled phase gate operator and with V and E as defined above. Graphically, the cluster states defined by Eq. (1) can also be represented by a graph with vertices V that represent the physical qubits (initialized in the |+ [symbol] state) and edges E that represent entanglement between them (i.e., the application of the various CZ gates). In some cases, e.g., cases involving a fault tolerant MBQC scheme, |Ψ [symbol] _{graph} can take the form of a graph in 3 dimensions. Like the examples shown in FIG. 1A and FIG. 22, such a graph can have a regular structure formed from repeating unit cells and is therefore often referred to as a “lattice.” When represented as a 3-dimensional lattice, 2-dimensional boundaries of this lattice can be identified. Qubits belonging to those boundaries are referred to as “boundary qubits” while all other qubits are referred to as “bulk qubits”.

After |Ψ [symbol] _{graph} is generated, this large state of mutually entangled qubits must be preserved long enough for a stabilizer measurement to be performed, e.g., by making X measurements on all physical qubits in the bulk of the lattice and Z measurements on the boundary qubits.

FIG. 1A shows one example of a fault tolerant cluster state that can be used in MBQC, the topological cluster state introduced by Raussendorf et al., and commonly referred to as the Raussendorf Lattice as described in further detail in Robert Raussendorf, Jim Harrington, and Kovid Goyal. A., Fault-Tolerant One-Way Quantum Computer, Annals of Physics, 321(9):2242-2270, 2006. The cluster state is in the form of repeating lattice cells (e.g., cell 120) with physical qubits (e.g., physical qubit 116) arranged on the faces and edges of the cells. Entanglement between the physical qubits is represented by edges that connect the physical qubits (e.g., edge 118), with each edge representing the application of the CZ gate, as described above in reference to Eq. (1). The cluster state shown here is merely one example among many and other topological error correcting codes can be used without departing from the scope of the present disclosure. For example, volume codes such as those disclosed within International Patent Application Publication No. WO/2019/173651, the contents of which is hereby incorporated by reference in its entirety for all purposes, can be used. Also the codes based on non-cubical unit cells described in International Patent Application Publication No. WO/2019/178009, the contents of which is hereby incorporated by reference in its entirety for all purposes, can be used without departing from the scope of the present disclosure. Furthermore, while the example shown here is represented in three spatial dimensions, the same structure may also be obtained from other implementations of codes that are not based on a purely spatial entangled cluster state, but rather can include both entanglement in 2D space and entanglement in time, e.g., a 2+1D surface code implementation can be used or any other foliated code. For cluster state implementation of such codes, all of the quantum gates needed for fault tolerant quantum computation can be constructed by making a series of single particle measurements to the physical qubits that make up the lattice.

Returning to FIG. 1A, a chunk of a Raussendorf lattice is shown. Such an entangled state can be used to encode one or more logical qubits (i.e., one or more error corrected qubits) using many entangled physical qubits. The collection of single particle measurement results of the multiple physical qubits (e.g., physical qubit 116) can be used for correcting errors and for performing fault tolerant computations on the logical qubits through the use of a decoder. Many decoders are available with one example being the Union-Find decoder as described in International Patent Application Publication No. WO2019/002934A1, the disclosure of which is hereby incorporated by reference in its entirety for all purposes. One of ordinary skill will appreciate that the number of physical qubits required to encode a single logical qubit can vary depending on the precise nature of the physical errors, noise, etc., that are experienced by the physical qubits, but to achieve fault tolerance, all proposals to date require entangled states of thousands of physical qubits to encode a single logical qubit. Generating and maintaining such a large entangled state remains a key challenge for any practical implementation of the MBQC approach.

FIGS. 1B-1C illustrate how the decoding of a logical qubit can proceed for a cluster state based on the Raussendorf lattice. As can be seen in FIG. 1A, the geometry of the cluster state is related to the geometry of a cubic lattice (lattice cell 120) shown superimposed on the clusters state in FIG. 1A. FIG. 1B shows the single particle measurement results (also superimposed on the cubic lattice) after the state of each physical qubit of the cluster state has been measured, with the measurement results being placed in the former position of the physical qubit that was measured (for clarity only measurement results that result from measurements of the surface qubits are shown).

In some embodiments, a measured qubit state can be represented by a numerical bit value of either 1 or 0 after all qubits have been measured, e.g., in the x basis, with the 1 bit value corresponding to the +x measurement outcome and the 0 but value corresponding to −x measurement outcomes (or vice versa). There are two types of qubits, those that are located on the edges of a unit cell (e.g. at edge qubit 122), and those that are located on the faces of a unit cell (e.g., face qubit 124). In some cases, a measurement of the qubit may not be obtained, or the result of the qubit measurement may be invalid. In these cases, there is no bit value assigned to the location of the corresponding measured qubit, but instead the outcome is referred to herein as an erasure, illustrated here as thick line 126, for example. These measurement outcomes that are known to be missing can be reconstructed during the decoding procedure.

To identify errors in the physical qubits, a syndrome graph can be generated from the collection of measurement outcomes resulting from the measurements of the physical qubits. For example, the bit values associated with each edge qubit can be combined to create a syndrome value associated with the vertex the results from the intersection of the respective edges, e.g., vertex 128 as shown in FIG. 1B. A set of syndrome values, also referred to herein as parity checks, are associated with each vertex of the syndrome graph, as shown in FIG. 1C. More specifically, in FIG. 1C, the computed values of some of the vertex parity checks of the syndrome graph are shown. In some embodiments, a parity computation entails determining whether the sum of the edge values incident on a given vertex is an even or odd integer, with the parity result for that vertex being defined to be the result of the sum mod 2. If no errors occurred in the quantum state, or in the qubit measurement then all syndrome values should be even (or 0). On the contrary, if an error occurs, it will result in some odd (or 1) syndrome values. Only half of the bit values from qubit measurement are associated with the syndrome graph shown (the bits aligned with the edges of the syndrome graph). There is another syndrome graph that contains all the bit values associated with the faces of the lattice shown. This leads to an equivalent decoding problem on these bits.

As mentioned above, the generation and subsequent storage of large cluster states of qubits can be a challenge. However, some embodiments, methods and systems described herein provide for the generation of a set of classical measurement data (e.g., a set of classical data corresponding to syndrome graph values of a syndrome graph) that includes the necessary correlations for performing quantum error correction, without the need to first generate a large entangled state of qubits in an error correcting code. For example, embodiments disclosed herein describe systems and methods whereby two-qubit (i.e., joint) measurements, also referred to herein as “fusion measurements” or “fusion gates” can be performed on a collection of much smaller entangled states to generate a set of classical data that includes the long-range correlations necessary to generate and decode the syndrome graph for a particular chosen cluster state, without the need to actually generate the cluster state. In other words, in some systems and methods described herein, there is only ever generated a collection of relatively small entangled states (referred to herein as resource states) and then joint measurements are performed on these resource states directly to generate the syndrome graph data without the need to first generate (and then measure) a large cluster state that forms a quantum error correcting code (e.g., a topological code such as the Raussendorf lattice).

For example, as will be described in further detail below, in the case of linear optical quantum computing using a Raussendorf lattice code structure, to generate the syndrome graph data, a fusion gate can be applied to a collection small entangled states (e.g., 4-GHZ states) that are themselves not entangled with each other and thus are never part of a larger Raussendorf lattice cluster state. Despite the fact that qubits from the individual resource states were not mutually entangled prior to the fusion measurement, the joint measurement outcomes that result from the fusion measurements generate a syndrome graph that includes all the necessary correlations to perform quantum error correction. Such systems and methods are referred to herein as Fusion Based Quantum Computing (FBQC). Advantageously, the resource states have a size that is independent of the computation being performed or code distance used, which is in stark contrast to the cluster states of MBQC. This allows the resource states used for FBQC to be generated by a constant number of sequential operations. As a result, in FBQC, errors in the resource state are bounded, which is important for fault-tolerance.

### II. A System for FBQC

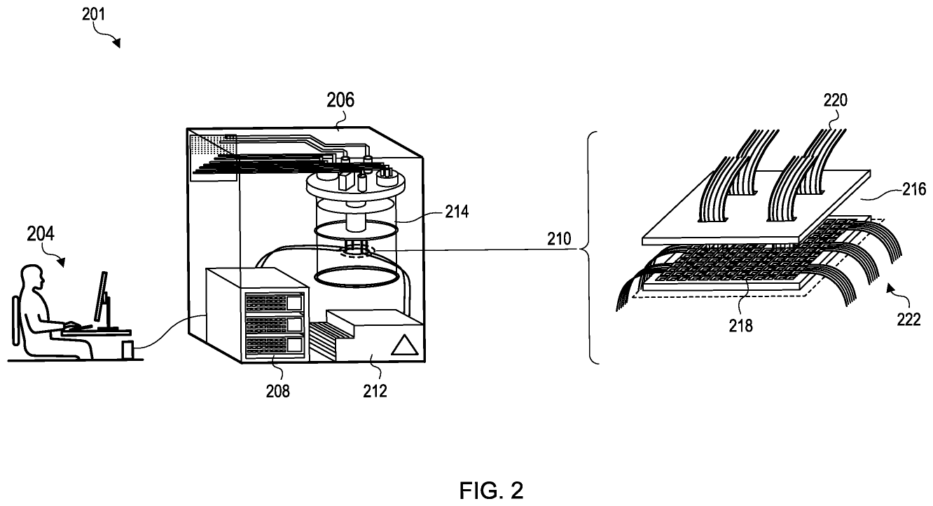

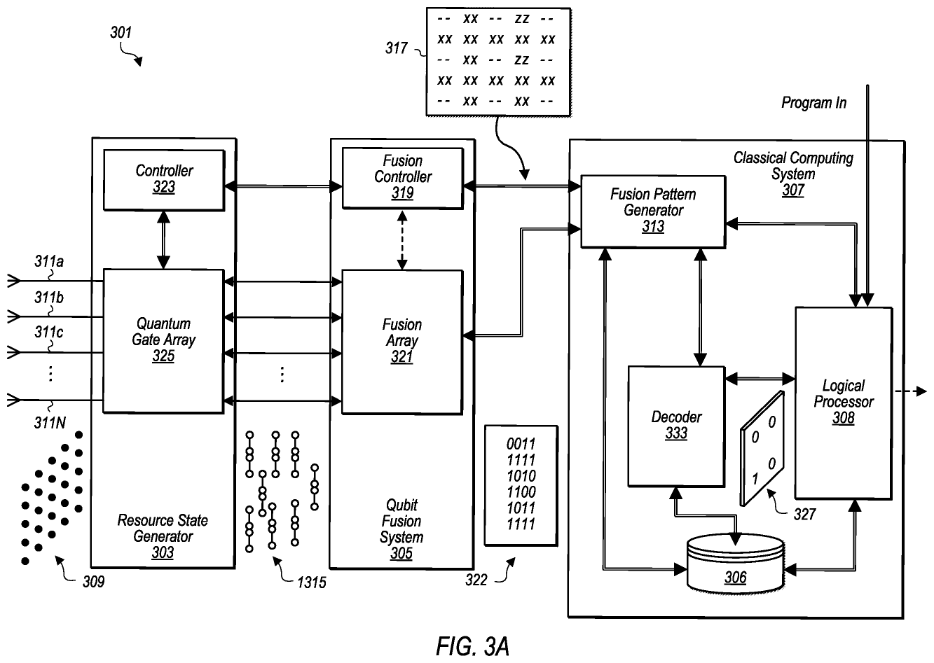

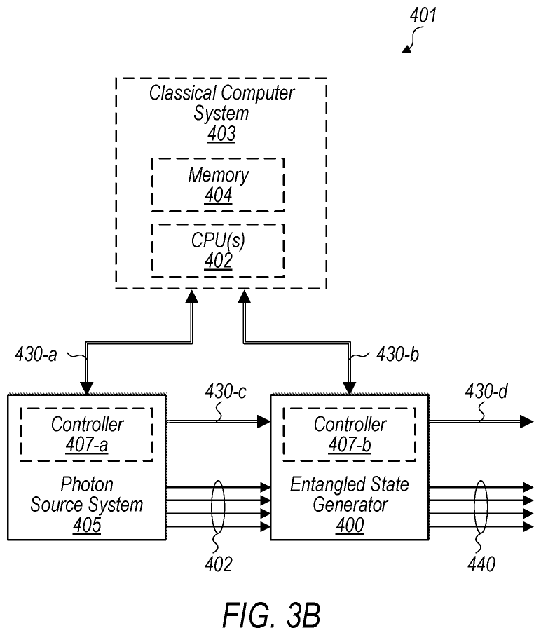

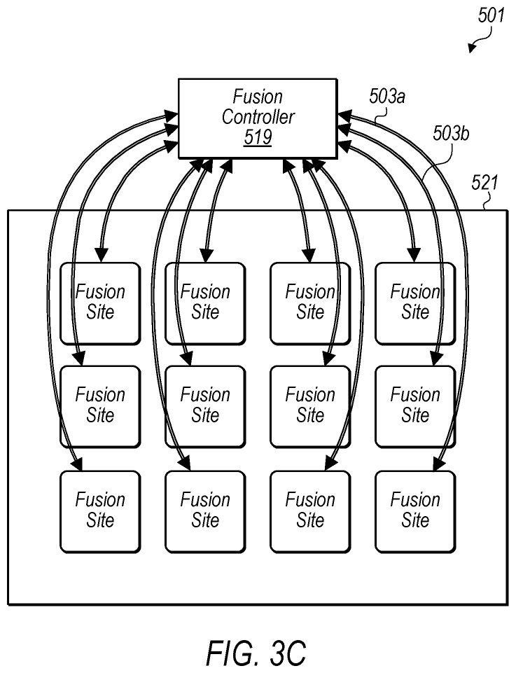

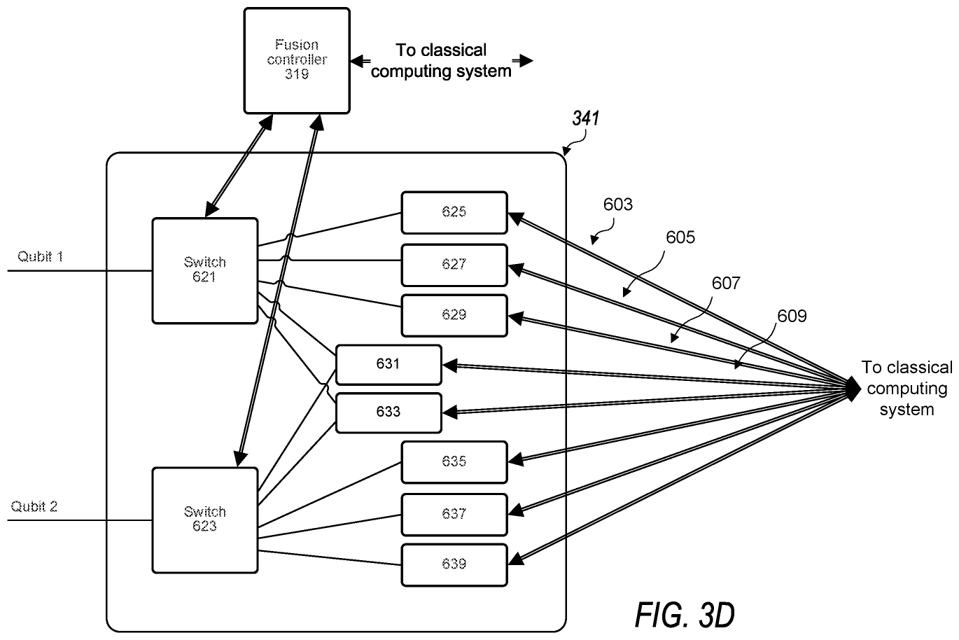

FIG. 2 shows a quantum computing system in accordance with one or more embodiments. The quantum computing system 201 includes a user interface device 204 that is communicatively coupled to a quantum computing (QC) sub-system 206, described in more detail below in FIG. 3. The user interface device 204 can be any type of user interface device, e.g., a terminal including a display, keyboard, mouse, touchscreen and the like. In addition, the user interface device can itself be a computer such as a personal computer (PC), laptop, tablet computer and the like. In some embodiments, the user interface device 204 provides an interface with which a user can interact with the QC subsystem 206 directly or via a local area network, wide area network, or via the internet. For example, the user interface device 204 may run software, such as a text editor, an interactive development environment (IDE), command prompt, graphical user interface, and the like so that a user can program, or otherwise interact with, the QC subsystem to run one or more quantum algorithms. In other embodiments, the QC subsystem 206 may be pre-programmed and the user interface device 204 may be an interface where a user can initiate a quantum computation, monitor the progress, and receive results from the QC subsystem 206. QC subsystem 206 can further include a classical computing system 208 coupled to one or more quantum computing chips 210. In some examples, the classical computing system 208 and the quantum computing chip 210 can be coupled to other electronic components 212, e.g., pulsed pump lasers, microwave oscillators, power supplies, networking hardware, etc. In some embodiments that employ cryogenic operation, the quantum computing system 201 can be housed within a cryostat, e.g., cryostat 214. In some embodiments, the quantum computing chip 210 can include one or more constituent chips, e.g., an integration (direct or heterogeneous) of electronic chip 216 and integrated photonics chip 218. Signals can be routed on- and off-chip any number of ways, e.g., via optical interconnects 220 and via other electronic interconnects 222. In addition, the computing system 201 may employ a quantum computing process, e.g., a fusion-based quantum computing process as described in further detail below.

FIG. 3A shows a block diagram of a QC system 301 in accordance with some embodiments. Such a system can be associated with the computing system 201 introduced above in reference to FIG. 2. In FIG. 3, solid lines represent quantum information channels and double-solid lines represent classical information channels. The QC system 301 includes a resource state generator 303, qubit fusion system 305, and classical computing system 307. In some embodiments, the resource state generator 303 can take as input a collection of N physical qubits (also referred to herein as “quantum sub-systems”), e.g., physical qubits 309 (also represented schematically as inputs 311a, 311b, 311c, . . . , 311N) and can generate quantum entanglement between two or more of them to generate entangled resource states 315 (also referred to herein as “quantum systems” which are themselves made up of entangled states of quantum sub-systems). For example, in the case of photonic qubits, the resource state generator 303 can be a linear optical system such as an integrated photonic circuit that includes waveguides, beam splitters, photon detectors, delay lines, and the like. In some examples, the entangled resource states 315 can be relatively small entangled states of qubits (e.g., qubit entangled states having between 3 and 30 qubits). In some embodiments, the resource states can be chosen such that the fusion operations applied to certain qubits of these states results in syndrome graph data that includes the required correlations for quantum error correction. Advantageously, the system shown in FIG. 3 provides for fault tolerant quantum computation using relatively small resource states, without requiring that the resource states become mutually entangled with each other to form the typical lattice cluster state required for MBQC.

In some embodiments, the input qubits 309 can be a collection of quantum systems (also referred to herein as quantum-subsystems) and/or particles and can be formed using any qubit architecture. For example, the quantum systems can be particles such as atoms, ions, nuclei, and/or photons. In other examples, the quantum systems can be other engineered quantum systems such as flux qubits, phase qubits, or charge qubits (e.g., formed from a superconducting Josephson junction), topological qubits (e.g., majorana fermions), spin qubits formed from vacancy centers (e.g., nitrogen vacancies in diamond), or qubits otherwise encoded in multiple quantum systems, e.g., Gottesman-Kitaev-Preskill (GKP) encoded qubits and the like. Furthermore, for the sake of clarity of description, the term “qubit” is used herein although the system can also employ quantum information carriers that encode information in a manner that is not necessarily associated with a binary bit. For example, qudits (i.e., quantum systems that can encode information in more than two quantum states) can be used in accordance with some embodiments.

In accordance with some embodiments, the QC system 301 can be a fusion-based quantum computer that can run one or more quantum algorithms or software programs. For example, a software program (e.g., a set of machine-readable instructions) that represents the quantum algorithm to be run on the QC system 301 can be passed to a classical computing system 307 (e.g., corresponding to system 208 in FIG. 2 above). The classical computing system 307 can be any type of computing device such as a PC, one or more blade servers, and the like, or even a high-performance computing system such as a supercomputer, server farm, and the like. Such a system can include one or more processors (not shown) coupled to one or more computer memories, e.g., memory 306. Such a computing system will be referred to herein as a “classical computer.” In some examples, the logical processor 308 can take the software program as input and compute the corresponding set of logical gates to be applied to run the software program on the particular hardware available within the QC system 301. In some embodiments, the software program can be received by other, or even more than one module, e.g., a by the fusion pattern generator 313. One function of the fusion pattern generator 313 is to generate a set of machine-level fusion instructions (e.g., a set of fusion operations and/or single qubit measurements to be applied across the physical qubits that make up the QC system 301. As such, the logical processor 308 and fusion pattern generator 313 are able to receive the input software program (which may originate as high-level code that can be more easily written by a user to program the quantum computer) and to generate a set of machine readable instructions to be applied to the low level quantum hardware.

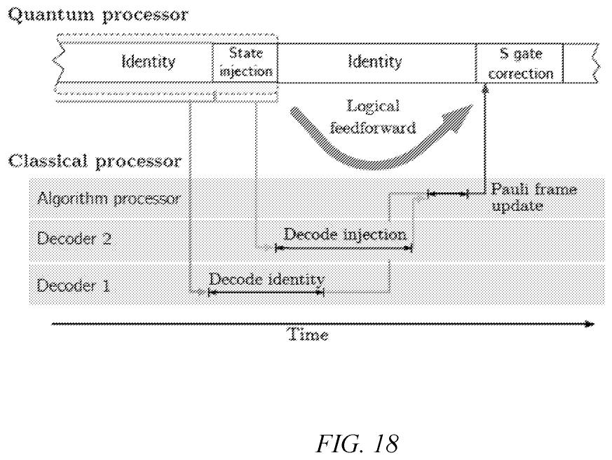

In some embodiments, the fusion pattern generator 313 (alone or in combination with the logical processor 308) can operate as a compiler for software programs to be run on the quantum computer. Fusion pattern generator 313 can be implemented as pure hardware, pure software, or any combination of one or more hardware or software components or modules. In various embodiments, fusion pattern generator 313 can operate at runtime or in advance; in either case, machine-level instructions generated by fusion pattern generator 313 can be stored (e.g., in memory 306). In some examples, the compiled machine-level instructions take the form of one or more data frames that instruct the qubit fusion system 305 to make, at a given clock cycle of the quantum computer, one or more fusions between certain qubits from the separate, i.e., unentangled, resource states 315. For example, fusion pattern data frame 317 is one example of the set of fusion measurements (e.g., Type II fusion measurements, described in more detail below in reference to FIGS. 18-21) that should be applied between certain pairs of qubits from different entangled resource states 315 during a certain clock cycle as the program is executed.

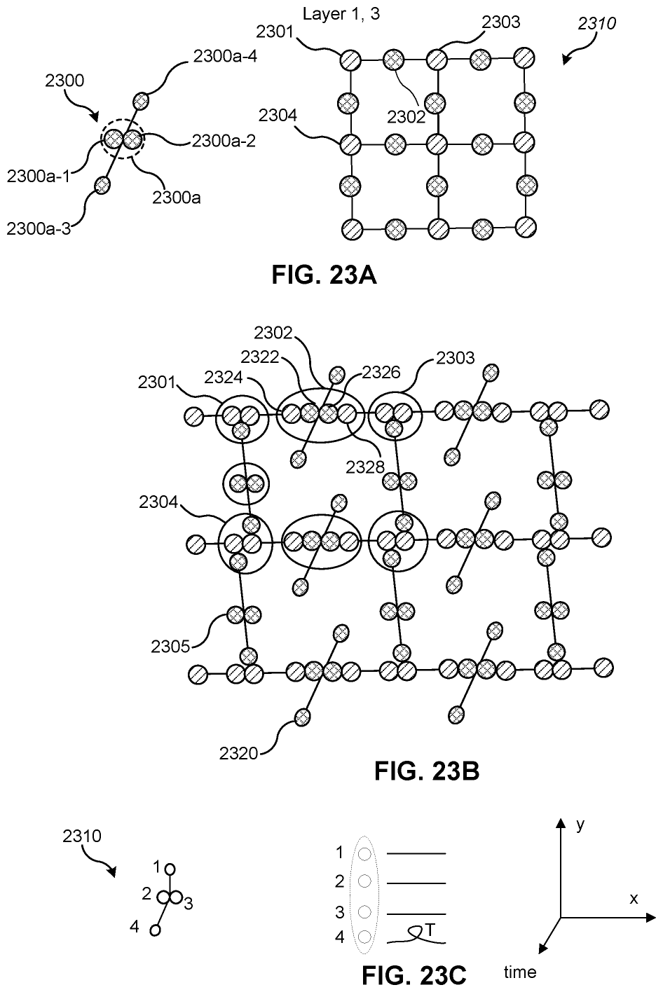

In some embodiments, several fusion pattern data frames 317 can be stored in memory 306 as classical data. In some embodiments, the fusion pattern data frames 317 can dictate whether or not XX Type II Fusion is to be applied (or whether any other type of fusion, or not, is to be applied) for a particular fusion gate within the fusion array 321 of the qubit fusion system 305. In addition, the fusion pattern data frames 317 can indicate that the Type II fusion is to be performed in a different basis, e.g., perform an XX-Fusion, XY-Fusion, ZZ-Fusion, etc. As used herein, the term XX Type II Fusion, YY Type II Fusion, XY Type II Fusion, ZZ Type II Fusion etc. refer to a fusion operation that applies a particular a two-particle projective measurement, e.g., a Bell projection which, depending on the Bell basis chosen, can project the two qubits onto one of the 4 Bell states. Such projective measurements produce two measurement outcomes (also referred to herein as joint measurement outcome data) that correspond to the eigenvalues of the corresponding pair of observables that are measured in the chosen basis. For example, XX Fusion is a Bell projection that measures the XX and ZZ observables (each of which could have a +1 or −1 eigenvalue—or 0 or 1 depending on the convention used), and XZ Fusions is a Bell projection that measures the observable XZ and ZX observables, and the like. FIGS. 23-36 below show example circuits for performing Type II fusions for various choices of basis in a linear optical system but other Bell projective measurements are possible in other qubit architectures without departing from the scope of the present disclosure. One of ordinary skill will appreciate that in a linear optical system, Type II Fusions perform probabilistic Bell measurements. FIGS. 23-36 discuss the probabilistic nature of linear optical fusion in the context of fusion “success” and “failure” outcomes and will not be repeated here for the sake of clarity.

A fusion network controller circuit 319 of the qubit fusion system 205 can receive data that encodes the fusion pattern data frames 317 and, based on this data, can generate configuration signals, e.g., analog and/or digital electronic signals, that drive the hardware within the fusion array 321. For example, for the case of photonic qubits, the fusion gates can include photon detectors coupled to one or more waveguides, beam splitters, interferometers, switches, polarizers, polarization rotators and the like. More generally, the detectors can be any detector that can detect the quantum states of one or more of the qubits in the resource states 315. One of ordinary skill will appreciate that many types of detectors may be used depending on the particular qubit architecture being employed.

In some embodiments, the result of applying the fusion pattern data frames 317 to the fusion array 321 is the generation of classical data (generated by the fusion gates' detectors) that is read out, and optionally pre-processed, and sent to the Fusion Pattern Generator and/or decoder 333, either directly (not shown) or via any other module. More specifically, the fusion array 321 (also referred to herein as a “fusion network”) can include a collection of measuring devices that implement the joint measurements between certain qubits from two different resource states and generate a collection of measurement outcomes associated with the joint measurement. These measurement outcomes (also referred to herein as joint measurement outcome data) can be stored in a measurement outcome data frame, e.g., data frame 322 and passed back to the classical computing system for further processing. In some embodiments, passing the measurement outcome data frame 322 directly to the fusion pattern generator can enable a rapid adaptive feed forward process that allows the system to alter the fusion pattern data frames 317 in a future clock cycle (e.g., the choice of basis or choice of single particle measurement) based on the measurement outcome data collected in a previous time step.

In some embodiments, any of the submodules in the QC system 301, e.g., controller 323, quantum gate array 325, fusion array 321, fusion network controller 319, fusion pattern generator 313, decoder 323, and logical processor 308 can include any number of classical computing components such as processors (CPUs, GPUs, TPUs) memory (any form of RAM, ROM), hard coded logic components (classical logic gates such as AND, OR, XOR, etc.) and/or programmable logic components such as field programmable gate arrays (FPGAs and the like). These modules can also include any number of application specific integrated circuits (ASICs), microcontrollers (MCUs), systems on a chip (SOCs), and other similar microelectronics. While FIG. 3 shows specific modules that exchange data, signals, and messaged to perform functions as described above, one of ordinary skill will appreciate that the particular arrangement of modules shown here is but one example and many different examples are possible without departing from the scope of the present disclosure. For example, the compilation, feed forward functionality, etc., described above can be share among modules.

In some embodiments, the entangled resource states 315 can be any type of entangled resource state, that, when the fusion operations are performed, produces measurement outcome data frames that include the necessary correlations for performing fault tolerant quantum computation. While FIG. 3 shows an example of a collection of identical resource states, a system can be employed that generates many different types of resource states and can even dynamically change the type of resource state being generated based on the demands of the quantum algorithm being run. As described herein, the logical qubit measurement outcomes 327 can be fault tolerantly recovered, e.g., via decoder 333, from the measurement outcomes 322 of the physical qubits. Logical processor 308 can then process the logical outcomes as part of the running of the program. As shown, the logical processor can feed back information to the fusion pattern generator 313 for affect downstream gates and/or measurements to ensure that the computation proceeds fault tolerantly.

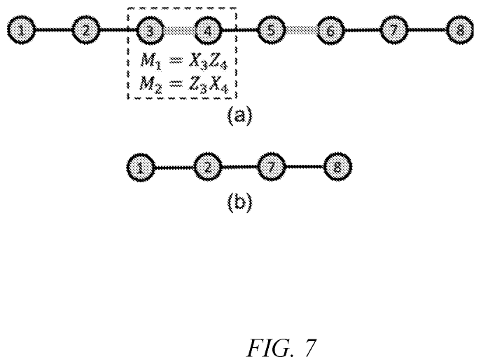

FIG. 3B illustrates an example of a resource state generator 401 in accordance with some embodiments. Such a system can be used to generate qubits (e.g., photons) in an entangled state (e.g., the resource state used in the illustrative examples shown in FIGS. 7-9 below), in accordance with some embodiments. Resource state generator 401 is an example of a system that can be employed in an FBQC system, such as resource state generator 303 shown in FIG. 3 above. One of ordinary skill will appreciate that any resource state generator could be used without departing from the scope of the present disclosure. Examples of resource state generators can be found in U.S. patent application Ser. No. 16/621,994 (published as US Pat App Pub No 20200287631) titled, Generation of entangled qubit states, U.S. patent application Ser. No. 16/691,459 (published as U.S. Pat. No. 11,126,062), titled, GENERATION OF ENTANGLED PHOTONIC STATES, and U.S. patent application Ser. No. 16/691,450 (published as US Pat App Pub No XXXXX), titled, GENERATION OF AN ENTANGLED PHOTONIC STATE FROM PRIMITIVE RESOURCES, the disclosures of which are hereby incorporated by reference in their entireties for all purposes. For example, in some embodiments, rather than generating single photons, the photon sources may generate entangled resource states directly, or may even generate smaller entangled states that can undergo additional entangling operations at the Entangled State Generator 400 to produce the final resource states to be used for FBQC. As such, as used herein the scope of the term “photon source” is intended to include at least sources of single photons, sources of multiple photons in entangled states, or more generally any source of photonic states. One of ordinary skill will appreciate that the precise form of the resource state generation hardware is not critical and any system can be employed without departing from the scope of the present disclosure.

In an illustrative photonic architecture, resource state generator 401 can include a photon source system 405 that is optically connected to entangled state generator 400. Both the photon source system 405 and the entangled state generator 400 may be coupled to a classical processing system 403 such that the classical processing system 403 can communicate with and/or control (e.g., via the classical information channels 430a-b) the photon source system 405 and/or the entangled state generator 400. Photon source system 405 may include a collection of single-photon sources that can provide output photonic states (e.g., single photons or other photonic states such as bel states, GHZ states, and the like) to entangled state generator 400 by way of interconnecting waveguides 402. Entangled state generator 400 may receive the output photonic states and convert them to one or more entangled photonic states (or larger photonic states in the case that the source itself outputs an entangled photonic state) and then output these entangled photonic states into output waveguides 440. In some embodiments, output waveguides 440 can be coupled to some downstream circuit that may use the entangled states for performing a quantum computation. For example, the entangled states generated by the entangled state generator 400 may be used as resources for a downstream quantum optical circuit (not shown).

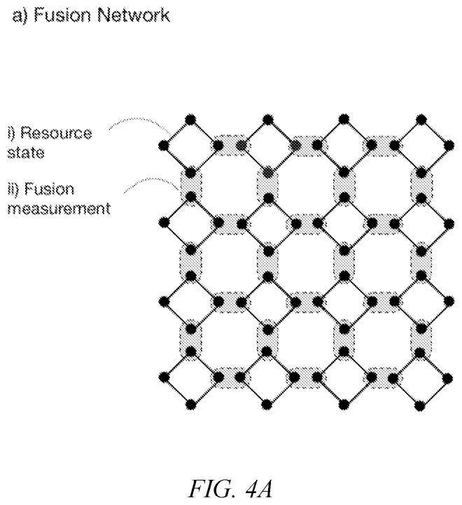

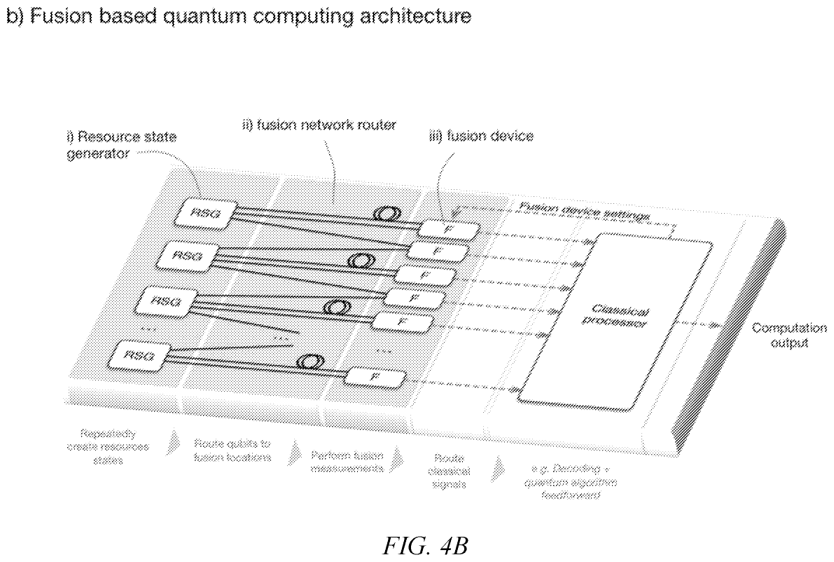

In some embodiments, the photon source system 405 and the entangled state generator 400 may be used in conjunction with the quantum computing system illustrated in FIG. 3. For example, the resource state generator 303 illustrated in FIG. 3 may include the photon source system 405 and the entangled state generator 400, and the classical computer system 403 of FIG. 4 may include one or more of the various classical computing components illustrated in FIG. 3 (e.g., the classical computing system 307). In this case, the entangled photons that leave via output waveguides 440 can be fused together by the qubit fusion system 305, i.e., they can be input to a detection system that performs a collection of joint measurements for use in a FBQC scheme.

In some embodiments, system 401 may include classical channels 430 (e.g., classical channels 430-a through 430-d) for interconnecting and providing classical information between components. It should be noted that classical channels 430-a through 430-d need not all be the same. For example, classical channel 430-a through 430-c may comprise a bi-directional communication bus carrying one or more reference signals, e.g., one or more clock signals, one or more control signals, or any other signal that carries classical information, e.g., heralding signals, photon detector readout signals, and the like.

In some embodiments, resource state generator 401 includes the classical computer system 403 that communicates with and/or controls the photon source system 405 and/or the entangled state generator 400. For example, in some embodiments, classical computer system 403 can be used to configure one or more circuits, e.g., using a system clock that may be provided to photon sources 405 and entangled state generator 400 as well as any downstream quantum photonic circuits used for performing quantum computation. In some embodiments, the quantum photonic circuits can include optical circuits, electrical circuits, or any other types of circuits. In some embodiments, classical computer system 403 includes memory 404, one or more processor(s) 402, a power supply, an input/output (I/O) subsystem, and a communication bus or interconnecting these components. The processor(s) 402 may execute software modules, programs, and/or instructions stored in memory 404 and thereby perform processing operations.

In some embodiments, memory 404 stores one or more programs (e.g., sets of instructions) and/or data structures. For example, in some embodiments, entangled state generator 400 can attempt to produce an entangled state over successive stages and/or over independent instances, any one of which may be successful in producing an entangled state. In some embodiments, memory 404 stores one or more programs for determining whether a respective stage was successful and configuring the entangled state generator 400 accordingly (e.g., by configuring entangled state generator 400 to switch the photons to an output if the stage was successful, or pass the photons to the next stage of the entangled state generator 400 if the stage was not yet successful). To that end, in some embodiments, memory 404 stores detection patterns from which the classical computing system 403 may determine whether a stage was successful. In addition, memory 404 can store settings that are provided to the various configurable components (e.g., switches) described herein that are configured by, e.g., setting one or more phase shifts for the component.

In some embodiments, some or all of the above-described functions may be implemented with hardware circuits on photon source system 405 and/or entangled state generator 400. For example, in some embodiments, photon source system 405 includes one or more controllers 407-a (e.g., logic controllers) (e.g., which may comprise field programmable gate arrays (FPGAs), application specific integrated circuits (ASICS), a “system on a chip” that includes classical processors and memory, or the like). In some embodiments, controller 407-a determines whether photon source system 405 was successful (e.g., for a given attempt on a given clock cycle) and outputs a reference signal indicating whether photon source system 405 was successful. For example, in some embodiments, controller 407-a outputs a logical high value to classical channel 430-a and/or classical channel 430-c when photon source system 405 is successful and outputs a logical low value to classical channel 430-a and/or classical channel 430-c when photon source system 405 is not successful. In some embodiments, the output of control 407-a may be used to configure hardware in controller 107-b.

Similarly, in some embodiments, entangled state generator 400 includes one or more controllers 407-b (e.g., logical controllers) (e.g., which may comprise field programmable gate arrays (FPGAs), application specific integrated circuits (ASICS), or the like) that determine whether a respective stage of entangled state generator 400 has succeeded, perform the switching logic described above, and output a reference signal to classical channels 430-b and/or 430-d to inform other components as to whether the entangled state generator 400 has succeeded.

In some embodiments, a system clock signal can be provided to photon source system 405 and entangled state generator 400 via an external source (not shown) or by classical computing system 403 via classical channels 430-a and/or 430-b. Examples of clock generators that may be used are described in U.S. Pat. No. 10,379,420, the contents of which is hereby incorporated by reference in its entirety for all purposes; but other clock generators may also be used without departing from the scope of the present disclosure. In some embodiments, the system clock signal provided to photon source system 405 triggers photon source system 405 to attempt to output one photon per waveguide. In some embodiments, the system clock signal provided to entangled state generator 400 triggers, or gates, sets of detectors in entangled state generator 400 to attempt to detect photons. For example, in some embodiments, triggering a set of detectors in entangled state generator 400 to attempt to detect photons includes gating the set of detectors.

It should be noted that, in some embodiments, photon source system 405 and entangled state generator 400 may have internal clocks. For example, photon source system 405 may have an internal clock generated and/or used by controller 407-a and entangled state generator 400 has an internal clock generated and/or used by controller 407-b. In some embodiments, the internal clock of photon source system 405 and/or entangled state generator 400 is synchronized to an external clock (e.g., the system clock provided by classical computer system 403) (e.g., through a phase-locked loop). In some embodiments, any of the internal clocks may themselves be used as the system clock, e.g., an internal clock of the photon source may be distributed to other components in the system and used as the master/system clock.

In some embodiments, photon source system 405 includes a plurality of probabilistic photon sources that may be spatially and/or temporally multiplexed, i.e., a so-called multiplexed single photon source. In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (i.e., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single-photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources. In some embodiments, the photon source can also produce a classical herald signal that announces (or heralds) the success of the generation. In some embodiments, this classical signal is obtained from the output of a detector, where the photon source system always produces photon states in pairs (such as in SPDC), and detection of one photon signal is used to herald the success of the process. This herald signal can be provided to a multiplexer and used to properly route a successful generation to a multiplexer output port, as described in more detail below.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator 400 may not be necessary, or alternatively may take the entangled states as input and generate even larger entangled states.

In some embodiments, spatial multiplexing of several non-deterministic photon sources (also referred to as a MUX photon source) can be employed. Many different spatial MUX architectures are possible without departing from the scope of the present disclosure. Temporal MUXing can also be implemented instead of or in combination with spatial multiplexing. MUX schemes that employ log-tree, generalized Mach-Zehnder interferometers, multimode interferometers, chained sources, chained sources with dump-the-pump schemes, asymmetric multi-crystal single photon sources, or any other type of MUX architecture can be used. In some embodiments, the photon source can employ a MUX scheme with quantum feedback control and the like. One example of an n×m MUXed source is disclosed in U.S. Pat. No. 10,677,985, the contents of which is hereby incorporated by reference in its entirety for all purposes.

FIG. 3C shows one example of qubit fusion system 501 in accordance with some embodiments. In some embodiments, qubit fusion system 501 can be employed within a larger FBQC system such as qubit fusion system 305 shown in FIG. 3A.

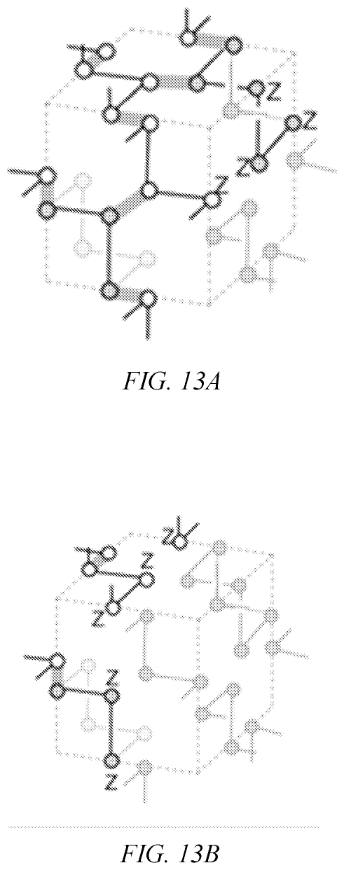

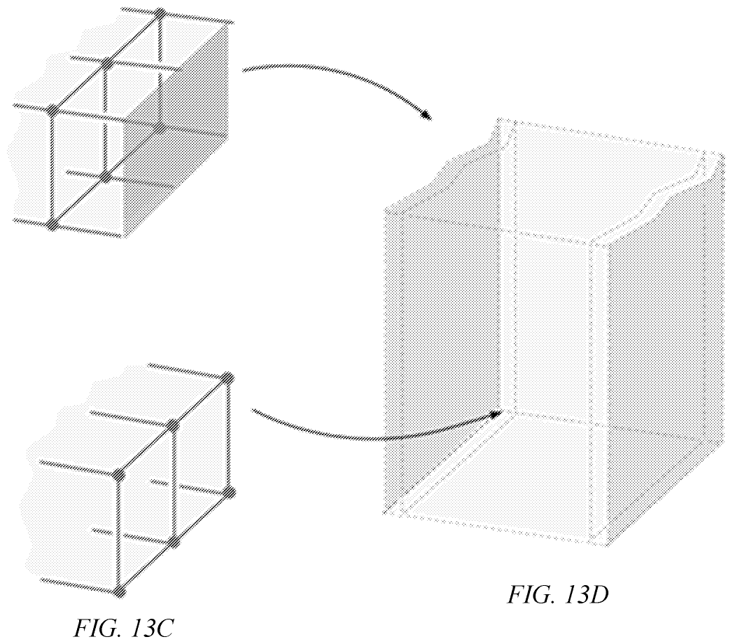

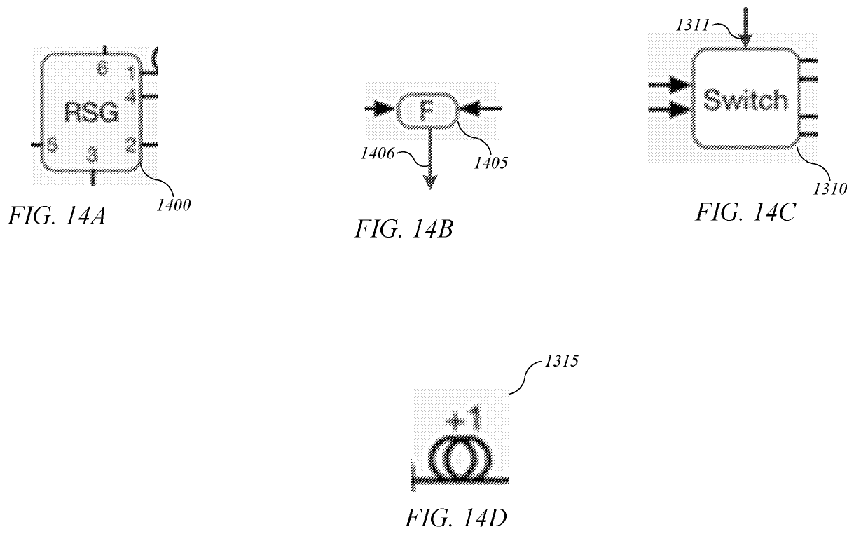

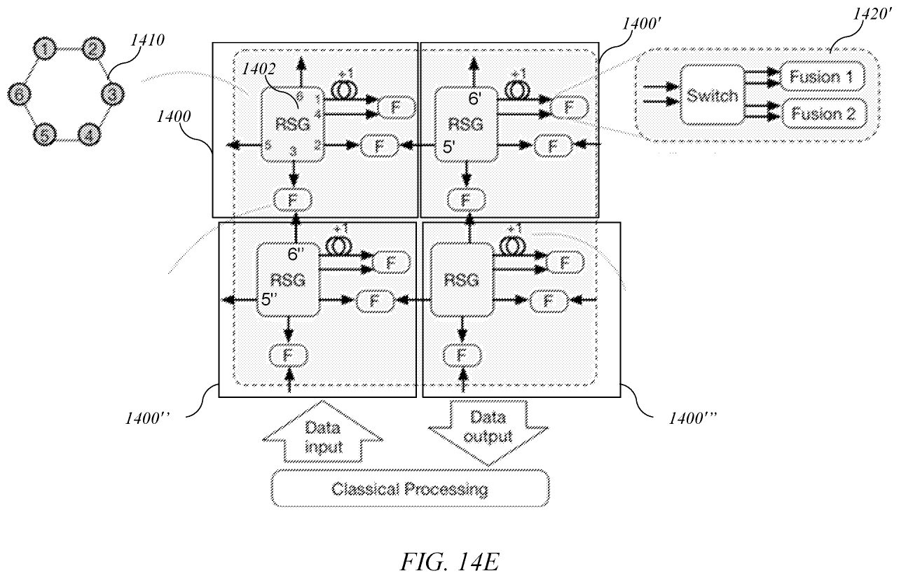

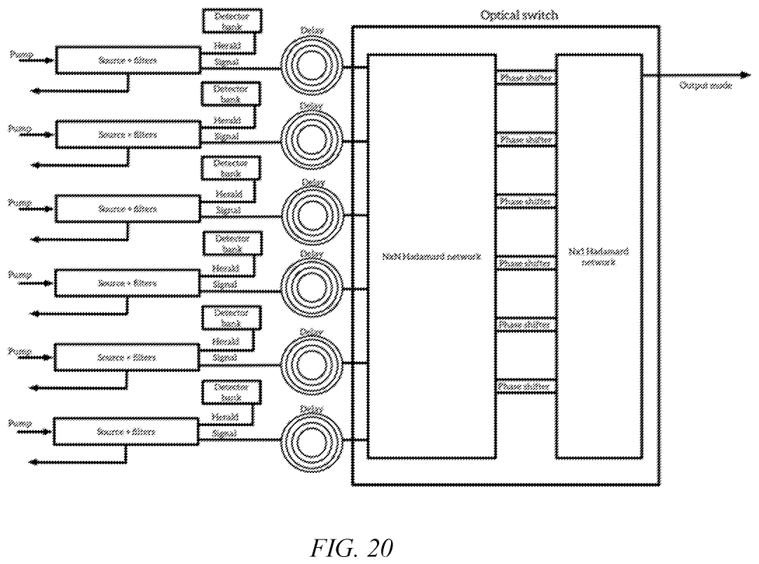

Qubit fusion system 501 includes a fusion network controller 519 that is coupled to fusion array 521 (also referred to herein as a “fusion network”). Fusion network controller 519 is configured to operate as described above and below in reference to fusion network controller circuit 319 of FIG. 3 above. Fusion array 521 includes a collection of fusion sites that each receive two or more qubits from different resource states (e.g., as shown in FIG. 4a) and perform one or more fusion operations (e.g., Type II fusion) on selected qubits from the two or more resource states and/or to perform select single particle measurements to implement fault tolerant logic, as described in more detail below in reference to FIGS. 13-14. The measurement operations performed on the qubits can be controlled by the fusion network controller 519 via classical signals that are sent from the fusion network controller 519 to each of the fusion sites via control channels 503a, 503b, etc. Based on the measurements performed at each fusion site, classical measurement outcomes in the form of classical data are output and then provided to a decoder system, as shown and described above in reference to FIG. 3. Examples of photonic circuits that can be employed as Type II fusion gates are described in below in reference to FIG. 20 and also FIGS. 23-35.

FIG. 3D shows one possible example of a fusion site 341 (one of many that make up a fusion array 321) as configured to operate with a fusion network controller 319 to provide measurement outcomes to a decoder system for fault tolerant quantum computation in accordance with some embodiments. In this example, fusion site 341 can be an element of fusion array 321 (shown in FIG. 3), and although only one instance is shown for purposes of illustration, fusion array 321 can include any number of instances of fusion sites 341. In some embodiments, quantum logic gates can be implemented by modifying fusion measurements. To allow logic to be implemented (at least) a subset of the fusion devices can be reconfigurable, as indicated in FIG. 3B but others need not be reconfigurable. Boundaries or other topological features in the bulk can be implemented by changing the measurement basis of the fusion or by choosing a single qubit measurement instead of a fusion as also described below in reference to FIG. 13A-13D.

As described above, the qubit fusion system 305 can receive (at two or more inputs) two or more qubits (Qubit 1 and Qubit 2) that are to be measured according to the quantum application being run. Qubit 1 incident on input 1 is one qubit that is entangled with one or more other qubits (not shown) as part of a first resource state and Qubit 2 incident on input 2 is another qubit that is entangled with one or more other qubits (not shown) as part of a second resource state. Advantageously, in contrast to MBQC, none of the qubits from the first resource state need be entangled with any of the qubits from the second (or any other) resource state in order to facilitate a fault tolerant quantum computation. Also advantageously, at the inputs of a fusion site 341, the collection of resource states are not mutually entangled to form a cluster state that takes the form of a quantum error correcting code and thus there is no need to store and or maintain a large cluster state with long-range entanglement across the entire cluster state. Also advantageously, in some embodiments, the fusion operations that take place at the fusion sites can be fully destructive joint measurements on Qubit 1 and Qubit 2 such that all that is left after the measurement is classical information representing the measurement outcomes on the detectors, e.g., measurement outcomes 603, 605, 607, 609, etc. At this point, the classical information is all that is needed for the decoder 333 to perform quantum error correction. This can be contrasted with an MBQC system that might employ fusion sites to fuse resource states into a cluster state that itself serves as the topological code and only then generates the required classical information via an additional step of single particle measurements on each qubit in the large cluster state. In such an MBQC system, not only does the large cluster state need to be stored and maintained in the system before the single particle measurements are made, but an extra single particle measurement system must be present (in addition to the fusion system used to generate the cluster state) to receive every qubit of the cluster state and perform the requisite single particle measurements in order to generate the classical information required to compute the syndrome graph data required for the decoder to perform quantum error correction.

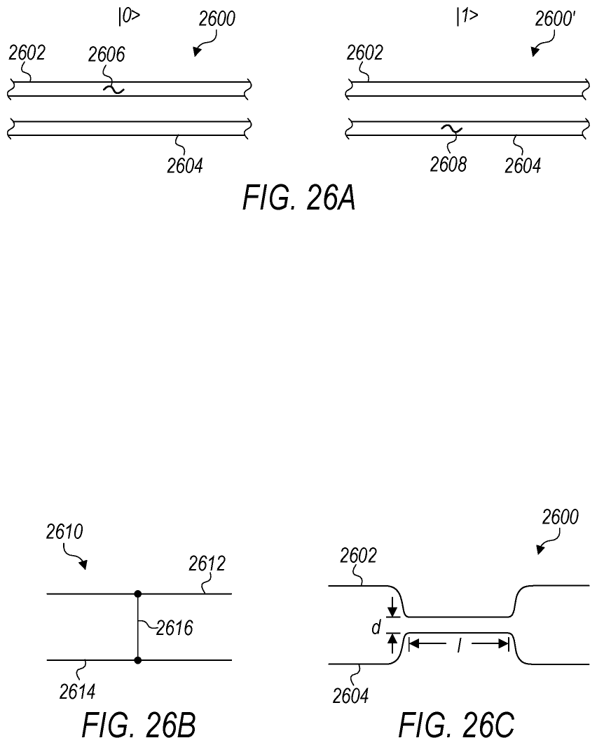

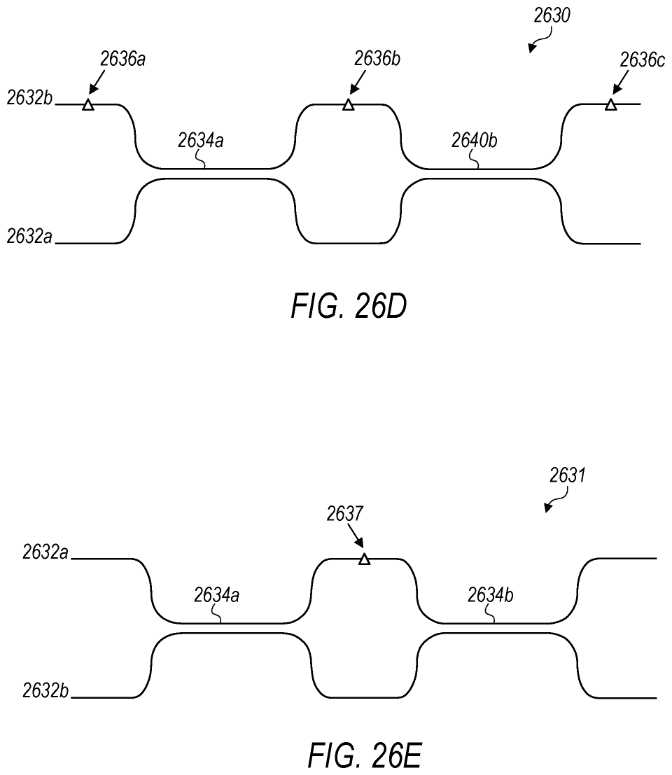

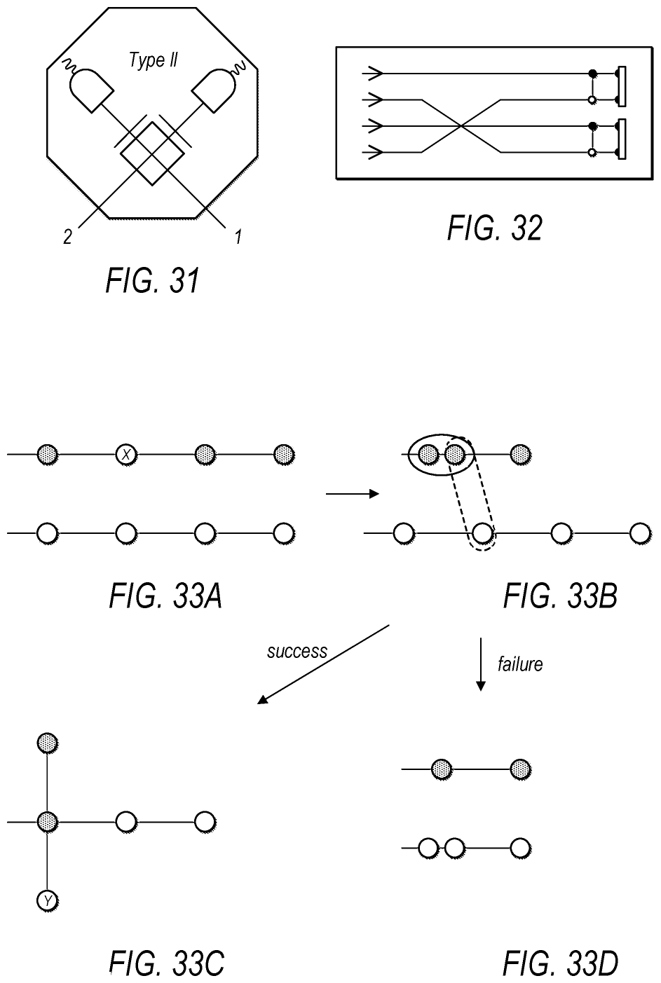

FIG. 3D shows an illustrative example for one way to implement a fusion site as part of a fusion based quantum computer architecture. In this example, qubit 1 and qubit 2 can be dual rail encoded photonic qubits, but any type of qubit is possible without departing from the scope of the present disclosure. A brief introduction to the dual-rail encoding of photonic qubits is provided below in reference to FIGS. 26-29. Accordingly, qubit 1 and qubit 2 can be coupled to switches 621 and 623, respectively. In some embodiments, the coupling can be waveguides and the switches 621 and 623 could be photonic switches. The various output channels of the switch can be coupled to different qubit measuring devices that implement different types of measurements. For example, single qubit measuring device 625 (635) could implement a measurement of the state of qubit 1 (qubit 2) in the X basis, single qubit measuring device 627 (637) could implement a measurement of the qubit in the Y basis, single qubit measuring device 629 (639) could implement a measurement of the qubit in the Z basis. Likewise, two qubit measuring devices 631 and 633 can implement different types of two qubit measurement, e.g., the projective Bell measurements referred to herein at Type II fusions. For example, measuring device 631 could implement an XX-Fusion and measuring device 633 could implement a ZZ fusion or XZ fusion. FIGS. 31-36 show example hardware than could be used to implement such measurement devices in accordance with one or more embodiments. In some embodiments the state of the switches 621 and 623 basis can be hard-coded within the fusion network controller 319, or in some embodiments the basis can be chosen based upon external inputs, e.g., instructions provided by the fusion pattern generator 313 depending on the needs of the algorithm being run. The layout shown in FIG. 3C is intended to be merely illustrative and any number and combination of switches and single and/or multi-particle measurement devices can be employed without departing from the scope of the present disclosure.

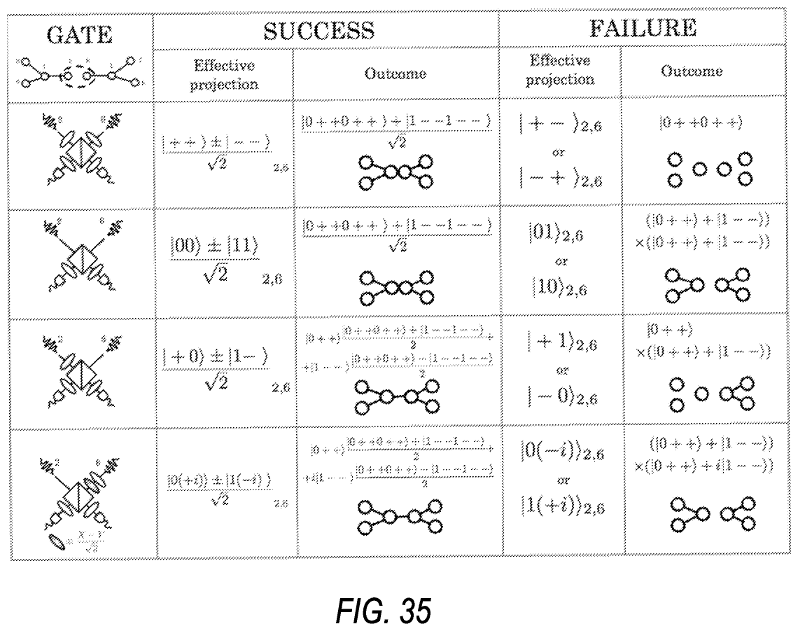

In some embodiments, e.g., linear optical implementation, fusion can be probabilistic operation, i.e., it implements a probabilistic Bell measurement, with the measurement sometimes succeeding and sometime failing, as described below in reference to FIG. 35. In some embodiments, the success probability of such operation can be increased by using extra quantum systems in addition to those onto which the operation is acting upon. Embodiments using extra quantum systems are usually referred to as “boosted” fusion. In the example shown in FIG. 3C, the fusion site implements an unboosted Type II fusion operation on the incoming qubits. One of ordinary skill will appreciate that any type of fusion operation can be applied (and may be boosted or unboosted) without departing from the scope of the present disclosure. Additional examples of Type II fusion circuits are shown and described below for both polarization encoding and dual rail path encoding. In some embodiments the fusion network controller 319 can also provide a control signal to the measurement devices 625, 627, 629, 631, 633, 635, 637, 639, etc. A control signal can be used, e.g., for gating the measurement hardware (e.g., photon detectors) or for otherwise controlling the operation of the hardware. Each of the measurement devices provides measurement outcome signals (603, 605, 607, 609, etc.) and this signal can be preprocessed at the fusion site 341 to determine a measurement outcome (e.g., fusion success or not, which eigenvalue is measured, how many photons are detected, and the like) or passed directly to the decoder 333 for further processing.

In accordance with some embodiments, a fault tolerant quantum computer architecture is disclosed. In some examples, a fault tolerant linear optical quantum computer that can be made manufacturable in a silicon photonics platform is described. A linear optical approach to quantum computing is advantageous for numerous reasons, including: (i) highly coherent qubits and high fidelity single qubit operations can be implemented using well-known quantum optical methods; (ii) silicon photonics is manufacturable, providing an avenue to scaling to large numbers of qubits; (iii) all required operations—state preparation, gates, and measurements—can be performed rapidly, leading to high gate speeds; and (iv) the dominant source of noise is optical loss which allows for more effective error correction because the location of errors is known.

In linear optics two-qubit gates cannot be implemented deterministically because photons do not interact with each other. Entangled states can only be produced using operations that succeed with some probability less than one. Also, the single photon sources used to prepare qubit states may not work deterministically. Overcoming this limitation leads to an overhead relative to schemes that have deterministic two-qubit operations. This overhead does not grow as the size of the computation grows. In that sense the overhead related to non-deterministic operations in linear optics is less serious that the overhead of quantum error correction which does grow slowly for larger computations.

In accordance with some embodiments, an architecture is disclosed that can tolerate even relatively frequent failures of entangling operations thereby greatly reducing the overhead of non-deterministic operations relative to other LOQC architectures.

In some ways the fact that photons do not interact readily is an advantage. This limits the possibility for so-called quantum crosstalk in which qubits can become entangled unintentionally. Such effects are an important source of noise in many other approaches to quantum computing.

In accordance with some embodiments, systems and methods for fault tolerant quantum computation, referred to herein as fusion-based quantum computing (FBQC) are disclosed. In this approach, specific, relatively small entangled states, referred to as resource states are produced. The computation is then carried out by selecting measurements that are performed on pairs of qubits coming from distinct, i.e., unentangled, resource states. As described in further detail below, the measurements can be linear optical fusion measurements, hence the name fusion-based quantum computing.

FBQC should not be confused with measurement-based quantum computing (MBQC) approaches. MBQC approaches involve very large entangled resources states, known as cluster states with a number of cluster state qubits that grows as the desired number of logical qubits increases and also as the number of desired gate operations in the computation increases. In MBQC the computation is performed using single qubit measurements on the cluster state. In FBQC the size of the resource state does not depend on either the number of logical qubits or the number of gates in the computation. As used herein we refer to a resource state whose size neither depends on either the number of logical qubits nor the number of gates in the computation as a resource state with fixed (or constant) size. In FBQC, computations are performed by performing two qubit measurements on qubits belonging to two distinct (i.e., unentangled) resource states having a fixed size.

In linear optical implementations, fusion operations are probabilistic and when they fail this means that some outcome of the fusion measurement is not obtained. In FBQC these missing measurement outcomes can be handled using quantum error correction because quantum error correcting codes can handle such missing measurement outcomes, referred to herein as “erasures,” very well.

The most efficient photonic architectures in the present academic literature are based on MBQC and use fusion to create cluster states. The effect of fusion failures is handled by using the fact that such failure results in missing qubits in the desired cluster state. Results from percolation theory are used to guarantee that if fusion failure is sufficiently rare the remnant cluster state has a very large connected component that can be used for MBQC. Such percolation-based architectures have serious drawbacks compared to FBQC including the fact that paths through the remnant cluster state must be computed in real-time for each logical gate, this is likely very challenging and the thresholds for such schemes are in practice very low.

Using quantum error correcting codes to compensate for the inescapably probabilistic linear optical entangling operations allows for very high quantum error correction thresholds in FBQC without the need for a decoder that can also implement the computationally demanding renormalization computation necessary for percolation-based approaches. Schemes based on percolation require much more complex decoders that must find paths in percolated clusters. In accordance with some embodiments, FBQC architectures can have physical size (footprint) that many orders of magnitude smaller than percolation-based photonic architectures or alternatives that deal with the probabilistic linear optical operations via gate teleportation through very large ancilla states or ‘repeat until success’ methods.

In some embodiments, implementing FBQC involves the ability to choose each measurement adaptively in response to the outcomes of earlier fusion measurements. Such adaptivity can be implemented using classical logic and an appropriate switchable element to move each qubit towards the appropriate measurement device, e.g., as described above in reference to FIG. 3D.

FBQC combines many advantageous features. For example, Advantageously, every individual photon in FBQC only encounters a small, fixed number of optical elements between source and detector, regardless of the size of computation being performed. This ‘constant depth’ feature results in dramatically reduced loss relative to other architectures because each optical element increases the probability of loss. More explicitly, a photon that comprises a resource state qubit is measured immediately in the subsequent fusion. The number of optical elements the photon passes through in the resource state generator depends on the resource state and the method used to produce it but not on the computation that will be performed.

Because each photon passes through a small, fixed number (which can be, e.g., 5 or fewer) of optical elements and this number remains constant as the size of the computation increases, the timescale for producing and detecting photons is completely decoupled from the much longer timescale required to implement a non-trivial logical operation or to run the decoder. This means the decoder does not need to be co-located with the rest of the computer, which is advantageous for architectures that employ cryogenic operation of the quantum elements because the decoder need not be co-located in the cryostat.

Advantageously, FBQC is consistent with a planar architecture of the computer. In such an architecture the bulk of the fusion measurements are between qubits that are adjacent to each other in the plane of the chip. Advantageously a planar architecture makes it practical to implement in silicon photonic chips or any other planar integrated circuit approach using non-photonic qubits.

Advantageously, FBQC is flexible enough to implement many different approaches to quantum error correction and fault tolerant logical gates. In accordance with some embodiments, the large body of existing tools of fault tolerant quantum computation using surface codes can be employed in FBQC.

In accordance with some embodiments, a qubit encoding can be used where the qubit is a single photon in some time-bin in a given transverse mode of one of two waveguides. This is called a dual-rail encoding. A variant that is also useful is to encode the qubit in one of two time-bins travelling in the same waveguide or fiber. This is called time-bin encoding.

In dual-rail encoding each qubit has one photon and in FBQC all qubits are measured. Photon loss results in fewer than the expected number of photons being detected which provides a signal that an error has occurred. Advantageously for the FBQC approaches disclosed herein, the tolerance of surface codes to such errors is much higher than for errors that are not heralded in this way.

Another advantage of optical implementations of FBQC is the ability to use optical fibers to create long delays between resource state generators and fusion measurements. This makes it possible to fuse qubits that are not just nearest neighbors in the plane of the photonic chip.

### III. FBQC Architecture Example

In accordance with some embodiments, FBQC can be built on two primitive operations: generation of small constant-sized entangled resource states and projective entangling measurements, which we refer to herein as fusion.

FBQC can be applied across many physical systems, and is particularly relevant to architectures where multi-qubit projective measurements are native operations. One or more embodiments implement FBQC in linear optical quantum computing. In the examples disclosed herein a fault tolerant threshold of 24% against fusion failure is demonstrated (compared to 14.9% previously reported).

### A. Principles of FBQC

In FBQC, a fusion network defines a configuration of fusion measurements to be made on qubits of a collection of resource states. The fusion network forms the fabric of the computation on which an algorithm can be implemented by modifying the basis of at least some of the fusion measurements. Appropriately combining fusion measurement outcomes gives the output of the computation. An example of a 2-dimensional fusion network is shown in FIG. 4A. In general there is no requirement for any particular structure in the fusion network.

Building fusion networks involves two basic primitives. The first is resource state generation, which describes the creation of small entangled states. These states have a fixed size and structure, regardless of the size of the computation they will be used to implement. Resource states could be any size and the particular form of the resource state is not critical for FBQC generally, but rather, is a design parameter that the quantum engineer has at its disposal given a particular qubit architecture and noise model. In some embodiments, a resource state generator device produces a copy of this resource state on some time period, referred to herein as a “clock cycle.” The resource state generator could physically take many forms: for example, it could be a device that produces entangled photonic states, or it could be a matter based device.

The second primitive is a fusion measurement, which is a projective entangling measurement on multiple qubits. In some embodiments, the fusion measurement can be implemented by a fusion device with n input qubits, which outputs n classical bits giving measurement outcomes. For example, a Bell measurement on two qubits yielding outcomes X₁X₂ and Z₁Z₂. At least some of the fusion devices (or resource states generated) must be reconfigurable such that at different time steps the projective measurement they make can change to accommodate the computational intent of FBQC, i.e., in order to run a quantum application.

The physical implementation of a fusion will depend on the underlying hardware. In a linear optical system, fusion may be natively implemented by performing interferometric photon measurements encompassing different resource states, which simply amounts to appropriate configurations of beam splitter and photon detectors, with more nuanced implementation are also possible in order to improve on success probability and robustness to hardware imperfections.

Other approaches to quantum computation also employ entangling measurements to be performed throughout the computation. Particularly, in the fault-tolerant circuit picture, syndrome extraction can be understood as a joint measurement in an entangling basis. In topological quantum computation, joint anyonic charge projection is necessary to extract classical outcomes from the system and can be used as a basis to achieve universal quantum computation. Redundancy in fusion measurement outcomes can be used to naturally accommodate the constant density of syndrome extraction required to mitigate entropy accumulation.

### B. Architecture

FBQC provides a natural framework for studying fault tolerance given the primitives of resource states and fusion, but its advantages also translate to a significant simplification of the physical architecture requirements. In addition, to resource state generation and fusion, we may also explicitly identify a third component, the fusion network router which allows the first two to jointly function, by appropriately routing qubits from resource states to fusion measurements. The fusion network router provides the largest advantage to linear optic realizations, as integrated wave-guides and optical fiber allow straightforward and low loss routing of photonic qubits across extremely large distances whereas other matter based approaches require coherent light-matter coupling which has only been demonstrated at relatively low fidelities.

A given fusion network has many possible architectural implementations, for example for a 3D fusion network we could choose to create all the resource states simultaneously, or instead, we could create them one 2D layer at a time, reusing a resource state generator to create a new copy of a state in each clock cycle. This architectural design is captured by the fusion network router, which channels qubits created at different spatial and temporal locations (i.e. from different resource state generators and time bins) to corresponding fusion location. Thus, the fusion network router includes both spatial routing as well as temporal routing in the form of delay lines. FIG. 4B shows a schematic example of an architecture for FBQC that creates a 2D fusion network from a 1D array of resource state generators.

In certain fault-tolerant fusion networks, the fusion network routers to implement a fixed routing configuration. Fixed routing means that, qubit produced from a given resource state generator will always be routed to the same location. This design feature is particularly appealing from a hardware perspective and has many practical implications. Namely, it minimizes the need for switching which may be error-prone and reduces the burden of classical control.

Another crucial feature of an FBQC architectures, and something that distinguishes them from other approaches, is the separation of time scales for classical control. As is shown in FIG. 4B, feed-forward control can be implemented at the logical level to process and decode measurement outcomes, which then influence future logical operations. However, this timescale can be orders of magnitude longer than the clock cycle of resource state generation and fusion, and no classical computation or feedback is required on this shorter timescale. In other words, physical qubits do not need to wait in memory while a computation runs to decide how it should be measured.

### IV. Fusion

In FBQC the initial quantum resources are small entangled resource states of a fixed size. The large scale quantum correlations necessary for universal computation are generated when we perform measurements on qubits from distinct resource states. In order for this to generate long range entanglement at least some of the measurement outcomes need to be entangling, i.e. projectors onto a subspace containing at least one entangled state.

In general, the measurement could be any positive operator valued measure (POVM) but for the purposes of achieving fault tolerance, it is helpful to consider measurements where all outcomes are projections onto stabilizer states. This makes it straightforward to use existing stabilizer fault tolerance methods. In the examples in this paper we focus in particular on the case of two-qubit measurements which are Bell state projections, and we follow in calling this Bell fusion. A Bell fusion measures input qubits in the stabilizer basis X₁X₂, Z₁Z₂.

In general we will look at fusion networks where the vast majority of fusion measurements needed to implement quantum error correction are identical Bell measurements. However, in order to implement logical gates some fraction of the fusion measurements need to differ from the others. There are many variations of how this can be achieved, either with two-qubit measurements in a modified stabilizer basis, or by including single qubit measurements. We discuss this in more detail below.

### C. Fusion in Linear Optics

In linear optical quantum computing (LOQC), fusion on pairs of photonic qubits is simple to perform, but does not deterministically generate entanglement. This non-determinism means that the desired measurement outcomes are sometimes not obtained, and, advantageously, one or more embodiments for architectures for LOQC find a way around this missing information. In the FBQC schemes we describe here these fusion failures are corrected for directly by quantum error correction.

In the examples we study here we specifically consider “dual-rail” qubits composed of a single photon in two photonic modes. A photon in the first mode represents logical |0> and a photon in the other mode represents logical |1>. This qubit encoding is attractive because loss, takes the qubit out of the computational subspace, and is therefore heralded. Bell fusion on dual-rail qubits can be implemented using a linear optical circuit in which all four modes of the two qubits are measured. This is often referred to as type-II fusion. Fusion “succeeds” with 1−p_{fail}, measuring the input qubits in the Bell stabilizer basis X₁X₂, Z₁Z₂ as intended. The fusion ‘fails” with probability p_{fail}, in which case it performs separable single qubit measurements Z₁I₂, I₁Z₂. If there is a chance of photon loss or other imperfections then there is a third possible outcome: fusion “erasure”. In this case neither intended stabilizer outcome is measured. FIG. 5 illustrates the different possible measurement outcomes of a linear optical fusion on two qubits.

FIG. 5 shows outcomes of a linear optical Bell fusion. A fusion on qubits from two cluster states is shown, with intended outcomes X₁X₂ and Z₁Z₂. In the presence of photon loss there are three possible outcomes: fusion success where both measurement outcomes are obtained, fusion failure where only the outcome Z₁Z₂ is obtained, and fusion erasure where no measurement outcome is obtained. Fusion failure is intrinsic to linear optics, and can happen even when all operations are ideal. Fusion erasure only occurs due to errors in the system, most commonly if one or more of the photons going into the fusion measurement are lost.

Failure in linear optical fusion is a more benign error than erasure since it is heralded and does not result in a mixed state since we still obtain pure stabilizer measurements. One of the two desired outcomes, Z₁Z₂, can be obtained by multiplying the two single qubit measurements together. Fusion failure can therefore be treated as a Bell measurement where the X₁X₂ measurement outcome is erased.

The simplest way to implement a type-II fusion involves only two beamsplitters and four detectors, and has a failure probability p_{fail}=50%. Using an additional Bell pair, fusion can be “boosted” to suppress the failure probability to 25%, and by using more ancillary photons the fusion success rate can be further boosted. Increased tolerance to photon loss and physical fusion failure can be achieved by performing fusion on encoded qubits. This method is used in the examples below, where physical qubits are encoded using the (2,2) Shor code and encoded fusion is implemented by performing physical fusions transversally. Below, we describe how erasure in an encoded fusion can be suppressed and compute the erasure probability of measurements from an encoded fusion in the presence of photon loss and fusion failure.

In order to implement logic, the measurement basis of linear optical fusion can be straightforwardly changed by placing single qubit rotations before their input. These single qubit gates can be implemented with high accuracy using a beam-splitter and phase shifters which are straightforward to implement in integrated photonic chips. A small switching network before a fusion allows reconfigurability between different measurements, which we discuss further in below.

### V. Resource States

In FBQC, the small entangled states fueling the computation are referred to as resource states. Importantly, their size is independent of the computation being performed or code distance used. This allows them to be generated by a constant number of sequential operations. As a result, errors in the resource state are bounded, which is important for fault-tolerance.

As with fusions, we are going to focus on qubit stabilizer resource states. Such states can be described, up to local Clifford operations, by a graph G using the graph state representation, where the described quantum state |G> is obtained by putting qubits in the |+> at each vertex and performing a controlled-Z gate between qubits for which the corresponding vertices in the graph are neighbors. Equivalently, n stabilizers generators for a graph state with vertices labeled from 1 to n are given by Xᵢ [symbol] Zⱼ, i∈{1, 2, . . . , n} where [symbol] (i) is the set of vertices neighboring vertex i in G.

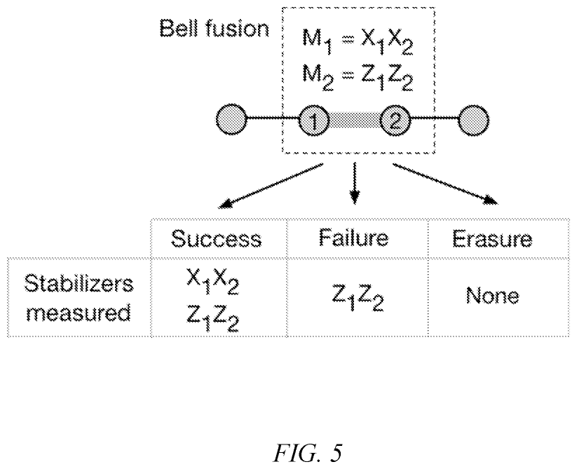

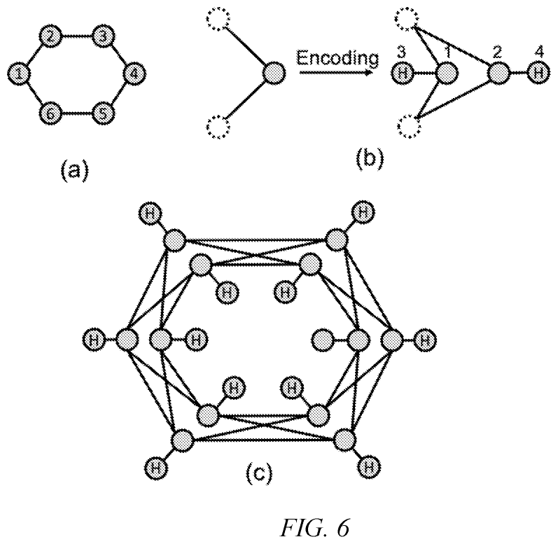

FIG. 6 shows an example of a resource state represented as a graph state in accordance with some embodiments. FIG. 6A shows an example of a resource state in the form of a 6-ring graph state. With the qubits labelled as in the figure, the stabilizers for the resource state are Z₆X₁Z₂, Z₁X₂Z₃, Z₂X₃Z₄, Z₃X₄Z₅, Z₄X₅Z₆ and Z₅X₆Z₁. FIG. 6B illustrates that a qubit in the resource state can be replaced by a (2,2) Shor encoded resource state with the depicted transformation. The qubits 1 and 2 both have the same neighboring qubits, drawn as dotted circles, as the unencoded qubit on the left. Qubits with an H inside have a Hadamard applied to them with respect to their graph state representation. FIG. 6C shows the resource state in FIG. 6A with every qubit encoded in a (2,2) Shor code.

The stabilizers for this resource state are Z₆X₁Z₂, Z₁X₂Z₃, Z₂X₃Z₄, Z₃X₄Z₅, Z₄X₅Z₆, Z₅X₆Z₁. A resource state can be encoded in the (2,2) Shor code by following the transformation shown in FIG. 6B. Replacing every qubit of a 6-ring with a (2,2) Shor encoded qubit gives us the resource state depicted in FIG. 6C.

The operations used to create a resource state depend on the physical platform used for this process, which can differ from the physical platform used to implement the fusion network as long as the resource state qubits generated are compatible with the fusion network. In solid state qubits for example, resource states can be generated using unitary entangling gates or dissipatively. When using linear optics, generation of resource states is achieved by performing a series of projective measurements, such as fusions, on even smaller entangled states such as Bell states and 3-GHZ states which we sometimes refer to as seed states. Methods for the generation of seed states are fully covered in. Since projective entangling measurements in linear optics succeed probabilistically, as discussed in the above, it is often advantageous to use switching networks between fusions to enhance the success probability of the protocol. Using these networks, we attempt probabilistic operations multiple times and only select cases where they have succeeded. In this sense, multiplexing is used to effectively approximate post-selection on entangling fusion outcomes. Since the size and number of probabilistic operations required to generate a resource state is fixed, the overhead from repeating probabilistic operations is fixed as well. There are many options for implementing such switching networks, depending on the required efficiency and available devices, the most up to date schemes can be found in. It is worth noting that although the resource states are required to be qubit states, that is, states with multi-partite entanglement between well-defined qubits, the states obtained at intermediate stages of generating resource states don't need to follow this restriction.

Determining the most suitable resource state is part of the design of an FBQC scheme for a realistic hardware implementation, as the noise profile of the resource state will depend on the generation protocol used. For a given target resource state there are an enormous number of possible preparation protocols, each of which will result in a different noise profile. However, the fixed size of the resource state implies that any generation protocol will require a finite number of operations, and therefore the noise accumulated in any of the state generations will be bounded. Moreover, any error correlations that emerge from independent state generation will be local to that state, which limits the spread of errors in the fusion network and is discussed below.

### VI. Fusion Networks

A fusion network (FN) specifies the resource states used in an FBQC protocol and how they are connected by fusions. After fusion measurements are made, two types of information remain: classical information from the measurement outcomes, and (potentially) some quantum correlations corresponding to unmeasured qubits. These measurement outcomes contain correlations that are the ‘outcome’ of the fusion network, giving us both a computational output, or in the case of fault-tolerant fusion networks, parity checks that can be used for error correction. In this section we describe how to construct fusion networks, and how to analyze them to identify the quantum and classical correlations that exist after fusion measurements have been made. In particular we focus on stabilizer fusion networks where resource states are stabilizer states and fusion measurements are stabilizer projections. This allows us to make use of existing fault tolerance tools.

Stabilizer fusion networks can be characterized by two Pauli subgroups: (1) A stabilizer group R describing the ideal resource states and (2) the fusion group F, which is a Pauli sub-group that defines the fusion measurements, where we include F [symbol] −1. Assuming perfect fusions we would learn the eigenvalues of all the operators in F by implementing the fusion network. The −1 is included since individual measurement outcomes of the fusion operators are random. Fusion stabilizers, which by definition should have a ‘+1’ outcome, correspond to consistently signed elements of F. After fusion measurements are made we can describe the remaining system by the surviving stabilizer group,

S:= [symbol] _{R}(F),

which is the centralizer of F in R. The stabilizers of F and R do not all commute with each other, and so after fusion measurements are made only some subgroup of the original stabilizers remain: the surviving stabilizers. These surviving stabilizers contain both ‘already-measured’ qubits, where the information remaining is purely classical, as well as qubits that are not yet measured, where quantum correlations remain. Any remaining qubits are described by the output stabilizer group Sₒᵤₜ, which is the restriction of S to the remaining qubits, up to signs which can be determined from the specific fusion outcomes. Namely, the signs of the stabilizers in Sₒᵤₜ are computed such that when multiplied by elements of the fusion group F with a sign compatible with the measurement outcome obtained, an element of S is produced.

In the fault-tolerant fusion network examples disclosed herein, every qubit in the network is measured out and there are no remaining qubits. The computation in FBQC uses correlations between fusion measurements that arise from the structure of the fusion network.

(a) An example of a fusion network with three resource states: a two qubit graph state, and two copies of a 3-qubit linear graph state. There are two fusions, shown by the orange lines, both of which measure the operators [symbol] XZ, ZX [symbol] . Specifically, the resource state composed of qubits {1,2,3} is stabilized by [symbol] Z₁X₂Z₃, X₁Z₂I₃, I₁Z₂X₃ [symbol] and similarly for {6,7,8}. The qubits {4,5} are stabilized by [symbol] X₄Z₅, Z₄X₅ [symbol] If every measurement result in the fusion network is successful and returns a +1 eigenvalue, the unmeasured qubits {1,2,7,8} are stabilized by [symbol] X₁Z₂, Z₁X₂Z₇, Z₂X₇Z₈, Z₇X₈ [symbol] which corresponds to the 4-line graph state shown in (b).

A simple example of a fusion network is shown in FIG. 7A, which results in the state in FIG. 7B up to outcome dependent stabilizer signs. The resource state group, R, is generated by the union of the stabilizers of different resource states that can be inferred from their graph state representation. R= [symbol] X₁Z₂, Z₁X₂Z₃, X₄Z₅,Z₄X₅,Z₂X₃,X₆Z₇,Z₆X₇Z₈,Z₇X₈ [symbol] . The fusion group is generated by the union of all fusion measurement operators i.e. F= [symbol] X₃Z₄, Z₃X₄, X₅Z₆, Z₅X₆,−1 [symbol] . The classical information produced by the fusion network comes from the measurement results of F. In addition, the fusion network leaves quantum information on the unmeasured qubits, which have stabilizers Sₒᵤₜ= [symbol] ±X₁Z₂, ±Z₁X₂Z₇, ±Z₂X₇Z₈, ±Z₇X₈ [symbol] , depicted by the graph state in FIG. 7B. The signs in Sₒᵤₜ depend on the fusion measurement outcomes.

There are some aspects of an FBQC architecture that are not covered by a fusion network. In particular, fusion networks do not capture the time ordering of fusions, the physical qubit routing or the classical processing requirements. A fusion network does not specify the ordering of the fusions: they can be performed in whichever order is most appropriate for the underlying hardware. Moreover, the resource states involved in a fusion network need not all exist simultaneously and their production may be staggered as long as fusion measurements can be made on all the necessary qubit pairs.

Below we describe how redundancy can be added to a fusion network for fault-tolerance.

### VII. Fault-Tolerant Fusion Networks

Fusion networks can be constructed to be fault tolerant, such that errors in resource states, or noisy fusion circuits leading to fusion measurement outcomes that differ from their ideal values can be corrected for, as long as errors occur with sufficiently low probability. In this section we describe fault tolerance in fusion networks.

Fault tolerant fusion networks (FTFNs) can be constructed in a way that is inspired by circuit-based quantum error correction, or based on fault tolerant cluster states. This approach can be a useful initial guide, but a direct translation often yields inefficient schemes, and better schemes can be found by working more directly in the fusion network picture, as we show in the examples herein.

### A. Stabilizer Formalism for FTFNS

When modeling physical errors, both from the resource state preparation as well as from the fusion measurement, we interpret them as occurring in a space where all the resource states are prepared and before the fusions are performed. In this picture, the key to fault tolerance is a redundancy between the Pauli operators measured during fusion, F, and the stabilizers of the resource states, R. This redundancy is reflected in the existence of the check operator group

C:=R∩F.

In other words, the check group C corresponds to the subset of stabilizers R on the resource states which are made available by the fusion measurement group F. In the absence of errors, fusion outcomes should be compatible with all the operators in C having positive eigenvalues, i.e. the classical fusion outcomes form a classical linear binary code, which allows them to be corrected. The error correction process is described in below.

The group of undetectable errors is defined by the centralizer of the check group C on the whole Pauli group

U:= [symbol] (C).

As the name suggests, this subgroup of Pauli operators which, if applied to qubits before fusion on an otherwise ideal process, leave no trace on the check operator results. However, not all undetectable errors are problematic for computation, since some do not affect the final correlations of interest. For example, arbitrary elements of R or F will have no detrimental effect as elements of R elements leave the resource states invariant and elements of F leave the fusion invariant and may respectively be absorbed into an ideal state preparation or fusion measurement. More generally, the group of trivial undetectable errors is

T:= [symbol] (S),

which includes [symbol] R, F [symbol] by definition. Undetectable errors can thus be classified by the elements of the quotient U/T, where S is the surviving stabilizer group defined below. Two errors are considered distinct if they lead to a different syndrome or have a different logical action. In contrast, if they differ only by an element of T, they are equivalent in all relevant ways. In this way, in-equivalent errors correspond to the equivalence classes P/T.

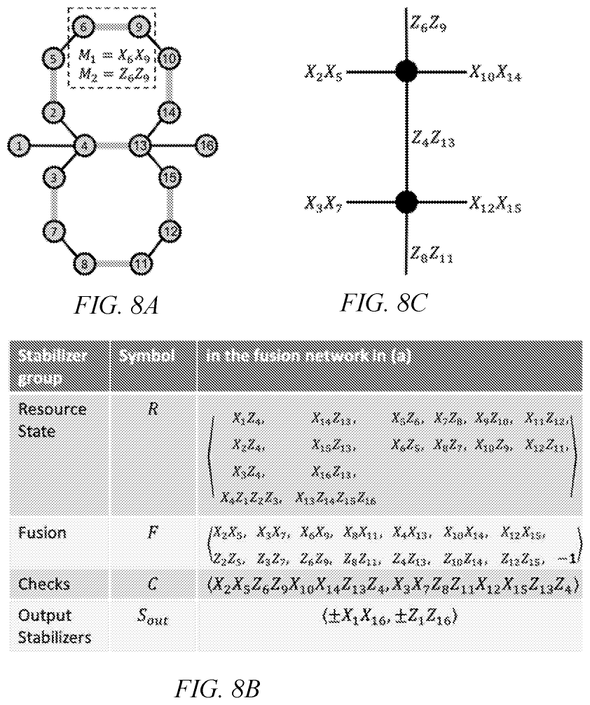

FIGS. 8A-8C show an example of a fusion network along with the explicit definition of these groups. All fusions measure input qubits in the basis XX, ZZ. The output stabilizer group Sₒᵤₜ= [symbol] ±X₁X₈, ±Z₁Z₈ [symbol] i.e. the fusion network produces a Bell pair when all the measurements succeed. FIG. 8A shows an example of a fusion networks for which the resource state group R, fusion group F and check group C can be explicitly defined in FIG. 8B. FIG. 8B shows the set of resource state group generators is the union of the stabilizers of different resource states that can be inferred from their graph state representation. The fusions in green measure input qubits in the basis XX, ZZ. The fusion group is generated by all the fusion measurements and −1. Generators from different resources states in R and different fusions in F are sorted by column. The output stabilizer group Sₒᵤₜ= [symbol] ±X₁X₁₆, ±Z₁Z₁₆ [symbol] i.e. the fusion network produces a Bell pair when all the measurements succeed. The signs in Sₒᵤₜ will depend on the specific measurement outcomes. FIG. 8C shows the syndrome graph from the fusion network (a) with the measurements corresponding to every edge labelled. Multiplying the measurements adjacent to the checks gives us the same generators for C as in table (b) S= [symbol] X₁Z₄Z₁₃Z₁₆,Z₁Z₂Z₃X₄Z₅X₆Z₇X₈X₉Z₁₀X₁₁Z₁₂X₁₃Z₁₄Z₁₅Z₁₆,C

[symbol]

Since F⊆T, it is never necessary to distinguish different errors which are equivalent up to an element of F. We thus choose to express decoding problems in terms of element of P/F (i.e. the full Pauli group quotiented by the fusion group). While distinct elements of P/F may correspond to equivalent errors (according to the fully reduced equivalence classes of P/T), this reduction has the advantage of preserving a large amount of the locality structure in the error model. In particular, single qubit Pauli errors on resource states are interpreted as measurement errors on a corresponding generator(s) of F. When F is composed of Bell fusion measurements, the quotient P/F identifies pairs of single qubit Paulis in P whenever they jointly produce an element of F. We can thus choose to express decoding problems in terms of P/F, which directly corresponds to specifying which fusion outcomes were flipped. For instance, in the example of FIG. 4, the single qubit errors X₄ and X₁₃ are equivalent errors, as they multiply to X₄X₁₃, which is an element of F. Up to this equivalence, errors can be characterized by which generators of F (fusion outcomes) they flip, in this case Z₄Z₁₃.

The most favorable kind of errors are trivial errors which correspond to elements of T. However, they may have non-trivial representations in P or in terms of the fusion outcomes which are flipped. For instance, if the measurement outcomes X₂X₅ and X₁₀X₁₄ are both flipped (i.e. possibly due to an error Z₂Z₁₀), neither check is affected, so Z₂Z₁₀∈U is an undetectable error. The error Z₂Z₁₀ also commutes with the remaining generators of S which means that it is also a trivial error (i.e. Z₂Z₁₀∈T) and will not affect the predicted signs for the output stabilizers. It is immaterial whether the physical error causing the flip of X₂X₅ and X₁₀X₁₄ was Z₂Z₁₀ or any other operator in T. In fact, any combination of outcome for X₂X₅ and X₁₀X₁₄ is equally probable in the idealized setting, and only their combined parity (XOR) is used in extracting check operators and calculating the sign for output stabilizers Sₒᵤₜ.

The worse kind of errors are non-trivial undetectable errors. This is the case of an outcome flip for X₄X₁₃ which could be produced by a single qubit error such as Z₄ or Z₁₃, which belong to U but not to T. Namely, while these errors commute with the check operators in C and will thus go undetected, they anti-commute with one of the additional generators in S. For this reason, they will lead to an incorrect prediction for the sign on ±Z₁Z₆ on the output stabilizers.

The most interesting case, for fault-tolerant fusion networks, is the case of detectable errors. The measurement error in Z₄Z₁₃ corresponds to a detectable error (i.e. X₄∉U), as it would lead to an inconsistency in both the check generators in FIG. 4B. For such detectable errors, it is the job of a decoder to predict the sign of outer stabilizer based on the most likely physical error class consistent with the detection pattern. If the decoder guesses the error class correctly, all logical outcomes will be recovered correctly.

For fault-tolerance, we are interested in fusion networks where the weight of non-trivial undetectable errors, also called the distance of the code, increases with the size of the network. Some examples of such networks are discussed in below. In the large periodic networks that we deal with later, it is inconvenient to explicitly write the full resource state group R and fusion group F as was done in FIG. 4. Instead, we only specify the stabilizers of a single resource state and the stabilizers measured in a single fusion; the resource state and fusion group generators can be obtained by repeating the same stabilizers for different sets of qubits. Instead of writing the check group explicitly, it is more convenient to represent the checks in a graphical manner using a “syndrome graph” that is discussed below.

### B. Local and Topological FTFN

We can introduce a notion of local FTFN that is entirely analogous to other similar constructions in error correction. Namely, a family of stabilizer FTFNs is local if

it has local check operator generators (i.e. each generator involves a bounded number of fusions, and each fusion is involved on a bounded number of generators), for any integer d, there exist fusion networks in the family such that non-trivial undetectable errors have support on at least d qubits.

One can then apply the usual combinatorial arguments to show the existence of error thresholds. For example, if we adopt an error model where our fusions might be erased or randomly flipped, for any given local FTFN there will be a sub-threshold region in the plane defined by the erasure and flip rates such that FT can be achieved. That is, as long as the combination of erasure and flip rate is within the at sub-threshold region we can achieve any desired logical error rate by build a large enough fusion network.

A crucial class of local FTFNs are topological fusion networks. Using the circuit picture as a reference, one can regard (the bulk of) topological fusion networks as mimicking the FT error correction process of a topological code Consequently, for 2D topological codes one obtains 3D topological fusion networks in which elements of the surviving stabilizer group S take the form of membranes (word-lines of string operators) and undetectable errors in U take the form of closed strings (word-lines of topological charges). While there exists the noted equivalence between these 3D topological fusion networks and 2D topological codes, the 3D topological fusion networks are not constrained to represent foliated codes and can support the more general framework of measurement-based fault tolerance described in. Examples of topological FNs based on the toric code are discussed below.

### C. Syndrome Graphs

The redundancy of classical codes associated to fault-tolerant fusion networks is often well described by a syndrome graph representation, which makes it straightforward to apply existing decoders such as minimum-weight matching and union-find decoders to the FBQC framework. Another advantage of the syndrome graph picture is that it allows a graphical way to design fault-tolerance schemes with higher thresholds. However, it should be noted that not all schemes can be naturally represented by a syndrome graph structure.

A syndrome graph is a graphical representation of a classical linear code through a multi-graph, with vertices correspond to check generators and edges corresponding to variable nodes. We will use them in a such a way that each vertex represents a check operator in C, and each edge represents a generator of the fusion group F (or more precisely an error therein). An edge will be attached to a vertex if the corresponding generator of F is used in the factorization of the corresponding check operator in C. Note that given a set of independent generators for the fusion group F, each element of the check group C has a unique factorization in terms of it. Furthermore, note that it is up to the fault-tolerant fusion network, and the choice of generators for C to guarantee that each edge is connected to at most two vertices (i.e. each fusion generator is used in at most two check generators). That this is possible in topological FBQC, is a manifestation of the fact that error chains leave non-trivial syndromes only at their endpoints.

The parity for a check operator is evaluated by taking the joint parity of all the measurement outcomes composing the check. Given a set of fusion measurement outcomes each parity check has an associated parity value of either ±1 or −1. The configuration of all of these parity outcomes is called the syndrome. If a fusion outcome is flipped, the checks incident to its edge in the graph will have their parity values flipped. If a fusion outcome is erased or missing, the two checks incident to the edge in the graph can be multiplied/combined into a single check operator. The syndrome graph may have ‘dangling edges’, where an edge connects to only one check vertex, in this case the check/vertex is removed if the fusion outcome is erased or missing. In some cases there may also be multi-edges between two check nodes when multiple fusion measurement outcomes contribute to the same pair of syndromes.

FIG. 4C shows how the fusion network example can be represented as a syndrome graph. In this simple example there are two check operators, each check operator has four incident edges. There is one edge that is shared by both check operators, connecting the two vertices. The other edges are ‘dangling edges’ connected to only a single check node. In this small example not all fusion outcomes are included in a check operator, but in the topological fault tolerant fusion networks we present in the next section, all fusion outcomes will be part of at least one check operator. Specifically, we will consider topological fusion networks based on the surface code. Like any surface code construction, these networks can be represented by a primal syndrome graph and a dual syndrome graph which are locally disconnected. In the bulk, every Bell fusion contributes two measurement outcomes, which respectively correspond to one edge of the primal and one of the dual syndrome graph.

### VIII. Example Fault-Tolerant Fusion Networks

In this section we describe two explicit examples of fault tolerant fusion networks that implement surface code error correction. These examples provide simple illustrations of how fault-tolerance can be achieved in the FBQC framework. They are chosen as helpful pedagogical examples and are not optimal FBQC architectures. However, even with these examples we demonstrate a significant performance improvement.

### A. “4-Star” Fusion Network

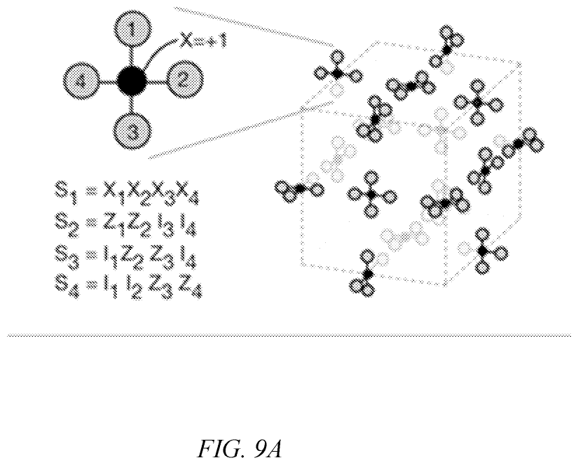

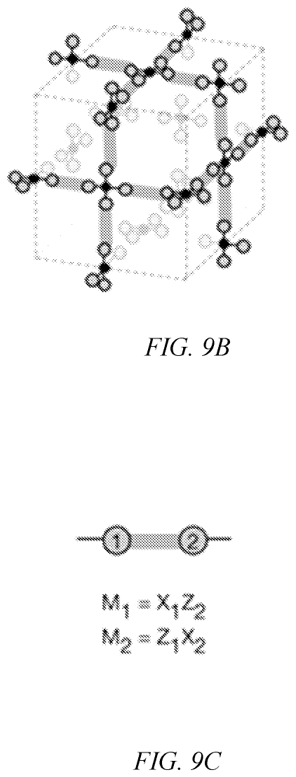

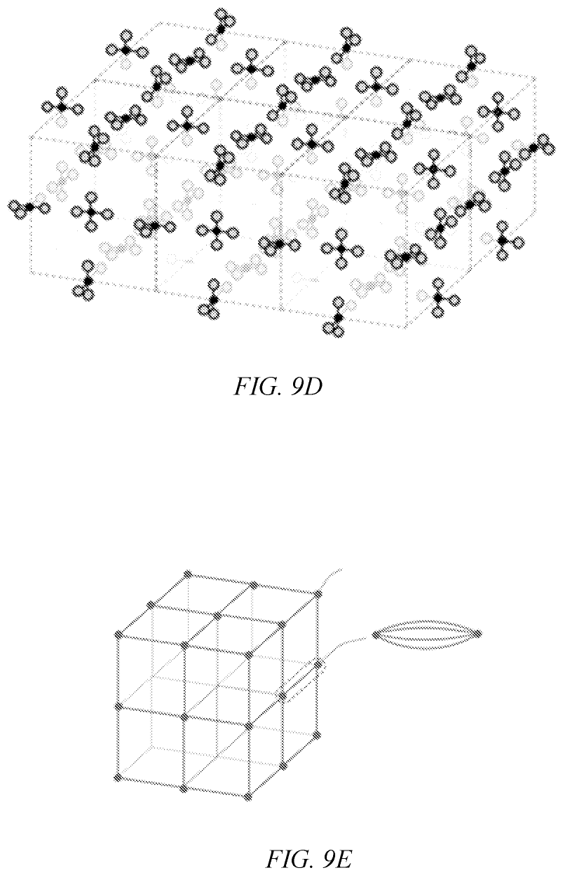

In accordance with some embodiments, a “4-star” fusion network is shown in FIG. 9. The resource state is the four qubit Greenberger-Horne-Zeilinger (GHZ) state with stabilizers Z₁Z₂Z₃Z₄, X₁X₂I₃I₄, I₁X₂X₃I₄ and I₁I₂X₃X₄. For graphical clarity we represent this resource state as a 5-qubit star graph state with the central qubit blacked out (FIG. 9A) because this state is obtained on measuring the central qubit of a 5-star graph state in the X basis with a ‘+1’ outcome. There is no need to prepare a 5 qubit physical resource state, the 4-GHZ state can be created directly. For example using linear optics a 4-GHZ state can be prepared from single photons using circuits described in. The four purple circles, correspond to qubits in the resource state and are input to fusions in the network. The fusion network can be built up from a cubic unit cell as shown in FIGS. 9A and 9D, where a resource state is placed on every face and edge of the unit cell. Resource are aligned parallel to faces or perpendicular to edges. A fusion measurement is made on pairs of qubits from resource states centered at unit cell faces and qubits from resource states centered at neighboring edges as shown in FIG. 9B (If the center qubit in the resource state had not been measured, the fusions would result in the cluster state used in the MBQC implementation of the surface code). Each fusion attempts to measure the stabilizer operators X₁Z₂ and Z₁X₂ as shown in FIG. 9C.

The fusion network results in the syndrome graph shown in FIG. 9E: a cubic lattice, where every edge is a 4-way multi-edge corresponding to four measurement outcomes. In total there are 24 fusion measurements that combine to evaluate each check operator. The fusion network is symmetric under translation by half the lattice constant in all three dimensions. This means that the primal syndrome graph and dual syndrome graph are identical.

Since the syndrome graph is used across hardware implementations of the surface code, it is a useful tool to understand the correspondence between FBQC and a circuit based surface code implementation. In a circuit model, space-like edges in the 3D syndrome graph correspond to physical qubit errors, while time-like edges correspond to measurement errors. In FBQC both time-like and space-like edges correspond to fusion measurement outcomes—there is no distinction between physical and measurement errors in this model. Another point of comparison is the interpretation of the primal and dual syndrome graphs. In a circuit model the primal syndrome graph captures Pauli-X errors, and measurement errors on Z-type parity checks, while the dual syndrome graph captures Pauli-Z errors and measurement errors on X-type checks. In this FBQC example each 2-qubit fusion contributes one measurement outcome to the primal graph, and the other to the dual graph. One way of viewing this is that the two fusion measurement outcomes behave like the Pauli-X and Pauli-Z parts of the error channel on a physical qubit in the circuit model.

### B. “6-Ring” Fusion Network

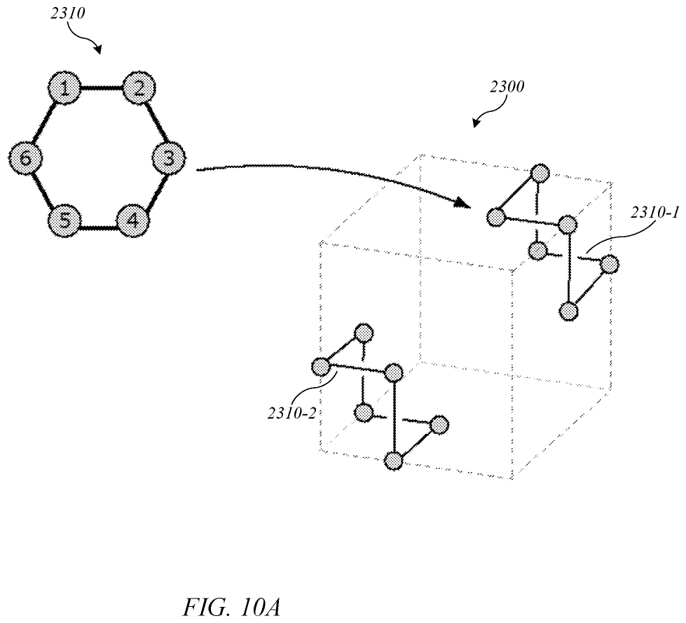

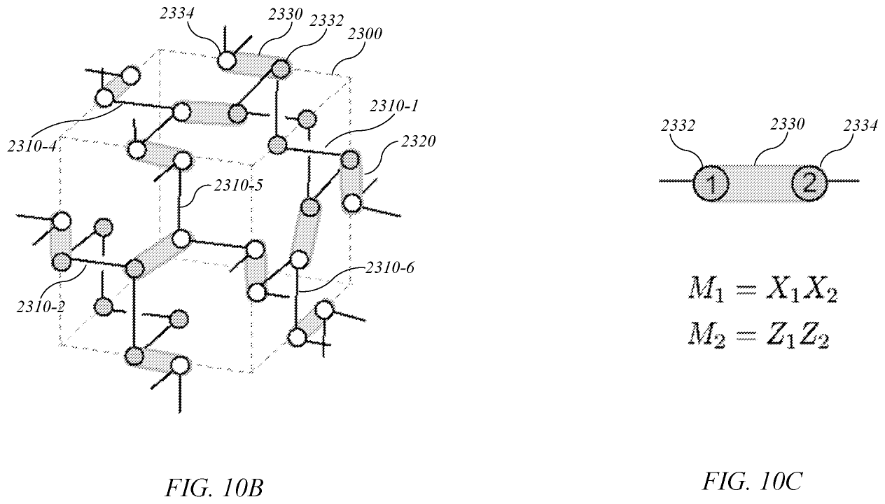

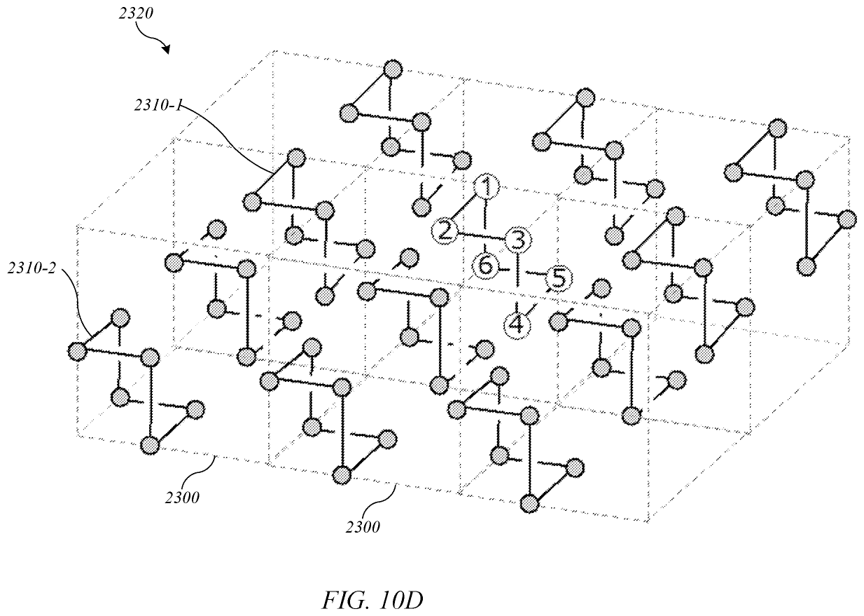

Our second example, the 6-ring fusion network shown in FIG. 10, improves on the 4-star network. It requires fewer resource states and fewer fusion measurements to implement a code of the same distance, and as we will see in the next section, it offers a significantly improved threshold.

In this fusion network the resource states are graph states in the form of six qubit rings. The fusion network has a cubic unit cell with two resource states per unit cell, as depicted in FIGS. 10A and 10D. Fusion measurements connect the pair of qubits at each face and each edge, as shown by the orange lines in FIG. 10B. Each fusion attempts to measure the stabilizer operators X₁X₂ and Z₁Z₂ on the input qubits. FIG. 10 shows multiple unit cells, where it can be seen that the resource states form layers in the planes perpendicular to the (1,1,1) direction. In the sections below, a formal definition of the 4-star and 6-ring fusion networks will be given.

The syndrome graph for this fusion network is depicted in FIG. 10E, and is a cubic lattice with added diagonal edges. Every check vertex has 12 incident measurements, half of the 24 measurements contributing to each check operator in the 4-star network. The 6-ring network has the same symmetry under translation in all three dimensions by half the lattice constant. So, as in the 4-star network, the primal and dual syndrome graphs are identical.

The diagonal edges that show up in the syndrome graph here are a familiar feature in circuit based surface codes, where they would be interpreted as so-called ‘hook’ errors, where a single error event spreads to neighboring qubits during the stabilizer measurement circuit. The origin of this type of correlated error is very different in the fusion network setting, but the appearance in the syndrome graph is the same.

### C. Performance Comparison

We study the performance of these two fusion networks by simulating their behavior under a model of both Pauli errors and erasure. We consider two error models:

A phenomenological error model where every fusion measurement can be erased and flipped with some probability

A linear optical error model where every fusion has a failure probability and every photon in a resource has a probability of being lost.

We perform Monte Carlo simulations of each fusion network with L×L×L unit cells and with periodic boundary conditions in all three dimensions. We draw error samples based on the models above, and use the simplest version of the union-find decoder to perform decoding and count the instances of logical errors. We repeat this simulations over a range of values of the erasure probability and Pauli error rate, and the system size, L, in order to build up a threshold surface in the two error parameters. Primal and dual syndrome graphs are decoded separately.

### D. Phenomenological Error Model

Threshold curve for the star (blue line) and six-ring (orange line) fusion networks with two error parameters: fusion erasure probability pₑᵣₐₛᵤᵣₑ and measurement error probability pₑᵣᵣₒᵣ. The union find decoder is used here. The green star depicts the operating point with erasures due to linear optic failure if qubits in the resource state are encoded in a (2,2) Shor code and all fusions are boosted to 75% success probability with a randomly chosen physical failure basis. The effective erasure probability for encoded fusion with linear optic failure and loss is calculated below.

Every fusion in a fusion network produces two measurement outcomes which we call fusion measurements. The phenomenological error model is an independent and identical error model on the fusion measurements: every measurement in the fusion network is erased with probability pₑᵣₐₛᵤᵣₑ and flipped with probability pₑᵣᵣₒᵣ. This allows capturing single qubit Pauli errors and erasures originating from the resource state generation as well as those derived from the fusions instruments themselves.

Compared to previous studies of fault-tolerant MBQC, which look at the erasure and error thresholds of single qubit measurements on lattices which already have long range entanglement, this model captures errors in the joint measurements used to create long range entanglement starting from small resource states. In this way, what we call a phenomenological error model is closer to a circuit level error model where individual resource states and fusion measurements play the role of elementary gates.

FIG. 5 shows the threshold curve (obtained with a union-find decoder) for the 4-star (blue line) and 6-ring (orange line) fusion networks with this error model. If the combination of erasure probability pₑᵣₐₛᵤᵣₑ and error probability pₑᵣᵣₒᵣ per measurement lies below a threshold curve, the errors are in the correctable region of the corresponding fusion network. In the correctable region, the probability of non-trivial undetectable errors, also called logical errors, are suppressed exponentially in the size of the network.

The correctable region of the 4-star network is contained in the correctable region of the 6-ring network i.e. any value of (pₑᵣₐₛᵤᵣₑ, pₑᵣᵣₒᵣ) that can be corrected by the 4-star network can be corrected by the 6-ring network as well. The marginal pₑᵣₐₛᵤᵣₑ threshold for the 4-star network is 6.9%, while it is 11.9% for the 6-ring network. The marginal pₑᵣᵣₒᵣ threshold for the 6-ring network (0.94%) is also higher than for 4-star (0.65%). For this reason, we say that the 6-ring network is more fault-tolerant than the 4-star network.

A general trend that we observe is that the phenomenological threshold w.r.t. fusion errors in a fault-tolerant fusion network can be improved by relying on larger resource states. This is due to the phenomenological error model only capturing errors in the fusion graph part and no internal errors for the resource states. In general the complexity of a resource state generator will grow with the size and degree of entanglement of the generated states. The trade-offs at play between keeping this complexity as low as possible and raising the phenomenological threshold for fusion errors is one of the key targets for optimization in the design of fault-tolerant FBQC architectures.

### E. Linear Optic Error Model

Threshold curves for the 4-star (blue) and 6-ring (orange) fusion networks under the linear optic error model with photon loss probability pₗₒₛₛ and fusion failure probability p_{fail} with a randomly chosen encoding and failure basis. The green curve corresponds to the 6-ring fusion network with qubits encoded in a (2,2) Shor code. The error model used to evaluate these curves is explained below.

We now examine the performance of these fusion networks under an error model motivated by linear optics. Every fusion is a linear optic “type-II” fusion with four photons: two photons from the qubits being measured and two photons from a Bell pair used to boost the fusion success probability. Each of these four photons, including the two boosting photons, is lost with a probability pₗₒₛₛ≡l. If any photon in a fusion is lost, fewer than expected photons are detected and both fusion outcomes are considered erased. As a result, with probability 1−η⁴, η=1−l, the fusion produces no information. Even if no photons in a fusion are lost, there is a probability p_{fail} that the linear optic fusion performs separable single qubit measurements instead of the intended Bell measurements. As described above, this can be treated as one of the two intended fusion measurements being erased. The linear optic fusion circuit for each fusion is randomly chosen so that the erasure probability of both measurements coming from a fusion is the same. Fusion Error Model details how with this randomization, the erasure probability of every physical fusion measurement in the network is p₀=1−(1−p_{fail}/2)η⁴.

To further reduce the erasure probability, we also consider a case where every qubit in the resource states is replaced by a qubit encoded in the (2,2) Shor code as depicted in FIG. 6. With this replacement, fusions between the (unencoded) qubits in a resource state are replaced by encoded fusions between the encoded qubits in resource states, which are composed of pairwise fusions between the physical qubits that constitute an encoded qubit. Fusion measurements in the network are replaced by encoded fusion measurements.

The (2,2) Shor code refers a four qubit [[4,1,2]] quantum code which can be obtained by concatenating repetition codes for X and Z observables. Depending on the order of concatenation, the resulting code space will be described by the code stabilizers [symbol] XXXX, ZZII, IIZZ [symbol] or [symbol] ZZZZ, XXII, IIXX [symbol] ). For simplicity, we assume that this choice is taken uniformly at random for every encoded fusion. An encoded fusion on two qubits A and B attempts to measure the input encoded qubits in the encoded Bell basis X̅_̅{̅A̅}̅X̅_̅{̅B̅}̅, Z̅_̅{̅A̅}̅Z̅_̅{̅B̅}̅ where X̅ and Z̅ respectively denote encoded X and Z operators for the local (2,2) Shor code that are explicitly defined in below. The local stabilizers in an encoded qubit allow the logical Bell measurement to be performed in multiple ways which suppresses the erasure rate for encoded fusions. Below, we explicitly calculate the erasure probability for measurements in an encoded fusion. If the erasure probability of unencoded fusion measurements is p₀, the probability of encoded fusion measurement erasure is

$${p}_{enc} = \frac{{[ 1 - {( 1 - {p}_{0} )}^{2} ]}^{2} + 1 - {( 1 - {p}_{0}^{2} )}^{2}}{2} .$$

For p₀<0.5, p_{enc}<p₀ i.e. the encoding suppresses the erasure probability.

There are three levels of encoding which we are separately modeling: The lowest level, is the linear-optics specific encoding of representing each physical qubit as a dual-rail photon. A local encoding, such as the (2,2) Shor code can then be used for resource state qubits to achieve an encoded fusion which is less susceptible to failure and loss in linear optic fusions. Finally, fusion networks like the 6-ring network consisting of many resource states and fusions define a topologically protected logical qubit.

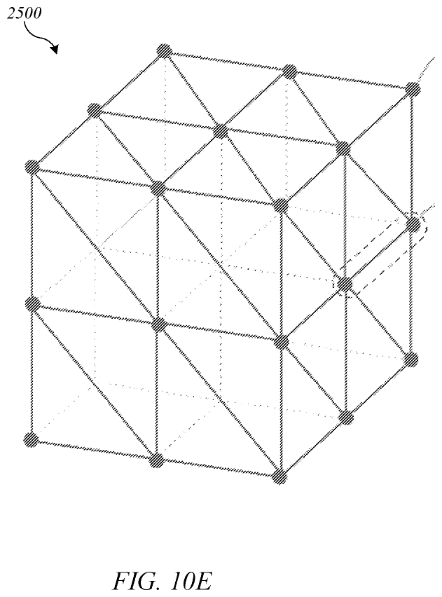

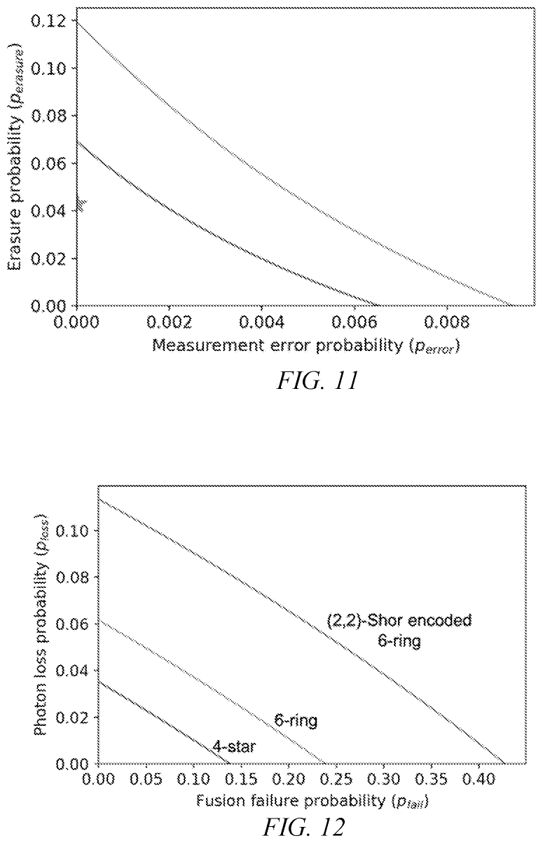

The green star in FIG. 11 shows the magnitude of encoded erasure probability p_{enc}=0.043 when the erasures only come from fusion failure probability p_{fail}=25% which is the value achieved by boosting with a Bell pair. This number can be obtained by combining the expressions for p₀ and p_{enc} in the previous paragraphs in this subsection and is described in detail in below.

With (2,2) Shor encoding, erasures from fusion failure place us inside the correctable region for both the 4-star and 6-ring networks. For the 6-ring network, the gap between this baseline operating point and threshold curve is significantly larger than the 4-star network. The baseline erasure rate is less than half of the erasure marginal leaving room for other errors like photon loss.

We numerically look at the loss tolerance in the presence of fusion failure in FIG. 6. The blue and orange lines represent the threshold curves for the 4-star and 6-ring fusion networks respectively without qubit encoding. The failure threshold for these networks however, is below 25%. With the (2,2) Shor encoding, the 6-ring fusion network provides a significantly larger marginal failure threshold of 43% and marginal loss threshold of 5.9%. With the 25% failure probability achieved with fusions boosted with a Bell pair, we have a loss tolerance of 2.7% per photon. In other words, by boosting fusions with a Bell pair, the fusion network can be in the correctable region even when the probability of at least one photon being lost in a fusion is 10.37%.

IX. Quantum Computation with Fault Tolerant Fusion Networks

The above has described how to create a fault tolerant bulk-which behaves as the fabric of topological quantum computation. Creating the bulk is the most critical component of the architecture, as it is this that determines the error correction threshold. But to implement fault-tolerant computation, additional features are needed. We now turn to the question of how this bulk can be used to implement fault tolerant logic, and the implications for classical processing and physical architecture.

### A. Logical Gates

In order to perform fault tolerant logic, systems and methods disclosed herein allow for the creation of topological features in addition to the bulk. There are different approaches that can be used to create a fault-tolerant Clifford gate set. Boundaries can be used to create punctures which can be braided to perform gates. Boundaries can be used to create patches on which lattice surgery can be performed. Logical qubits can alternatively be encoded in defects and twists. All of these approaches to logic are compatible with FBQC. Such topological features can be created by modifying fusion measurements in certain locations, or adding single qubit measurements in an appropriate configuration. Here we give one example of how to create two types of boundaries in order to facilitate the encoding and manipulation of logical qubits in punctures or patches. In some embodiments, these two boundary types correspond to rough and smooth boundaries in the surface code picture, but in FBQC it is more natural to refer to them as primal and dual boundaries, according to whether they are able to match excitations in the primal/dual syndrome graphs respectively. A primal boundary corresponds to a rough boundary in the primal syndrome graph, and to a smooth boundary in the dual syndrome graph as shown in, e.g., FIG. 22C.

FIG. 13 illustrates one example of how primal and dual boundaries can be created by measuring certain qubits in the Z basis. FIG. 13A shows the creation of a boundary, where the layer of qubits at the boundary of the unit cell are either measured in the Z basis, or simply never created. FIG. 13B shows a similar protocol for creating a smooth boundary. The case in which boundaries are parallel to planes defined by pairs of the unit cell vectors are particularly simple. For such boundaries, the only distinction between the primal and dual case is a displacement by half a unit vector in the perpendicular direction.

The effect of this measurement pattern is to terminate the bulk, creating boundaries which can then be used as a feature to encode and manipulate logical qubits. FIG. 13D shows an example of how these boundaries can be macroscopically assembled to fault tolerantly prepare the state |0> (or |1>) in a patch encoded logical qubit.

### B. Pauli Frame Tracking

In FBQC logical states have a direct physical counterpart only up to a Pauli correction, which is tracked in classical logic through the so called Pauli frame, e.g., within classical computing system 307 of FIG. 3A. The use of a Pauli frame is essentially unavoidable due to the intrinsic randomness which is introduced by teleportations carried out by Bell measurements. For instance, at the logical level, the same component which prepares a |0> state in FIG. 13 will also represent the preparation of a |1>=X|0> state. In general, this means that a state |ψ> may be physically represented by a different state P|ψ> for some tracked Pauli correction operator P.

When relying on Pauli frame tracking, a generic n qubit state can be represented by any of 4ⁿ possible physical quantum states together with 2n classical bits which describe frame. The use of stabilizer codes which protect the logical information practically halves the number of bits required to describe the frame. The key property of this technique is that most of the computation which can be described by Clifford operations can be executed independently of the classical tracking information. The classical Pauli frame data only influences the quantum operations performed at the logical level, in cases such as magic state injection and distillation. This allows classical Pauli frame processing to occur at a logical clock rate rather than at a potentially much faster physical fusion clock rate. Below, we explain how Pauli frame tracking is naturally suited for fault-tolerant FBQC, explaining why this technique only imposes minimal quantum and classical processing requirements.

### C. Universal Logic

To achieve a universal gate set the Clifford gates are supplemented with state injection, which combined with magic state distillation protocols can be used to implement T gates, or other small angle rotation gates. Magic state injection can be implemented in FBQC by performing a modified fusion operation, by making a single qubit

$$\frac{π}{8}$$

measurement, or by replacing a resource state with a special ‘magic’ resource state. These approaches, along with configurations of the injection site provide a multitude of ways to optimize the noisy encoded state preparation.

### D. Decoding and Other Classical Processing

In FBQC, as in other approaches to fault-tolerant quantum computation, classical error-correction protocols are in charge of extracting reliable logical measurement information from the unreliable and noisy physical measurement outcomes. In FBQC it is helpful to view the decoding outcomes as logical Pauli frame information. Keeping track of this logical Pauli frame is necessary to interpret future measurement outcomes.

This logical Pauli frame produces time-sensitive information when logical level feed-forward is required. That is, when a logical measurement outcome is used to decide on a future logical gate it is necessary to have the relevant Pauli frame information available. One example of this if for the realization of T-gates via magic state injection, where a S or S^{†} is applied conditioned on a logical measurement outcome.

One widely discussed challenge of decoding is that during quantum computation it must be performed live. However, it is a crucial feature that this feed-forward operation happens at the logical timescale, and decoding outcomes are not needed at the fusion (or physical qubit) timescale. If decoding is slower than the logical clock rate then buffering or ancillary logical qubits can be used to allow the computation to ‘wait’ for the decoding outcomes. However it is worth emphasizing that these are tools used at the logical level, and it is never necessary to modify any physical operation. Fusions can always proceed without decoding outcomes. An important implication of this is that a slow decoder does not impact threshold.

Nevertheless fast decoders are desirable to reduce unnecessary overhead.

### E. FBQC Architecture

For any given fusion network there are many possible variations of a physical architecture.

FIG. 14A-E shows an example of a fusion router that provides routing that generates the 6-ring fusion network using photonic resource state generators, optical routing and linear optical fusion. This example demonstrates several features of the a scheme for FBQC:
1. Resource state generators can be repeatedly used to create a large fusion network. A fusion network contains many resource states, but they do not all need to co-exist simultaneously. A resource state generator (RSG) that produces a state in each clock cycle can be re-used repeatedly. One natural way to time-order the creation of a large fusion network is to divide it into ‘time slices’. A 3D fusion network is divided into 2D layers, with one layer created at each time step, and fused with the previous layer. This time ordering allows a 3D network to be generated with a 2D array of resource state generators.
2. The fusion routing can be fixed, such that rerouting between each clock cycle is not required. A good design principle in a fusion routing is to minimize the need for switching between clock cycles. This reduces loss and error from switching, and minimizes the need to input classical control signals. In this example layout, every resource state generated at a given location goes to the same fusion devices. This means that the connections of the device are fixed, and no switching is needed to generate the bulk.
3. Logic can be implemented by modifying fusion measurements. To allow logic to be implemented (at least) a subset of the fusion devices should be reconfigurable, as indicated in FIG. 14E). Boundaries or other topological features in the bulk are implemented by changing the measurement basis of the fusion, or switching to single qubit measurements.

The example in FIG. 14 represents a simple physical architecture. With photonic qubits in particular there is a lot of flexibility in how to construct such an architecture. Depending on how long resource states can wait in memory before suffering too much decoherence or loss, more extreme time-ordering approaches can be taken. With photonic resource states the ideas of interleaving, described in WO2020257772A1, can be applied to use a single RSG to create an entire block of a fusion network by creating the network one resource state at a time. As long as the time ordering of state creation is compatible by higher level feedforward constraints at the logical level, any time ordering is possible. This example includes only local connectivity, which is not a requirement for photonic qubits. Long-range connectivity can allow the creation of non-periodic boundary conditions, other topologies, or codes embedded in non-Euclidean spaces. Higher dimensional fusion networks can also be created by combining time ordering structures with appropriate optical connectivity.

i. Circuit Symbols

To facilitate understanding of the description, FIGS. 14A-14D introduce a set of schematic circuit symbols that are used in subsequent figures. These circuit symbols represent photonic/electronic circuits that operate on physical qubits, and each input or output line represents a (physical) qubit. As a matter of drawing convention, inputs are shown at the left and outputs at the right, with the understanding that a schematic circuit drawing need not correspond to a specific physical layout.

FIG. 14A shows a symbol denoting a resource state generator (RSG) circuit 1400. As described above, an RSG circuit can be implemented using any photonic/electronic circuit that produces a resource state. The outputs of RSG circuit 1400 are qubits, where each qubit is indicated by a line; the number of outputs depends on the particular resource state. In embodiments described herein, it is assumed that the RSG circuit generates one resource state per clock cycle, and the length of a clock cycle can be defined based on the time required for one RSG circuit to generate one resource state. The time required can depend on the particular RSG circuit; for instance, some existing RSG circuits can generate a resource state in approximately 1 ns, and a clock cycle can be 1 ns. In some embodiments, a clock cycle can be longer than the time required for an RSG circuit to generate one resource state; it is not required that RSGs operate at maximum speed. For purposes of the present description, it is assumed herein that RSG circuit 1400 outputs all qubits of a resource state in the same clock cycle; however, those skilled in the art with access to this disclosure will appreciate that the timing can be varied.

FIG. 14B shows a symbol denoting a type II fusion circuit 1405. A type II fusion circuit can be implemented, e.g., as described below with reference to FIGS. 23-36, and can be reconfigurable as described above in reference to FIG. 3D. The inputs are two qubits (indicated by solid lines with inward directing arrows), which are consumed by the type II fusion operation as described below. Type II fusion circuit 1405 can provide a classical output signal 1406 indicating the measurement outcome of the fusion and success or failure of the fusion operation and/or a particular type of success or failure (e.g., a pattern of detected photons), where a pattern of detected photons indicates the number of photons detected at each one of the fusion circuit's detectors.

FIG. 14C shows a symbol denoting a switching circuit 1410. Inputs and outputs to switching circuit 1410 can include any number of qubits, and the number of inputs need not equal the number of outputs. Switching circuit 1400 can incorporate any combination of one or more active optical switches, mode couplers, phase shifters, or the like. A switching circuit can be configured to perform an active operation that reconfigures input modes (e.g., to effect a basis change for a qubit by coupling the modes of the qubit) and/or applies a phase to one or more of the input modes (which can affect subsequent coupling between modes). In some embodiments, operation of switching circuit 1410 can be controlled dynamically in response to a classical control signal 111, the state of which can be determined based on results of previous operations, a particular computation to be performed, a configuration setting, timing counters (e.g., for periodic switching), or any other parameter or information.

FIG. 14D shows a symbol denoting a delay circuit 1415. A delay circuit delays a qubit for a fixed length of time and can serve as memory for the quantum information stored in the qubit. The length of time (in clock cycles) is indicated by the number, in this example +1 meaning a 1 clock cycle delay. In the case of photonic qubits, a delay circuit can be implemented, e.g., by providing one or more suitable lengths of optical fiber or other waveguide material, so that the photon of the delayed qubit travels a longer path than the photon of a non-delayed qubit.

FIG. 14E shows a schematic diagram of a system for FBQC using what is referred to herein as networked RSG circuits according to some embodiments where such circuits can generate the topological features described above to implement fault tolerant quantum logic gates. The circuit notation is as described above with reference to FIGS. 14A-14F except that, for clarity of illustration, classical inputs and outputs are not shown. FIG. 14A shows a system that employs 4 representative network cells 1400, 1400′, 1400″, and 1400′″. FIG. 14A also shows couplings among neighboring instances of network cell 1400 within a network such that the couplings form an example of a fusion network router that implements a quantum error correcting code as described above. Each network cell 1400 can include an RSG circuit 1402 that produces a resource state having six peripheral qubits (e.g., the six-ring resource state 1410 shown here). RSG 1402 provides two qubits to neighboring network cells, as shown by the qubit 5 output path referred to herein as the “x-fusion direction” and the qubit 6 output path referred to herein as the “y+ fusion direction”. Network cell 1400 also receives qubits from two neighboring network cells. Specifically, qubit 2 output path referred to herein as the “x+ fusion direction” couples to the output qubit 5′ output path of neighboring network cell 1400′ at a fusion circuit. Likewise, the output path of qubit 3 couples to the output qubit path of qubit 6″ of network cell 1400″.

Network cells 1400, 1400′, 1400′″, 1400″″ can also include a reconfigurable fusion circuits, e.g., reconfigurable fusion circuit 1420′ and as such can implement quantum logic as described in FIG. 13A-13D. Any or all of the other fusion circuits can also be reconfigurable depending on the architecture being implemented, as described in more detail in reference to FIG. 3D. Furthermore to allow for fusion between qubits within resource states that are generated in different clock cycles, a offset can be implemented as shown. For example in each RSG shown, qubit 1 from a resource state generated in a first clock cycle will be fused with qubit 4 from the (different) resource state that is generated in the subsequent clock cycled. Delays other than +1 clock circuit can be implemented and/or delays can be applied to other qubits to implement fusion between any layer and also to implement the interleaving strategies described in, e.g., International Patent Application Publication No. WO2020257772A1, the entire contents of which is hereby incorporated by reference in its entirety for all purposes.

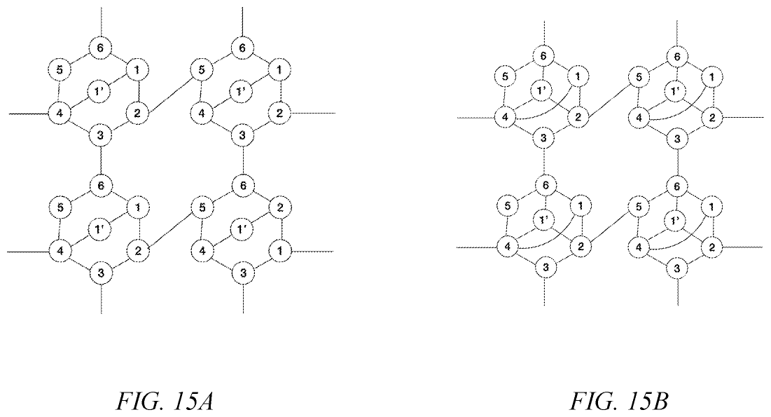

FIGS. 15A and 15B show examples of networked RSG circuits that could be employed, e.g., in a matter based qubit architecture, such as trapped ions, superconducting qubits and the like in accordance with some embodiments. These embodiments also use the 6-ring resource state as shown, with qubits included as numbered circles. Solid lines show qubit couplings that are capable of performing entangling operations between the qubits. For example, such a gate could implement a two qubit bell projection measurement by performing a CZ gate between the two qubits followed by two single qubit measurement in the computational basis. For example, in 15A, to implement an FBQC protocol similar to those described elsewhere herein, first the resource state is generated by applying a CZ gate between the following pairs of qubits: (1,6), (1,2), (2,3), (3,4), (4,5), and (5,6). Next, the two qubit projective Bell measurements are applied between the resource states, e.g., by performing two qubit measurements (fusions) on qubit pairs (2,5), (3,6), and (4,1′). Next the state of qubit 1 is teleported to qubit 1′. In the next time step, a new resource state is generated as before and the process repeats.

In the embodiments shown in FIG. 15B, the FBQC protocol proceeds as follows. In Step 1, the 6-ring resource states are prepared as before by applying CZ gates between the appropriate pairs of qubits: (1,6), (1,2), (2,3), (3,4), (4,5), and (5,6). In step 2a, fusions are applied between the resource states, e.g., between qubit (2,5) and (3,6) from neighboring (different) resource states and between (4,1′) within each resource state. Then in step 2b the state of qubit 1 is teleported to qubit 1′ within each resource state.

### F. Errors in FBQC

The thresholds presented herein are based on simple error models. In a physical implementation there will be many things that affect the system's performance. Error channels will likely have a lot more structure than random i.i.d Pauli errors, including error bias and correlations, and time ordering of operations can spread errors. When logic gates are performed via creating topological features, such as boundaries or twists, these need different physical operations, leading to different error models at those locations.

However, there are a number of reasons that despite this, the results we present here can still be meaningful across many types of physical hardware.
Resource state and fusion errors are intrinsically local. The construction of FBQC limits how far errors can potentially spread. We would expect correlations to exist only within a resource state and not between resource states. This expectation is particularly strong with linear optics, where photons at different locations cannot become ‘accidentally’ entangled with one another. Furthermore, each qubit in the protocol has a short finite lifetime, limiting the potential for the spread of errors in its neighborhood. Furthermore, the resource states and fusions in our models are all identical, so it is a reasonable assumption that they will have the same or similar error rates in a physical implementation.
Correlations within a fusion can only make performance better. A likely place for correlated errors to appear is between the two measurement outcomes of a fusion operation. Our model treats these errors as uncorrelated. Since we decode primal and dual syndrome graphs separately here, if fusion errors were correlated it would make no difference to our thresholds. If there was a way to account for that information, it could only improve the performance.
The bulk determines the threshold. The topological features used to implement logic are 2- or 1-dimensional objects. As a result error threshold is determined by the bulk

Despite the complexity of evaluating an entire system, many hardware level error models can be well approximated by our model via an error channel remapping. For example, if resource states were to be built from a series of noisy two qubit gates suffering errors with probability p_physical, under the standard gate error model, the Pauli-X and Pauli-Z accumulated by each qubit during the state preparation can be accounted for and re-expressed as cumulative error rates. When a cluster state is built out of two qubit gates error cannot propagate further than their nearest neighbors, and so any correlations from propagating errors are only between primal and dual.

### X. Discussion

At the level of fault-tolerant logical gates Fusion-based quantum computing permits the same operations as circuit based quantum computing (CBQC) or measurement based quantum computing (MBQC). But significant differences emerge when looking at the physical processes used to implement the logical gates: in the dependency of resources needed with the computational protocol, in the required connectivity of physical qubits, in the processing of classical information and in the emergence, propagation and impact of errors.

One distinction between FBQC and MBQC is in the nature of the respective entangled states required to implement fault tolerance. MBQC requires a large entangled cluster state, of a size that scales up with the computation being performed. FBQC, on the other hand, requires resource states of a constant size where the number of resource states needed increases for a larger quantum computation. The distinction is also clear in the type of measurements used. MBQC uses single qubit measurements to perform computation, and previous work that propose LOQC architectures to achieve fault-tolerant MBQC did so by first creating the large cluster state resource out of finite size operations, and following this with computational (single-qubit) measurements. No such separation exists in an FBQC protocol, where multi-qubit projective measurements, such as fusion gates, integrate the entangling measurements needed to create long-range entanglement with the measurements that implement fault tolerance and computation. Although not required, in some variations FBQC the protocol may also contain a small number of single qubit measurements, for example to create topological features as described in FIGS. 13A-13D.

When it comes to fault tolerant computation with linear optics, more distinctions arise at the architectural level. LOQC has a long history, with the earliest proposals relying on extremely large gate teleportation or repeat-until-success strategies to handle probabilistic gates, and requiring quantum memories. More recent architecture proposals eliminated the need for memory, schemes for fault tolerance were based on building a large entangled cluster state, and then making single qubit measurements on that state to implement fault tolerance and computation via MBQC. These schemes have a low constant depth, meaning that each photon sees a small fixed number of components during its lifetime, regardless of the size of the computation. The highest performing schemes were based on percolation methods to handle probabilistic fusion. Other schemes used branched resource states to add redundancy, which were able to tolerate probabilistic fusion at the expense of reducing the threshold against loss and Pauli error.

The FBQC schemes disclosed herein use constant sized resources in an architecture with a constant depth, but offer a significant threshold improvement compared to the best results in the literature. Beyond error tolerance, FBQC offers a crucial advantage in architectural viability compared to these previous schemes, where classical processing and feedforward was required to happen during the lifetime of a photon. This classical processing is often complex, and the need to perform a global computation of this kind while a photon waits in a delay line would place extraordinary requirements on the loss of photonic delays. FBQC removes this requirement and makes the fault tolerance threshold independent of the timescale of classical feedforward. In accordance with some embodiments, feedforward is still needed, as is the case in any quantum computing architecture, but in FBQC this requirement is only at the logical level, with a timescale completely separated from physical operations.

FBQC is a modular architecture, composed of small distinct functional blocks: resource state generation, fusion network and fusion operations. The blocks are required to be compatible with each other, but the physical implementation of each block can be independent and, in fact, have multiple options. As an example of its application to a realistic physical system, we have presented examples of a fully linear optical implementation of FBQC. However, it applies more generally to other physical platforms, in particular, it crucially supports applications in hybrid quantum systems. For example, photonic fusion operations and a fiber-based fusion network could be integrated with matter-based resource state generators producing photonic entangled states. Modularity is also a key aspect ensuring an architecture for quantum computing is reliable and manufacturable.

### XI. Decoder Buffering

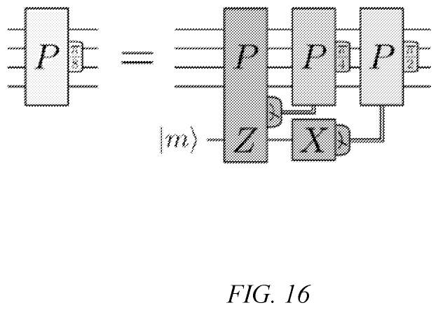

The challenges of decoding and handling classical processing and feedforward at the logical level are shared between all models of quantum computation. Decoders are very unlikely to be able to run as fast as the physical clock speed of the quantum processor. Classical feedforward is required at the logical level (see FIG. 16) and therefore the decoder system should be designed to handle a long latency and to increase to decoder throughput. Here we describe decoder buffering, and decoder parallelization as techniques to address these issues.

FIG. 16 shows an example of a quantum circuit which requires logical feedforward. More specifically FIG. 16 shows a circuit to implement a logical π/8 rotation. A pauli product measurement, P⊗Z is made on target qubits and a magic state, |m>=(|>+e^{iπ/4}|1 [symbol] )/\sqrt{2}. A logical X measurement is made on the magic state. These two steps are known as ‘state injection’. Depending on the outcomes of the two measurements a correction circuit is applied to result in the π/8 rotation on the input qubits.

### A. Decoder System

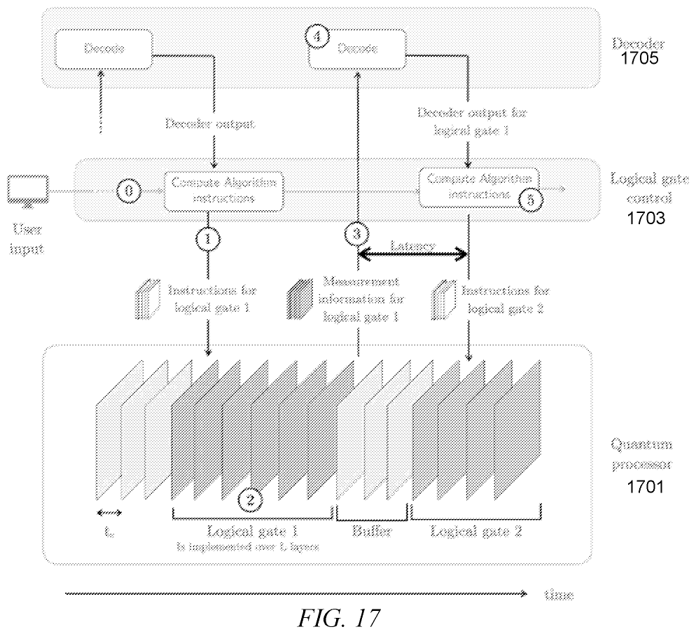

We first introduce the basic functionality of the decoder system and how it interacts with the quantum processing of a logical qubit, and other classical processing. A schematic diagram of the classical information flowing into and out of a quantum system is shown in FIG. 17. This diagram shows the evolution of a system over time as two logical gates are implemented. Here we consider the example of topological quantum computation where a 2D layer of measurement information is obtained in each timestep. Physically this could be achieved either in an FBQC setting where fusion measurements are made on resource states in a 3D fusion network. Or it could be a 2D surface code where parity check measurements are made in each timestep. The system involves three subsystems:
The quantum processor 1701 contains quantum information. The quantum processor can receive and execute measurement instructions that allow fault tolerance and logical gates to be implemented
The logical gate control system 1703 contains the program for the quantum algorithm to be executed. This will contain instructions for logical gates, and feedforward instructions about which gates to implement based on previous measurement results. This receives output from the decoder and send logical gate instructions to the quantum processor.
The decoder system 1705, which receives measurement information from the quantum processor and carries out a classical computation to decode these. The decoder system sends its output to the logical gate control system.

### B. Information Flow

We can understand the flow of information with the following steps, which are indicated in the figure by the numbered circles.

At step 0, the logical gate control contains a quantum program. This originates from user input, and may be compiled offline before the runtime of the quantum processor. The quantum program may contain feedforward steps where future instructions depend on measurements made on the quantum system. After some number of steps of the program have already been executed the logical gate control has a current program state, that
1. First, instructions are issued by the logical gate control system and sent to the quantum processor.
2. The instructions are executed on the quantum system. To implement a logical gate this may involve executing multiple layers of instructions over L timesteps. The instructions could be a gate sequence, a fusion measurement pattern, single qubit measurements, or other physical quantum instructions depending on the nature of the quantum hardware.
3. After the logical gate has been executed we have accumulated L layers of measurement information which are bundled together and passed to the decoder.
4. The decoder receives the measurement information, which we call the decoding problem and computes the corrected measurement result.
5. When decoding has finished the outcome is passed back to the algorithmic control where it is used to compute which logical gate instructions should be issued next.

### G. Timescales

There are several timescales that are relevant to determining how the system should be set up to ensure that logical gate instructions are available when they are needed:
Layer clock time—what is the time between each layer of the computation. We denote this by t_{c}. This timescale may vary significantly between different physical systems. In a photonic system with no interleaving this could be as fast as Ins. With interleaving it may be reduced to 1 μs or longer.

Logical block time—the time to implement a logical gate over L layers, this take time t_log=L*t_c. The value of L needed to reach target logical error rates of interest is typically in the range 30-50. We take a value of L=40 as an example. Depending on the level of interleaving applied t_log could be as low as 40 ns or larger than 40 μs.
Decoder latency—the time taken to run the decoder, t_{D}. Here we take this latency to be the time from the final measurement in the quantum system, to the time that the first logical instruction can be executed, i.e. it includes the time taken for signal transmission in/out of the quantum system, and the computation of algorithmic instructions. The latency cannot be decreased with parallelization. This timescale is indicated by the thick arrow in FIG. 17. The decoder runtime depends on the system size, the error rate, the decoding algorithm. The runtime also depends on the particular measurement configuration, and so in reality the time will be different for every run, following some distribution.

We can consider three different regimes of these timescales which will require different arrangements and methods of the decoding system.
1. Immediate decoding: t_{D}<t_{c}—in the simplest scenario the decoder evaluation is completed within one layer clock cycle. In this case the logical instructions for gate 2 are available in time for the gate to be performed immediately after gate 1 with no lag.
2. Fast decoding: t_c<t_D<t_log—in the second scenario the decoder is slower than one clock cycle, but is completed faster than the time taken to execute a complete logical gate. In this case there must be a lag between the completion of logical gate 1 and logical gate 2. However for this logical qubit only one decoder processor is needed, as it will have finished executing the decoding problem for logical gate 1 by the time it needs to start decoding for logical gate 2. In other words the decoder throughput is large enough to keep up with the rate at which information is produced.
3. Slow decoding: t_c>t_log—finally we consider the case where the decoder run time is longer than the logical gate time. In this case there must be a lag between gates, but an additional issue arises with the throughput of the decoder. With one decoder processor the first decoding problem will still be running when the second arrives. This results in a ‘backlog problem’, where the latency is essentially increasing with every subsequent gate as the queue of waiting decoding problems increases. Fortunately this throughput problem can be resolved using multiple decoder processors to increase the throughput to match the quantum system.

The ‘immediate decoding’ scenario is extremely unlikely to be achievable in a quantum computer, and we will almost certainly encounter the need to deal with some decoder latency, as well as parallelizing the decoder. In the next section we introduce the concept of decoder buffering which can be used as a technique to handle these decoding timing scenarios.

### H. Decoder System Design to Handle Slow Decoding

To address the issues that arise in the ‘fast decoding’ and ‘slow decoding’ regimes defined in the previous section we can use a combination of modifying the logical circuit to allow for decoding latency, and adding additional processors to increase throughput.

### A. Decoder Buffering

When the decoder latency is longer than the layer clock time then we can use decoder buffering to allow the target logical qubit to wait until the next logical gate instructions become available. This buffer region simply implements an identity region after each logical gate where the measurement outcome is needed for feedforward. This identity operation has no logical effect on the qubit. Crucially it is not necessary for the identity ‘buffer region’ to have been decoded in order to determine the next logical gate measurement instructions. The buffer region will need to be decoded at a later point, but the outcome of that decoding gives an update to the Pauli frame that will be used to interpret future measurement results, but this cannot change the determination of what the logical measurement instructions will be.

The buffer time could be chosen to be a fixed duration before each feedforward operation, of a time long enough to cover all decoding run times. Alternatively the duration of the buffer region could be chosen adaptively, such that the logical qubit waits in memory until the next gate instruction becomes available.

### B. Decoder Parallelization

If the logical latency is slower than the logical clock speed then in addition to the buffer we can include additional decoding processors to increase the throughput such that the decoding can be performed at a rate that can ‘keep up’ with the information being produced.

### C. Example Decoding System

In FIG. 18 we show an example configuration of a decoding system that include both buffering and decoder parallelization. We consider the example of the logical feedforward that is needed for a magic state injection circuit. In this case, the first logical gate is state injection which involves coupling a target logical qubit with a distilled magic state, and making a logical measurement. The second logical gate is the correction circuit that is performed dependent on the logical outcome of the first gate. The example in FIG. 18 shows the case that the decoder runtime is roughly two times the logical clock time, and the total decoding latency is roughly three times the logical clock time. A buffer is added of a duration longer than the latency such that the correction gate instructions are ready by the end of the buffer region. To increase the decoder throughput to match the quantum system, we use two decoder processors per logical qubit and decoding problems are then passed to them in an alternating fashion.

### XII. Physical Level Components and Operations

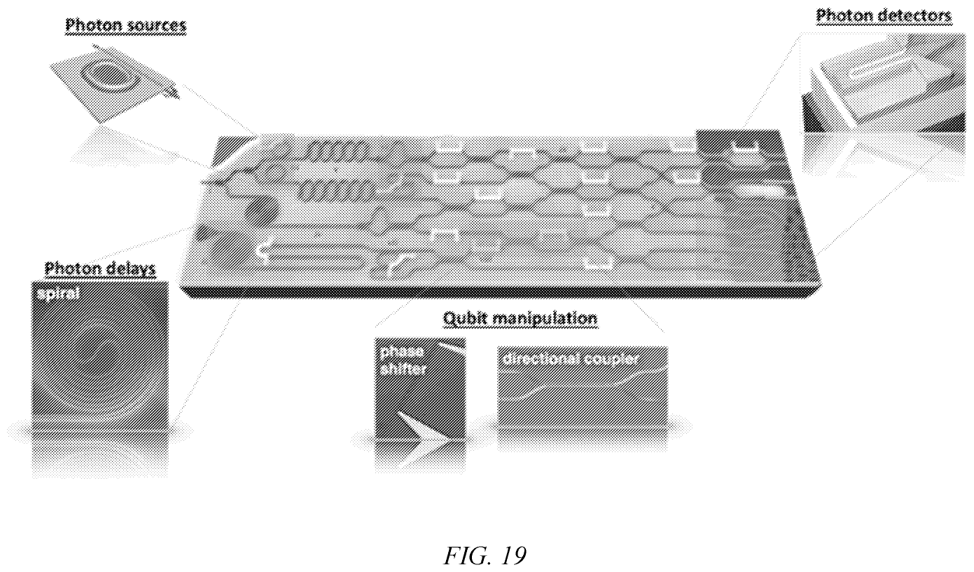

FIG. 19 shows photonic hardware components within a linear optical quantum computer in accordance with some embodiments. In a photonic chip for linear optical quantum computing single photons are emitted by a source, pass along waveguides through a range of linear optical elements, including delays, directional couplers, and active phase shifters, before being detected by a photon counting detector.

In some embodiments, qubit state initialization involves a single photon source. When the source succeeds it produces one and only one photon. The photons produced by each source are nearly identical, including frequency, pulse shape, and timing. In some embodiments, the source can produce photons at a very high repetition rate, e.g., around 1 GHz. A suitable photon generation technique includes spontaneous four-wave mixing to produce photon pairs probabilistically at mid-infrared frequencies close to the optical communication band. One of the two photons is detected, producing an electrical signal that heralds the success of the source.

Since spontaneous four-wave mixing sources do not work with unit probability, it is desirable to multiplex them. By multiplexing multiple sources that operate with low probability it is possible to produce a single source that functions with high probability.

In a multiplexed source, it may be desirable to delay the single photons after generation, e.g., for one or two nanoseconds. This delay provides time for the herald detectors to fire and for the required logic to be performed to actuate an optical switch. The switch routes the photon from the successful source to the desired output waveguide.

In accordance with some embodiments, delays are produced using ultra-low loss waveguides. In some parts of the architecture optical fiber can be used, which is capable of allowing longer delays. Note that the delays that are employed in an FBQC architecture are short and fixed (i.e., do not grow as the size of the computation increases).

In accordance with some embodiments, optical switches can be implemented using generalized Mach-Zehnder interferometers (GMZIs). These interferometers are composed of an array of active phase shifters sandwiched between two completely mixing interference networks (e.g. a Hadamard network). The active phase shifter is a device capable of implementing an optical phase shift upon application of an applied voltage. The completely mixing interference networks can be implemented with passive linear optical elements. The main characteristic of these interference networks is that they transform any single photon input into an equally spread wavefunction over all the modes. At this point each mode enters an active phase shifter implementing one of two phases to the optical mode (0 or π). After this the mode enters another completely-mixing interference network. This implementation allows routing of any input mode of the optical switch to any output mode. There is only a single active phase shifter in the path of the photon which minimizes loss in the switching network. If we only need to switch N input modes to a single output mode the second interference network can be significantly simplified.

In accordance with some embodiments, a photon number resolving detector can perform the qubit measurements, as well as detect herald photons emitted by the sources and can perform measurements required to produce resource states. Many such detectors can be sued, but the chosen technology should have very high quantum efficiency so that if a photon strikes the detector it is detected with very high probability. The detector should also have low dark counts so that in each time-bin the probability that the detector fires with no incident photon is very low. The detector also should be number resolving, so that when two photons strike the detector two counts are reported with high probability. Finally, to operate with a source of single photons at 1 GHz the detectors should have very low timing jitter and rapid reset times.

In accordance with some embodiments, Superconducting Nanowire Single-Photon Detectors (SNSPDs) can be used as the preferred single-photon detection technology for near-infrared photons. The combination of speed, timing accuracy and detection efficiency are superior to many alternatives, but any detector technology could be used without departing from the scope of the present disclosure. In general, SNSPDs require cryogenic operation at a few Kelvin (considerably warmer than the millikelvin temperatures of many matter-based qubits). Furthermore, designs for number resolving detectors involve multiple SNSPDs can be employed. One conceptually simple way to achieve this is with a fanout of the incident waveguide onto a bank of SNSPDs but other designs are possible without departing from the scope of the present disclosure. The number of SNSPDs should be such that the probability of two incident photons striking a single SNSPD is sufficiently low.

In accordance with some embodiments, these hardware components—sources, detectors, delays, and switches—are present in a multiplexed single photon source as indicated in FIG. 20.

Individual photon sources receive a pump laser input pulse and produce a pair of photons, a signal photon and a herald photon. The herald photon can be incident on a bank of photon number resolving detectors. The signal photon passes through a delay prior to being sent to the optical switching network. The schematic indicates a GMZI with 6 input modes and a single output. The Hadamard network is a network of directional couplers that implements a Hadamard transformation on the input modes. In FIG. 20, only the optical elements are shown and the electronic components and interconnects to implement logic and feed forward are not shows for the sake of simplicity.

In each time-bin the electrical signals from each detector pass through some classical logic that determines which source produced a photon. The signal from the logic unit actuates the phase shifters in the GMZI. These electrical elements are not indicated in the schematic. The optical delay should be sufficiently long to allow the detection, logic, and actuation of the phase shifts to take place.

Essentially the same approach to multiplexing can be used at several stages in the architecture. In one example, a typical resource state generator takes multiplexed single photons as input and then produces a Bell state or a GHZ state using a standard method from the literature. These relatively small entangled states are referred to herein as seed states. The resource state generator needs a supply of multiplexed seed states that it will use to build larger entangled resource states through fusion. In accordance with some embodiments, the fusion steps themselves can be multiplexed.

The overhead associated with multiplexing depends on the success probability that is required for the single photon source, for seed states, or for the resource state. Advantageously, in a FBQC architecture the success probability for single photon sources can be chosen independent of the size of the computation. The same is true for both seed state generation and resource state generation. This is true, in part, because failed single photon generation, seed state generation, or resource state generation will ultimately result in missing qubits in known locations, i.e., these errors are heralded. The error correcting code can correct for these missing qubits so long as the system remains below the error correction threshold.

### XIII. ADDITIONAL EMBODIMENTS

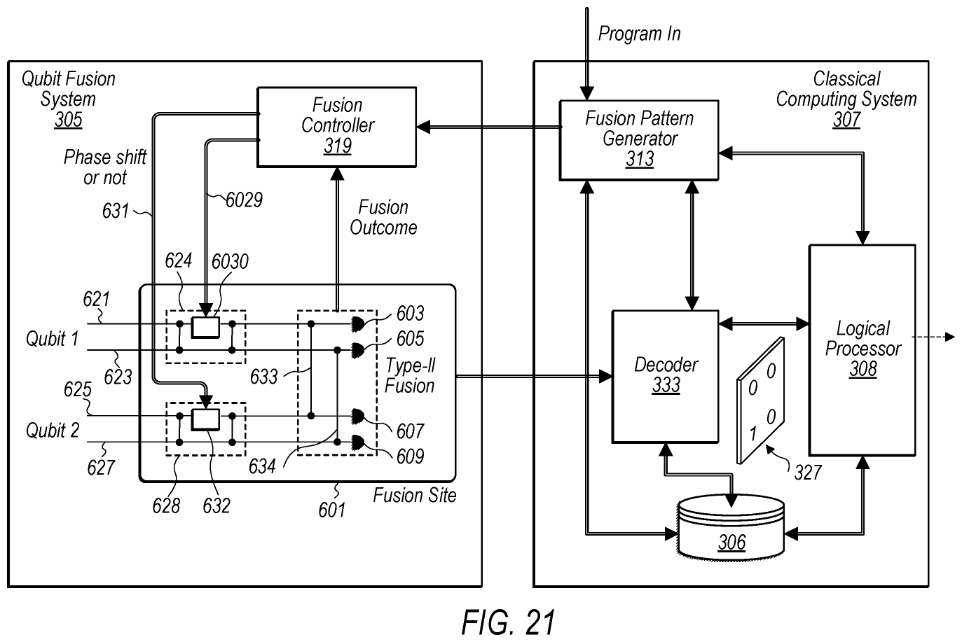

FIG. 21 shows one possible example of a fusion site 6001 as configured to operate with a fusion controller 319 to provide measurement outcomes to a decoder for fault tolerant quantum computation in accordance with some embodiments. In this example, fusion site 6001 can be an element of fusion array 321 (shown in FIG. 3), and although only one instance is shown for purposes of illustration, fusion array 321 can include any number of instances of fusion sites 6001.

As described above, the qubit fusion system 305 can receive two or more qubits (Qubit 1 and Qubit 2, shown here in a dual rail encoding) that are to be fused. Qubit 1 is one qubit that is entangled with one or more other qubits (not shown) as part of a first resource state and Qubit 2 is another qubit that is entangled with one or more other qubits (not shown) as part of a second resource state. Advantageously, in contrast to MBQC, none of the qubits from the first resource state need be entangled with any of the qubits from the second (or any other) resource state in order to facilitate a fault tolerant quantum computation. Also advantageously, at the inputs of a fusion site 6001, the collection of resource states are not mutually entangled to form a cluster state that takes the form of a quantum error correcting code and thus there is no need to store and or maintain a large cluster state with long-range entanglement across the entire cluster state. Also advantageously, the fusion operations that take place at the fusion sites can be fully destructive joint measurements on Qubit 1 and Qubit 2 such that all that is left after the measurement is classical information representing the measurement outcomes on the detectors, e.g., detectors 6003, 6005, 6007, 6009. At this point, the classical information is all that is needed for the decoder 333 to perform quantum error correction, and no further quantum information is propagated through the system. This can be contrasted with an MBQC system that might employ fusion sites to fuse resource states into a cluster state that itself serves as the topological code and only then generates the required classical information via single particle measurements on each qubit in the large cluster state. In such an MBQC system, not only does the large cluster state need to be stored and maintained in the system before the single particle measurements are made, but an extra single particle measurement step needs to be applied (in addition to the fusions used to generate the cluster state) to every qubit of the cluster state in order to generate the classical information required to compute the syndrome graph data required for the decoder to perform quantum error correction.

FIG. 21 shows an illustrative example for one way to implement a fusion site as part of a photonic quantum computer architecture. In this example, qubit 1 and qubit 2 can be dual rail encoded photonic qubits. A brief introduction to the dual-rail encoding of photonic qubits is provided in Section XIV below, in reference to FIGS. 26A-29. Accordingly, qubit 1 and qubit 2 can input on waveguides pair 6021, 6023 and on waveguide pair 6025, 6027, respectively. Interferometers 6024 and 6028 can be placed in line with each qubit, and within one arm of each interferometer 6024, 6028 a programmable phase shifter 6030, 6032 can be optionally applied to affect the basis in which the fusion operation is applied, e.g., by implementing the specific mode couplings shown in FIG. 21 to implement what is referred to herein as XX, XY, YY, or ZZ fusions). The programmable phase shifters 6030, 6032 can be coupled to the fusion controller 319 via control line 6029 and 6031 such that signals from the fusion controller 319 can be used to set the basis in which the fusion operation is applied to the qubits. In some embodiments the basis can be hard-coded within the fusion controller 319, or in some embodiments the basis can be chosen based upon external inputs, e.g., instructions provided by the fusion pattern generator 313. Additional mode couplers, e.g., mode couplers 0633 and 6032 can be applied after the interferometers followed by single photon detectors 6003, 6005, 6007, 6009 to provide a readout mechanism for performing the joint measurement.

In some embodiments, fusion can be probabilistic operation, i.e., it implements a probabilistic Bell measurement, with the measurement sometimes succeeding and sometime failing, as described in FIG. 35 below. In some embodiments, the success probability of such operation can be increased by using extra quantum systems in addition to those onto which the operation is acting upon. Embodiments using extra quantum systems are usually referred to as “boosted” fusion. One of ordinary skill will appreciate that any type of fusion operation can be applied (and may be boosted or unboosted) without departing from the scope of the present disclosure. Additional examples of Type II fusion circuits are shown and described in Section XIV below for both polarization encoding and dual rail path encoding. In some embodiments the fusion controller 319 can also provide a control signal to the detector 6003, 6005, 6007, 6009. A control signal can be used, e.g., for gating the detectors or for otherwise controlling the operation of the detectors. Each of the detectors 6003, 6005, 6007, 6009 provides photon detection signal (representing the number of photons detected by the detector, e.g., 0 photons detected, 1 photon detected, two photons detected, etc.), and this photon detection signal can be preprocessed at the fusion site 6001 to determine a measurement outcome (e.g., fusion success or not) or passed directly to the decoder 333 for further processing.

An example of FBQC employing GHZ Resource States

FIGS. 22A-22B illustrate an FBQC scheme for fault tolerant quantum computation in accordance with one or more embodiments. In this example a topological code known as the Raussendorf lattice (also known as the foliated surface code) is used but any other error correcting code can be used without departing from the scope of the present disclosure. For example, FBQC can be implemented for various volume codes (such as the diamond code, triamond code, etc.), various color codes, or other topological codes can be used without departing from the scope of the present disclosure.

FIG. 22A illustrates one unit cell 2202 of a Raussendorf lattice. For the case of measurement based quantum computing, to determine the value of the syndrome graph, referred to herein as P_{cell}, at the center of the unit cell, the qubits on the six faces of the unit cell are measured in the x-basis resulting in a set of 0 or 1 eigenvalues being determined for each of the six Mₓ measurements. These eigenvalues are then combined as follows

$${P}_{cell - MBQC} = [ {\sum }_{i = 1}^{6} {M}_{x} ( {S}_{i} ) ] mod 2. \qquad ( 2 )$$

where S₁, S₂, . . . , S₆ correspond to the six sites on the faces of the unit cell and Mₓ(Sᵢ) corresponds to the measurement outcomes (0 or 1) obtained by measuring the corresponding face qubits in the x basis. (S₁, S₂, and S₃ are labeled in FIG. 22; S₄, S₅, and S₆ are located on the hidden faces of unit cell 2202.)

In FBQC, the goal is to generate, through a series of joint measurements (e.g., a positive-operator valued measure, also referred to as a POVM) on two or more qubits, a set of classical data that corresponds to the error syndrome of some quantum error correcting code. For example, using the Raussendorf unit cell of FIG. 22A as an illustrative example, the set of measurements that can be used to generate the syndrome graph value in an FBQC approach is shown in FIG. 22B. In this example, GHZ states are used as the resource states, but one of ordinary skill having the benefit of this disclosure will appreciate that any suitable resource state can be used without departing from the scope of the present disclosure. To get from the MBQC scheme shown in FIG. 22A to the FBQC scheme shown in FIG. 22B, every face qubit of FIG. 22A is replaced with individual qubits from distinctly separate (i.e., not entangled) resource states. For instance, four resource states R1, R2, and R3 (encircled by dotted ellipses), are each contributing at least one qubit to what would be the face qubit S2 of the Raussendorf cell are labeled in FIG. 22B. For example, the face qubit S2 in FIG. 22A is replaced with 4 qubits, from three different resource states: resource state R1 contributes two qubits; resource state R2 contributes a third qubit; and resource state R3 contributes the fourth qubit. In operation, the system will perform two fusions at each face (e.g., circles 2221, 2222 in FIG. 22B represent fusions between the contributing qubits of resource state R2 and R1 and R3 and R1, respectively). In an example where the fusions are Type II fusions, all four face qubits are measured, thereby generating four measurement results. In an example where the fusions are Type II fusions, all four face qubits are measured, thereby generating four measurement results. The syndrome graph value for the cell is obtained by Eq. (2) above, but now with

$${M}_{x} ( {S}_{i} ) = [ {F}_{1 , XX} ( {S}_{i} ) + {F}_{2 , XX} ( {S}_{i} ) ] mod 2 \qquad ( 3 )$$

where, for the ith face, F_{1,XX}(Sᵢ) is the measurement outcome obtained by performing the joint measurement on the qubits associated with fusion 1 (e.g., as indicated by circle 721), with the fusion 1 being a type II fusion performed in the XX basis and where F_{2,XX}(Sᵢ) is the measurement outcome obtained by performing the joint measurement on the qubits associated with fusion 2 (e.g., as indicated by circle 722), with the fusion 2 also being a type II fusion performed in the XX basis. Like the measurements associated with the X observable described above in reference to Eqn. (2), the fusion measurements of the observable XX (and ZZ) take the values of zero or 1 corresponding to the positive or negative eigenvectors, respectively, of the measured operators (XX and ZZ, in this example). In view of Eq. (3), to obtain each measurement on a face Mₓ (Sᵢ), correct fusion outcomes for both the fusion measurements F_{1,XX} (Sᵢ) and F_{2,XX} (Sᵢ) are desired. However, if due to some error either fusions fails so that values for the operators cannot be recovered, then in some embodiments, the measurement of the face is considered failed and results in at least one erased edge in the syndrome graph data. One of ordinary skill having the benefit of this disclosure will appreciated that errors can be dealt with by the decoder in a manner that is analogous to that described above in reference to FIGS. 1A-1C. One of ordinary skill in the art will also recognize that while our description of Eqn. (3) focused on the XX observable, the fusion can also produce the measurement of the ZZ observable and that those outcomes can also be combined as per Eqn. (3) to produce an independent set of syndrome graph date. In some embodiments these two sets of syndrome data are referred to as the primal and dual syndrome graphs.

FIG. 22C shows an example of a cluster state made up on several unit cells of the Raussendorf lattice. In an MBQC approach, this entire cluster state would need to be generated, forming an entangled state of many qubits with the entanglement of the state extending across the lattice from one surface boundary to another. In the MBQC approach it is this large entangled cluster state that serves as the quantum error correcting code and thus can encode the logical qubit. Computation proceeds by performing single qubit measurements on each qubit of the entangled state to generate the measurement outcomes that are used to generate the syndrome graph that is fed to the decoder as described above in reference to FIGS. 1A-1C. As such, increasing the error tolerance of the computation requires an increase to the size of the lattice and therefore an increase to the size of the entangled state. In one or more embodiments of the FBQC approach disclose herein, such a large entangled cluster state is not necessary, but rather, smaller resource states are generated, with the size of the resource states being independent of the of the required error tolerance. As described in detail above in reference to FIG. 22, the FBQC approach can be constructed from any fault tolerant lattice by replacing each node of the lattice with a set of fusions between two or more adjacent resource states. This construction of replacing each node of the lattice with a resource state/fusions is merely one example of obtaining an FBQC scheme and one of ordinary skill having the benefit of this disclosure will recognize that many different ways of constructing an FBQC scheme from a fault tolerant lattice can be employed without departing from the scope of the present disclosure.

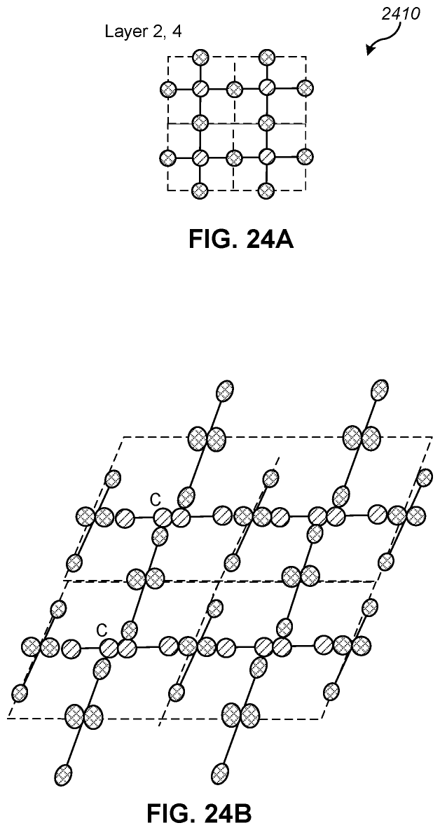

Furthermore, as described in more detail below, the process can proceed by generating a layer of resource states in a given clock cycle and performing fusions within each layer, as described in FIG. 23-24 below. For example, in FIG. 22C, the horizontal direction represents time in the sense that all or a subset of the qubits in any given layer in the x-y plane can be generated/initialized at the same clock cycle, e.g., qubits in Layer 1 can be generated at clock cycle 1, qubits in layer 2 can be generated at clock cycle 2, qubits in layer 3 can be generated at clock cycle 3, etc. As will be described in more detail below, a certain subset qubits in each layer can be stored/delayed such that they are available to be fused with qubits from resource states in a subsequent layer, if necessary to enable fault tolerance.

In some embodiments, in order to generate a desired error syndrome, a lattice preparation protocol (LPP) can be designed that generates the appropriate syndrome graph from the fusions of multiple smaller entangled resource states. FIGS. 23-24 show an example of a lattice preparation protocol according to some embodiments. For the purposes of illustration, the resource states are states such as resource state 2300 shown in FIG. 23A; however other resource states can be used without departing from the scope of the present disclosure. The resource state 2300 is equivalent to a GHZ state up to the application of Hadamard gates to single qubits. For example, the states used in the example disclosed herein are equivalent to GHZ states up to the application of Hadamard gates to the two terminating end qubits 2300a-3 and 2300a-4 in FIG. 23A. More specifically, a 4-GHZ state can be identified as a stabilizer state having the following stabilizers: [symbol] XXXX,ZZII,ZIZI,ZIIZ [symbol] . The resource state 2300 shown in FIG. 23A is closely related to this GHZ state, but the stabilizers of state 2300 are [symbol] XXZZ,ZZII,ZIXI,ZIIX [symbol] (with the ordering of the operators corresponding to qubits 2300a-1, 2300a-2, 2300a-3, and 2300a-4, respectively). One of ordinary skill will appreciate that 4-GHZ state and the resource state 2300 are equivalent under the application of a Hadamard gate on qubits 2300-a3 and 2300-a4.

The time direction in FIGS. 23-24 is perpendicular to the page such that a resource state having a shape such as resource state 2310 represents a collection of qubits, qubits 1, 2, and 3 that are mutually entangled within the same clock cycle and qubit 4 which is entangled in the time dimension with, e.g., qubits 2 and 3. Such a resource state can be created by, e.g., generating the full 4 qubit resource state in a single clock cycle and then storing qubit 4 for a fixed time period (e.g., one clock cycle) in a memory. As used herein the term “memory” includes at any type of memory, e.g., a quantum memory, a qubit delay line, a shift register for qubits, a qubit itself, and the like. In the case of photonic resource states, qubit memories such as these are equivalent to qubit delays and can thus be implemented through the use of optical fiber. In the example shown in FIG. 23C, the delay to qubit 4 is represented schematically by a loop of additional optical path length (e.g. provided by an optical fiber) placed inline with the existing optical path of the qubit but that is not present in the optical path of qubits 1-3. In this example the length of the fiber is such that it implements a single clock cycle delay of duration T but other delays are possible as well, e.g., 2T, 3T, etc. In terms of physical delay times, such delays could be in the range of 500 ps-500 ns but any delay is possible without departing from the scope of the present disclosure.

Returning to the FBQC process disclosed herein, FIGS. 23-24 show an example of how a lattice preparation and measurement protocol for FBQC can proceed according to layers. FIG. 23A shows a portion of the underlying layer of the Raussendorf lattice shown as layer 2310 (corresponding to a portion of Layer 1 shown in FIG. 22C). In the example illustrated here, to process a layer like that shown in FIG. 23A, first multiple resource states 2300 are generated (e.g., in qubit entangling system 303 of FIG. 3). In this example, the resource state 2300 is an entangled state comprising 4 physical qubits (also referred to herein as quantum sub-systems): qubits 2300a-1, 2300a-2, 2300a-3, 2300a-4. In some embodiments, the resource state 2300 can take the form of a 4-GHZ state where the two terminating end qubits 2300a-4 and 2300a-3 have undergone a Hadamard operation (e.g., for the case of a dual rail encoded qubit, by way of applying a 50:50 beamsplitter between the two rails that form the qubit). In some embodiments, not all qubits in the layer are subject to fusions in this clock cycle, but rather some of the qubits generated during this clock cycle from certain resource states can be delayed, e.g., the measurement of qubit 2320, redundantly encoded qubit 2305, or any other qubit can be delayed so that the qubit will be available at the next clock cycle. Such delayed qubits are then available to be fused with one or more qubits from resource states that will only be available for fusions at the next clock cycle.

In examples that employ a photonic implementation, the qubits from the resource states can then be routed appropriately (via integrated waveguides, optical fiber, or any other suitable photonic routing technology) to the qubit fusion system (e.g., qubit fusion system 305 of FIG. 3) to enable a set of fusion measurements that implement quantum error correction, i.e., that will result in collecting the measurement outcomes that correspond to the error syndrome of choice. While this example explicitly uses a topological code based on the Raussendorf lattice, any code can be used without departing from the scope of the present disclosure.

FIG. 23B shows an example of a collection of GHZ resource states arranged, i.e., that they have been pre-routed, such that the qubits that are to be sent to a given fusion gate are positioned graphically adjacent to each other. For qubits that are adjacent to each other in this illustration, respective fusions can be performed between pairs of qubits (also referred to herein as respective quantum sub-systems, with each qubit from the pair of qubits input on a fusion site belonging to a different respective resource state). For example, at site 2302, two Type II fusion measurements can be applied, one between qubits 2322 and 2324 and one between qubits 2326 and 2328. It should be noted that before the fusions are performed qubits 2322 and 2324 (or qubits 2326 and 2328) are not entangled with one another but instead are each part of a distinct resource state. As such, the large entangled cluster state known as the Raussendorf lattice is not present before the fusion measurements are performed.

Referring to FIG. 24A, a portion of a second layer of the underlying code structure is shown as layer 2410 (corresponding to layer 2 shown in FIG. 22C). In an FBQC system, to process a single layer like that shown in FIG. 24B the FBQC method proceeds along the same lines as described above in reference to FIGS. 23A-23B so the details will not be repeated here.

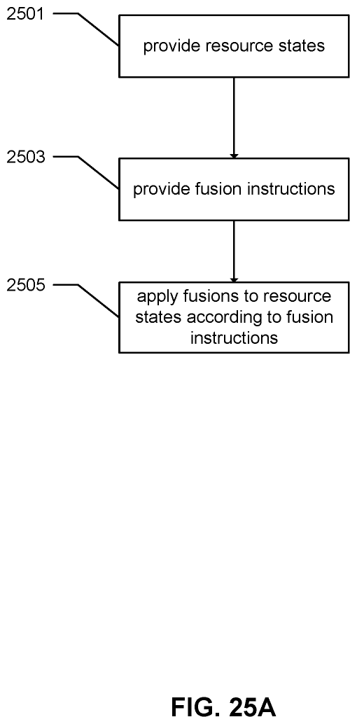

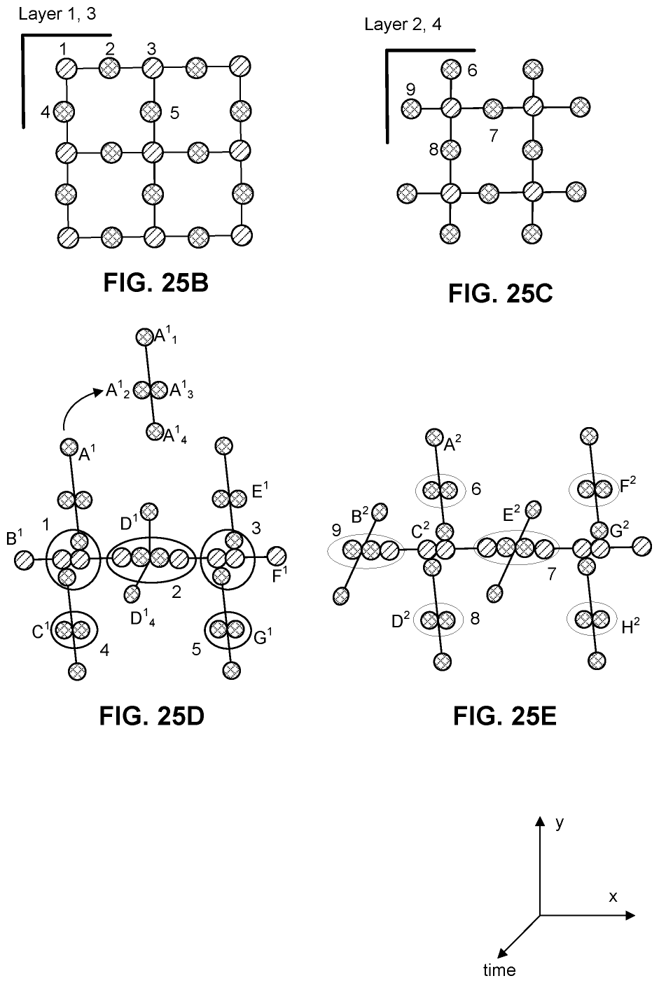

FIGS. 25A-25E show in further detail a method for performing FBQC in accordance with one or more embodiments. More specifically, the method described here includes steps for performing the joint measurements for a particular quantum error correcting code according to some embodiments, where the different layers of the code may be generated at different time steps (clock cycles) as introduced above in reference to FIGS. 23-24 and entangled together in a manner that provides for fusions measurements to extract the necessary syndrome information for performing quantum error correction. Like other examples provided herein, the Raussendorf lattice is used for the sake of illustration but other codes can be used without departing from the scope of the present disclosure.

For example, FIGS. 25A and 25B shows portions of layers 1 and 3, and layers 2 and 4, respectively, from the Raussendorf lattice of FIG. 22C (referred to here as the quantum error correcting (QEC) code). FIGS. 25C and 25D illustrate a method for processing these layers in an FBQC system, including example resource states that could be used. For the sake of example, the description is limited to vertices 1, 2, 3, and 4 of the QEC code and the example focuses on how to perform the resource state generation and measurements in an FBQC system.

Returning to FIG. 25A, in step 2501, a first set of the resource states are provided during a first clock cycle. FIG. 25D shows one example where, instead of single qubits being provided at vertices 1, 2, 3, 4, 5, etc. with those single qubits being mutually entangled across the lattice (as would be the case for a MBQC system), two or more qubits are provided, each originating from different, non-entangled, resource states, e.g., respective resource states A, B, C, D, E, F, and G. As used herein, the notation Aij is used to denote the j-th qubit from the A-th resource state of the i-th layer. For example, the A-th resource state of layer 1 in FIG. 25D is a GHZ state that includes 4 qubits, labeled A11, A12, A13, A14 as shown. Likewise, the qubits comprising resource state B that is provided as part of layer 1 can be labeled as B11, B12, B13, B14 (but this time with labels not explicitly shown in the figure to avoid cluttering the diagram). Qubits that will be fused to generate the syndrome information associated with vertices 1, 2, 3, 4, 5 are also shown as enclosed by solid ellipses 1, 2, 3, and 4 in FIG. 25D. As used herein these vertices are each associated with hardware for performing Type II fusions at fusion sites, as described above.

In some embodiments, the resource states for any given layer can be generated/provided by a qubit entangling system such as that described above in reference to FIG. 3. However, one of ordinary skill having the benefit of this disclosure will understand that any qubit entangling system can be employed, and that a given qubit entangling system can employ many different types of resource state generators, even generating different types of resource states. In this sense, an FBQC system is completely agnostic to the choice of resource states and choice of architecture for the qubit entangling system, or even the architecture of the qubit itself, thereby leaving the system designer a great deal of flexibility to implement a system that results in the highest threshold for the given the prevailing error/noise sources.

In Step 2503, fusion instructions in the form of classical data (also referred to herein as a fusion pattern) are provided to the fusion sites. Referring back to FIG. 3, for example, fusion pattern data frame 317 is one example of the set of fusion instructions (e.g., Type II fusion measurements in the XX basis) that can be applied between pairs of qubits from different entangled resource states at a fusion site during a certain clock cycle as a quantum application is executed on the FBQC system. As also described above, in some embodiments, several fusion pattern data frames can be stored in memory as classical data. In some embodiments, the fusion pattern data frames can dictate whether or not XX Type II Fusion is to be applied (or whether any other type of fusion, or not, is to be applied) for a particular fusion gate within the fusion site. In addition, the fusion pattern data frames can indicate that the Type II fusion is to be performed in a different basis, e.g., XX, XY, ZZ, etc.

Returning to FIG. 25D, the fusion instructions for Layer 1 can include fusion parameters (qubit location and basis) to fuse two or more qubits from different resource states (also referred to herein as respective quantum sub-systems because the qubits reside in, or are part of, respectively separate resource states). For example, for fusion site 1 the fusion instructions can specify the fusion parameters to indicate that XX Type II Fusions are to be performed between qubits from resource states A1, B1, and C1 (and similarly for site 3 between E1, F1, and G1). More specifically, the two Type II Fusions to be performed at fusion site 1 can be specified to be between A14 and B12 and between C11 and B13. Similar instructions are provided for the other fusion sites in the layer. For example, for fusion site 2, the fusion instructions can specify the fusion parameters to indicate that XX Type II Fusions are to be performed between qubits from resource states B1, D1, and F1. More specifically, the two Type II Fusions to be performed at fusion site 2 can be specified to be between B14 and D12 and between D13 and F14. However, unlike the case for fusion site 1, where all the qubits were measured, fusion site 2 includes a qubit that is to remain unmeasured until the second clock cycle. This is because the underlying structure of the QEC lattice requires that the quantum state of this qubit to be preserved until it is to be fused to a qubit from a different layer at a different clock cycle, i.e., if this were an MBQC scheme the qubit associated with this vertex would be one that is entangled with qubit in another layer, e.g., qubits 2 and 6 shown in FIGS. 25B and 25C, respectively.

Returning to the explicit example shown in FIG. 25D, the fusion instructions can specify that D14 will not be measured until the next clock cycle, where it will be fused from qubits in a later layer, e.g., layer 2 shown in FIG. 25E. In a photonic implementation optical fiber can implement a qubit delay for the above function, serving as a reliable quantum memory to store qubits until they are needed for a future clock cycle. As used herein, these unmeasured (delayed) qubits are referred to as unmeasured quantum sub-systems.

Moving on to fusion site 4, this site is an example that includes fusions between layers, i.e., fusion between qubits from resource states that were generated in this clock cycle with qubits from resource states that were generated in a prior clock cycle but were not measured at that time but instead were delayed, or equivalently, stored until the next clock cycle. For fusion site 4, the fusion instructions can specify the fusion parameters to indicate that XX Type II Fusions are to be performed between qubits from resource states in three different layers C1, B0, and B2. The fusion instructions can also include instructions to delay (not measure) qubits C12 and C13 until the next clock cycle. For example, in this case, the fusion instructions can indicate that in the next time step, C12 is to be fused with B04 and C13 is to be fused with B21.

In Step 2503, the fusion operations that are specified by the fusion instructions are performed, thereby generating classical data in the form of fusion measurement outcomes. As described above in reference to FIGS. 3 and Eq. (2), this classical data is then passed to the decoder and is used to construct the syndrome graph to be used for quantum error correction.

These examples are illustrative. The choice of error correcting code determines the set of qubit pairs that are fused from certain resource states, such that the output of the qubit fusion system is the classical data from which the syndrome graph can be directly constructed. In some embodiments, the classical error syndrome data is generated directly from the qubit fusion system without the need to preform additional single particle measurements on any remaining qubits. In some embodiments, the joint measurements performed at the qubit fusion system are destructive of the qubits upon which joint measurement is performed.

### Introduction to Qubits and Path Encoding

The dynamics of quantum objects, e.g., photons, electrons, atoms, ions, molecules, nanostructures, and the like, follow the rules of quantum theory. More specifically, in quantum theory, the quantum state of a quantum object, e.g., a photon, is described by a set of physical properties, the complete set of which is referred to as a mode. In some embodiments, a mode is defined by specifying the value (or distribution of values) of one or more properties of the quantum object. For example, again for photons, modes can be defined by the frequency of the photon, the position in space of the photon (e.g., which waveguide or superposition of waveguides the photon is propagating within), the associated direction of propagation (e.g., the k-vector for a photon in free space), the polarization state of the photon (e.g., the direction (horizontal or vertical) of the photon's electric and/or magnetic fields) and the like.

For the case of photons propagating in a waveguide, it is convenient to express the state of the photon as one of a set of discrete spatio-temporal modes. For example, the spatial mode ki of the photon is determined according to which one of a finite set of discrete waveguides the photon can be propagating in. Furthermore, the temporal mode tj is determined by which one of a set of discrete time periods (referred to herein as “bins”) the photon can be present in. In some embodiments, the temporal discretization of the system can be provided by the timing of a pulsed laser which is responsible for generating the photons. In the examples below, spatial modes will be used primarily to avoid complication of the description. However, one of ordinary skill will appreciate that the systems and methods can apply to any type of mode, e.g., temporal modes, polarization modes, and any other mode or set of modes that serves to specify the quantum state. Furthermore, in the description that follows, embodiments will be described that employ photonic waveguides to define the spatial modes of the photon. However, one of ordinary skill having the benefit of this disclosure will appreciate that any type of mode, e.g., polarization modes, temporal modes, and the like, can be used without departing from the scope of the present disclosure.

For quantum systems of multiple indistinguishable particles, rather than describing the quantum state of each particle in the system, it is useful to describe the quantum state of the entire many-body system using the formalism of Fock states (sometimes referred to as the occupation number representation). In the Fock state description, the many-body quantum state is specified by how many particles there are in each mode of the system. Because modes are the complete set of properties, this description is sufficient. For example, a multi-mode, two particle Fock state |1001 [symbol] _{1,2,3,4} specifies a two-particle quantum state with one photon in mode 1, zero photons in mode 2, zero photons in mode three, and 1 photon in mode four. Again, as introduced above, a mode can be any set of properties of the quantum object (and can depend on the single particle basis states being used to define the quantum state). For the case of the photon, any two modes of the electromagnetic field can be used, e.g., one may design the system to use modes that are related to a degree of freedom that can be manipulated passively with linear optics. For example, polarization, spatial degree of freedom, or angular momentum, could be used. For example, the four-mode system represented by the two particle Fock state |1001 [symbol] _{1,2,3,4} can be physically implemented as four distinct waveguides with two of the four waveguides (representing mode 1 and mode 4, respectively) having one photon travelling within them. Other examples of a state of such a many-body quantum system are the four photon Fock state |1111 [symbol] _{1,2,3,4} that represents each waveguide containing one photon and the four photon Fock state |2200 [symbol] _{1,2,3,4} that represents waveguides one and two respectively housing two photons and waveguides three and four housing zero photons. For modes having zero photons present, the term “vacuum mode” is used. For example, for the four photon Fock state |2200 [symbol] _{1,2,3,4} modes 3 and 4 are referred to herein as “vacuum modes” (also referred to as “ancilla modes”).

As used herein, a “qubit” (or quantum bit) is a physical quantum system with an associated quantum state that can be used to encode information. Qubits, in contrast to classical bits, can have a state that is a superposition of logical values such as 0 and 1. In some embodiments, a qubit is “dual-rail encoded” such that the logical value of the qubit is encoded by occupation of one of two modes by exactly one photon (a single photon). For example, consider the two spatial modes of a photonic system associated with two distinct waveguides. In some embodiments, the logical 0 and 1 values can be encoded as follows:

$${{\vert 0 〉}_{L} = \vert 10 〉}_{1 , 2} \qquad ( 3 )$$

$${{\vert 1 〉}_{L} = \vert 01 〉}_{1 , 2} \qquad ( 4 )$$

where the subscript “L” indicates that the ket represents a logical value (e.g., a qubit value) and, as before, the notation |ij [symbol] _{1,2} on the right-hand side of the Equations (3)-(4) above indicates that there are i photons in a first waveguide and j photons in a second waveguide, respectively (e.g., where i and j are integers). In this notation, a two qubit state having a logical value |01 [symbol] /(representing a state of two qubits, the first qubit being in a ‘0’ logical state and the second qubit being in a ‘1’ logical state) may be represented using photon occupations across four distinct waveguides by |1001 [symbol] _{1,2,3,4} (i.e., one photon in a first waveguide, zero photons in a second waveguide, zero photons in a third waveguide, and one photon in a fourth waveguide). In some instances, throughout this disclosure, the various subscripts are omitted to avoid unnecessary mathematical clutter.

### XIV. LOQC Introduction

### A. Dual Rail Photonic Qubits

Qubits (and operations on qubits) can be implemented using a variety of physical systems. In some examples described herein, qubits are provided in an integrated photonic system employing waveguides, beam splitters (or directional couplers), photonic switches, and single photon detectors, and the modes that can be occupied by photons are spatiotemporal modes that correspond to presence of a photon in a waveguide. Modes can be coupled using mode couplers, e.g., optical beam splitters, to implement transformation operations, and measurement operations can be implemented by coupling single-photon detectors to specific waveguides. One of ordinary skill in the art with access to this disclosure will appreciate that modes defined by any appropriate set of degrees of freedom, e.g., polarization modes, temporal modes, and the like, can be used without departing from the scope of the present disclosure. For instance, for modes that only differ in polarization (e.g., horizontal (H) and vertical (V)), a mode coupler can be any optical element that coherently rotates polarization, e.g., a birefringent material such as a waveplate. For other systems such as ion trap systems or neutral atom systems, a mode coupler can be any physical mechanism that can couple two modes, e.g., a pulsed electromagnetic field that is tuned to couple two internal states of the atom/ion.

In some embodiments of a photonic quantum computing system using dual-rail encoding, a qubit can be implemented using a pair of waveguides. FIG. 26A shows two representations (2600, 2600′) of a portion of a pair of waveguides 2602, 2604 that can be used to provide a dual-rail-encoded photonic qubit. At 2600, a photon 2606 is in waveguide 2602 and no photon is in waveguide 2604 (also referred to as a vacuum mode); in some embodiments, this corresponds to the |0 [symbol] state of a photonic qubit. At 2600′, a photon 2608 is in waveguide 2604, and no photon is in waveguide 2602; in some embodiments this corresponds to the |1 [symbol] state of the photonic qubit. To prepare a photonic qubit in a known state, a photon source (not shown) can be coupled to one end of one of the waveguides. The photon source can be operated to emit a single photon into the waveguide to which it is coupled, thereby preparing a photonic qubit in a known state. Photons travel through the waveguides, and by periodically operating the photon source, a quantum system having qubits whose logical states map to different temporal modes of the photonic system can be created in the same pair of waveguides. In addition, by providing multiple pairs of waveguides, a quantum system having qubits whose logical states correspond to different spatiotemporal modes can be created. It should be understood that the waveguides in such a system need not have any particular spatial relationship to each other. For instance, they can be but need not be arranged in parallel.

Occupied modes can be created by using a photon source to generate a photon that then propagates in the desired waveguide. A photon source can be, for instance, a resonator-based source that emits photon pairs, also referred to as a heralded single photon source. In one example of such a source, the source is driven by a pump, e.g., a light pulse, that is coupled into a system of optical resonators that, through a nonlinear optical process (e.g., spontaneous four wave mixing (SFWM), spontaneous parametric down-conversion (SPDC), second harmonic generation, or the like), can generate a pair of photons. Many different types of photon sources can be employed. Examples of photon pair sources can include a microring-based spontaneous four wave mixing (SPFW) heralded photon source (HPS). However, the precise type of photon source used is not critical and any type of source, employing any process, such as SPFW, SPDC, or any other process can be used. Other classes of sources that do not necessarily require a nonlinear material can also be employed, such as those that employ atomic and/or artificial atomic systems, e.g., quantum dot sources, color centers in crystals, and the like. In some cases, sources may or may not be coupled to photonic cavities, e.g., as can be the case for artificial atomic systems such as quantum dots coupled to cavities. Other types of photon sources also exist for SPWM and SPDC, such as optomechanical systems and the like.

In such cases, operation of the photon source may be deterministic or non-deterministic (also sometimes referred to as “stochastic”) such that a given pump pulse may or may not produce a photon pair. In some embodiments, coherent spatial and/or temporal multiplexing of several non-deterministic sources (referred to herein as “active” multiplexing) can be used to allow the probability of having one mode become occupied during a given cycle to approach 1. One of ordinary skill will appreciate that many different active multiplexing architectures that incorporate spatial and/or temporal multiplexing are possible. For instance, active multiplexing schemes that employ log-tree, generalized Mach-Zehnder interferometers, multimode interferometers, chained sources, chained sources with dump-the-pump schemes, asymmetric multi-crystal single photon sources, or any other type of active multiplexing architecture can be used. In some embodiments, the photon source can employ an active multiplexing scheme with quantum feedback control and the like.

Measurement operations can be implemented by coupling a waveguide to a single-photon detector that generates a classical signal (e.g., a digital logic signal) indicating that a photon has been detected by the detector. Any type of photodetector that has sensitivity to single photons can be used. In some embodiments, detection of a photon (e.g., at the output end of a waveguide) indicates an occupied mode while absence of a detected photon can indicate an unoccupied mode. In some embodiments, a measurement operation is performed in a particular basis (e.g., a basis defined by one of the Pauli matrices and referred to as X, Y, or Z), and mode coupling as described below can be applied to transform a qubit to a particular basis.

Some embodiments described below relate to physical implementations of unitary transform operations that couple modes of a quantum system, which can be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in a Fock notation in which the numbers indicate occupancy of each state), mode coupling can result in a state in which both modes have a nonzero probability of being occupied, e.g., a state a₁|10 [symbol] +a₂|01 [symbol] , where |a₁|²+|a₂|²=1. In some embodiments, operations of this kind can be implemented by using beam splitters to couple modes together and variable phase shifters to apply phase shifts to one or more modes. The amplitudes a₁ and a₂ depend on the reflectivity (or transmissivity) of the beam splitters and on any phase shifts that are introduced.

FIG. 26B shows a schematic diagram 2610 (also referred to as a circuit diagram or circuit notation) for coupling of two modes. The modes are drawn as horizontal lines 2612, 2614, and the mode coupler 2616 is indicated by a vertical line that is terminated with nodes (solid dots) to identify the modes being coupled. In the more specific language of linear quantum optics, the mode coupler 2616 shown in FIG. 26B represents a 50/50 beam splitter that implements a transfer matrix:

$$T = \frac{1}{\sqrt{2}} ( \begin{matrix}1 & i \\ i & 1\end{matrix} ) , \qquad ( 4 )$$

where T defines the linear map for the photon creation operators on two modes. (In certain contexts, transfer matrix T can be understood as implementing a first-order imaginary Hadamard transform.) By convention the first column of the transfer matrix corresponds to creation operators on the top mode (referred to herein as mode 1, labeled as horizontal line 2612), and the second column corresponds to creation operators on the second mode (referred to herein as mode 2, labeled as horizontal line 2614), and so on if the system includes more than two modes. More explicitly, the mapping can be written as:

$${( \begin{matrix}{a}_{1}^{†} \\ {a}_{2}^{†}\end{matrix} )}_{input} ↦ \frac{1}{\sqrt{2}} ( \begin{matrix}1 & - i \\ - i & 1\end{matrix} ) {( \begin{matrix}{a}_{1}^{†} \\ {a}_{2}^{†}\end{matrix} )}_{output} , \qquad ( 5 )$$

where subscripts on the creation operators indicate the mode that is operated on, the subscripts input and output identify the form of the creation operators before and after the beam splitter, respectively and where:

$$\begin{matrix}{a}_{i} \vert {n}_{i} , {n}_{j} 〉 = \sqrt{{n}_{i}} \vert {n}_{i} - 1 , {n}_{j} 〉 \\ {a}_{j} \vert {n}_{i} , {n}_{j} 〉 = \sqrt{{n}_{j}} \vert {n}_{i} , {n}_{j} - 1 〉 \\ {a}_{j}^{†} \vert {n}_{i} , {n}_{j} 〉 = \sqrt{{n}_{j} + 1} \vert {n}_{i} , {n}_{j} + 1 〉\end{matrix} \qquad ( 6 )$$

For example, the application of the mode coupler shown in FIG. 26B leads to the following mappings:

$${a}_{{1}_{input}}^{†} ↦ \frac{1}{\sqrt{2}} ( {a}_{{1}_{output}}^{†} - i {a}_{{2}_{output}}^{†} ) \qquad ( 7 )$$

$${a}_{{2}_{input}}^{†} ↦ \frac{1}{\sqrt{2}} ( - i {a}_{{1}_{output}}^{†} + {a}_{{2}_{output}}^{†} )$$

Thus, the action of the mode coupler described by Eq. (4) is to take the input states |10 [symbol] , |01 [symbol] , and |11 [symbol] to

$$\vert 10 〉 ↦ \frac{\vert 10 〉 - i \vert 01 〉}{\sqrt{2}} \qquad ( 8 )$$

$$\vert 01 〉 ↦ \frac{- i \vert 10 〉 + \vert 01 〉}{\sqrt{2}}$$

$$\vert 11 〉 ↦ \frac{- i}{2} ( \vert 20 〉 + \vert 02 〉 )$$

FIG. 26C shows a physical implementation of a mode coupling that implements the transfer matrix T of Eq. (4) for two photonic modes in accordance with some embodiments. In this example, the mode coupling is implemented using a waveguide beam splitter 2620, also sometimes referred to as a directional coupler or mode coupler. Waveguide beam splitter 2620 can be realized by bringing two waveguides 2622, 2624 into close enough proximity that the evanescent field of one waveguide can couple into the other. By adjusting the separation d between waveguides 2622, 2624 and/or the length l of the coupling region, different couplings between modes can be obtained. In this manner, a waveguide beam splitter 2620 can be configured to have a desired transmissivity. For example, the beam splitter can be engineered to have a transmissivity equal to 0.5 (i.e., a 50/50 beam splitter for implementing the specific form of the transfer matrix T introduced above). If other transfer matrices are desired, the reflectivity (or the transmissivity) can be engineered to be greater than 0.6, greater than 0.7, greater than 0.8, or greater than 0.9 without departing from the scope of the present disclosure.

In addition to mode coupling, some unitary transforms may involve phase shifts applied to one or more modes. In some photonic implementations, variable phase-shifters can be implemented in integrated circuits, providing control over the relative phases of the state of a photon spread over multiple modes. Examples of transfer matrices that define such a phase shifts are given by (for applying a +i and −i phase shift to the second mode, respectively):

$$s = ( \begin{matrix}1 & 0 \\ 0 & i\end{matrix} ) \qquad ( 9 )$$

$${s}^{†} = ( \begin{matrix}1 & 0 \\ 0 & - i\end{matrix} )$$

For silica-on-silicon materials some embodiments implement variable phase-shifters using thermo-optical switches. The thermo-optical switches use resistive elements fabricated on the surface of the chip, that via the thermo-optical effect can provide a change of the refractive index n by raising the temperature of the waveguide by an amount of the order of 10−5 K. One of skill in the art with access to the present disclosure will understand that any effect that changes the refractive index of a portion of the waveguide can be used to generate a variable, electrically tunable, phase shift. For example, some embodiments use beam splitters based on any material that supports an electro-optic effect, so-called χ2 and χ3 materials such as lithium niobite, BBO, KTP, BTO, PZT, and the like and even doped semiconductors such as silicon, germanium, and the like.

### B. Photonic Mode Coupler: Beam Splitters

Beam splitters with variable transmissivity and arbitrary phase relationships between output modes can also be achieved by combining directional couplers and variable phase-shifters in a Mach-Zehnder Interferometer (MZI) configuration 2630, e.g., as shown in FIG. 26D. Complete control over the relative phase and amplitude of the two modes 2632a, 2632b in dual rail encoding can be achieved by varying the phases imparted by phase shifters 2636a, 2636b, and 2636c and the length and proximity of coupling regions 2634a and 2634b. FIG. 26E shows a slightly simpler example of a MZI 2640 that allows for a variable transmissivity between modes 2632a, 2632b by varying the phase imparted by the phase shifter 2637. FIGS. 26D and 26E are examples of how one could implement a mode coupler in a physical device, but any type of mode coupler/beam splitter can be used without departing from the scope of the present disclosure.

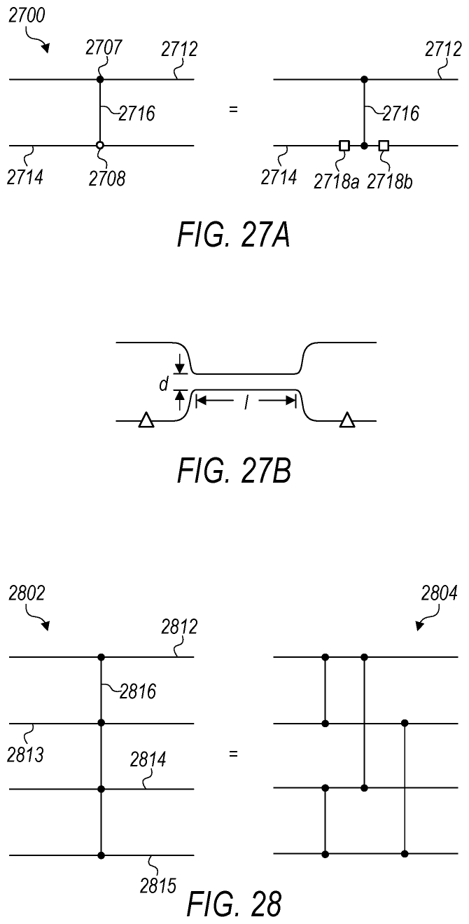

In some embodiments, beam splitters and phase shifters can be employed in combination to implement a variety of transfer matrices. For example, FIG. 27A shows, in a schematic form similar to that of FIG. 26A, a mode coupler 2700 implementing the following transfer matrix:

$${T}_{r} = \frac{1}{\sqrt{2}} ( \begin{matrix}1 & 1 \\ 1 & - 1\end{matrix} ) . \qquad ( 10 )$$

Thus, mode coupler 2700 applies the following mappings:

$$\vert 10 〉 ↦ \frac{\vert 10 〉 + \vert 01 〉}{\sqrt{2}} \qquad ( 11 )$$

$$\vert 01 〉 ↦ \frac{\vert 10 〉 - \vert 01 〉}{\sqrt{2}}$$

$$\vert 11 〉 ↦ \frac{1}{2} ( \vert 20 〉 + \vert 02 〉 ) .$$

The transfer matrix Tᵣ of Eq. (10) is related to the transfer matrix T of Eq. (4) by a phase shift on the second mode. This is schematically illustrated in FIG. 27A by the closed node 2707 where mode coupler 2716 couples to the first mode (line 2712) and open node 2708 where mode coupler 2716 couples to the second mode (line 2714). More specifically, Tᵣ=sTs, and, as shown at the right-hand side of FIG. 27A, mode coupler 2716 can be implemented using mode coupler 2716 (as described above), with a preceding and following phase shift (denoted by open squares 2718a, 2718b). Thus, the transfer matrix Tᵣ can be implemented by the physical beam splitter shown in FIG. 27B, where the open triangles represent +i phase shifters.

### C. Example Photonic Spreading Circuits

Networks of mode couplers and phase shifters can be used to implement couplings among more than two modes. For example, FIG. 28 shows a four-mode coupling scheme that implements a “spreader,” or “mode-information erasure,” transformation on four modes, i.e., it takes a photon in any one of the input modes and delocalizes the photon amongst each of the four output modes such that the photon has equal probability of being detected in any one of the four output modes. (The well-known Hadamard transformation is one example of a spreader transformation.) As in FIG. 26A, the horizontal lines 2812-2815 correspond to modes, and the mode coupling is indicated by a vertical line 2816 with nodes (dots) to identify the modes being coupled. In this case, four modes are coupled. Circuit notation 2802 is an equivalent representation to circuit diagram 2804, which is a network of first-order mode couplings. More generally, where a higher-order mode coupling can be implemented as a network of first-order mode couplings, a circuit notation similar to notation 2802 (with an appropriate number of modes) may be used.

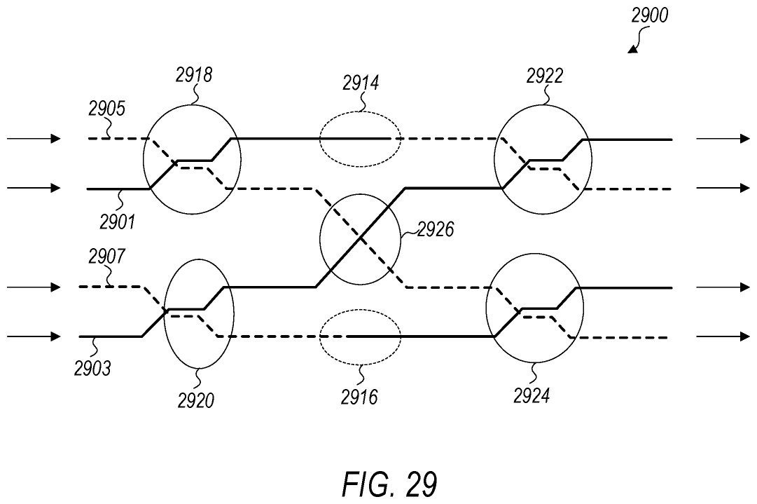

FIG. 29 illustrates an example optical device 2900 that can implement the four-mode mode-spreading transform shown schematically in FIG. 28 in accordance with some embodiments. Optical device 2900 includes a first set of optical waveguides 2901, 2903 formed in a first layer of material (represented by solid lines in FIG. 29) and a second set of optical waveguides 2905, 2907 formed in a second layer of material that is distinct and separate from the first layer of material (represented by dashed lines in FIG. 29). The second layer of material and the first layer of material are located at different heights on a substrate. One of ordinary skill will appreciate that an interferometer such as that shown in FIG. 29 could be implemented in a single layer if appropriate low loss waveguide crossing were employed.

At least one optical waveguide 2901, 2903 of the first set of optical waveguides is coupled with an optical waveguide 2905, 2907 of the second set of optical waveguides with any type of suitable optical coupler. For example, the optical device shown in FIG. 29 includes four optical couplers 2918, 2920, 2922, and 2924. Each optical coupler can have a coupling region in which two waveguides propagate in parallel. Although the two waveguides are illustrated in FIG. 29 as being offset from each other in the coupling region, the two waveguides may be positioned directly above and below each other in the coupling region without offset. In some embodiments, one or more of the optical couplers 2918, 2920, 2922, and 2924 are configured to have a coupling efficiency of approximately 50% between the two waveguides (e.g., a coupling efficiency between 49% and 51%, a coupling efficiency between 49.9% and 50.1%, a coupling efficiency between 49.99% and 50.01%, and a coupling efficiency of 50%, etc.). For example, the length of the two waveguides, the refractive indices of the two waveguides, the widths and heights of the two waveguides, the refractive index of the material located between two waveguides, and the distance between the two waveguides are selected to provide the coupling efficiency of 50% between the two waveguides. This allows the optical coupler to operate like a 50/50 beam splitter.

In addition, the optical device shown in FIG. 29 can include two inter-layer optical couplers 2914 and 2916. Optical coupler 2914 allows transfer of light propagating in a waveguide on the first layer of material to a waveguide on the second layer of material, and optical coupler 2916 allows transfer of light propagating in a waveguide on the second layer of material to a waveguide on the first layer of material. The optical couplers 2914 and 2916 allow optical waveguides located in at least two different layers to be used in a multi-channel optical coupler, which, in turn, enables a compact multi-channel optical coupler.

Furthermore, the optical device shown in FIG. 29 includes a non-coupling waveguide crossing region 2926. In some implementations, the two waveguides (2903 and 2905 in this example) cross each other without having a parallel coupling region present at the crossing in the non-coupling waveguide crossing region 2926 (e.g., the waveguides can be two straight waveguides that cross each other at a nearly 90-degree angle).

Those skilled in the art will understand that the foregoing examples are illustrative and that photonic circuits using beam splitters and/or phase shifters can be used to implement many different transfer matrices, including transfer matrices for real and imaginary Hadamard transforms of any order, discrete Fourier transforms, and the like. One class of photonic circuits, referred to herein as “spreader” or “mode-information erasure (MIE)” circuits, has the property that if the input is a single photon localized in one input mode, the circuit delocalizes the photon amongst each of a number of output modes such that the photon has equal probability of being detected in any one of the output modes. Examples of spreader or MIE circuits include circuits implementing Hadamard transfer matrices. (It is to be understood that spreader or MIE circuits may receive an input that is not a single photon localized in one input mode, and the behavior of the circuit in such cases depends on the particular transfer matrix implemented.) In other instances, photonic circuits can implement other transfer matrices, including transfer matrices that, for a single photon in one input mode, provide unequal probability of detecting the photon in different output modes.

### D. Example Photonic Bell State Generator Circuit

A Bell pair is a pair of qubits in any type of maximally entangled state referred to as a Bell state. For dual rail encoded qubits, examples of Bell states (also referred to as the Bell basis states) include:

$$\vert {Φ}^{+} 〉 = \frac{{{{{\vert 0 〉}_{L} \vert 0 〉}_{L} + \vert 1 〉}_{L} \vert 1 〉}_{L}}{\sqrt{2}} = \frac{\vert 1010 〉 + \vert 0101 〉}{\sqrt{2}}$$

$$\vert {Φ}^{-} 〉 = \frac{{{{{\vert 0 〉}_{L} \vert 0 〉}_{L} - \vert 1 〉}_{L} \vert 1 〉}_{L}}{\sqrt{2}} = \frac{\vert 1010 〉 - \vert 0101 〉}{\sqrt{2}}$$

$$\vert {Ψ}^{+} 〉 = \frac{{{{{\vert 0 〉}_{L} \vert 1 〉}_{L} + \vert 1 〉}_{L} \vert 0 〉}_{L}}{\sqrt{2}} = \frac{\vert 1001 〉 + \vert 0110 〉}{\sqrt{2}}$$

$$\vert {Ψ}^{-} 〉 = \frac{{{{{\vert 0 〉}_{L} \vert 1 〉}_{L} - \vert 1 〉}_{L} \vert 0 〉}_{L}}{\sqrt{2}} = \frac{\vert 1001 〉 - \vert 0110 〉}{\sqrt{2}}$$

In a computational basis (e.g., logical basis) with two states, a Greenberger-Horne-Zeilinger state is a quantum superposition of all qubits being in a first state of the two states superposed with all of qubits being in a second state. Using logical basis described above, the general M-qubit GHZ state can be written as:

$$\vert GHZ 〉 = \frac{{{\vert 0 〉}^{⊗ M} + \vert 1 〉}^{⊗ M}}{\sqrt{2}}$$

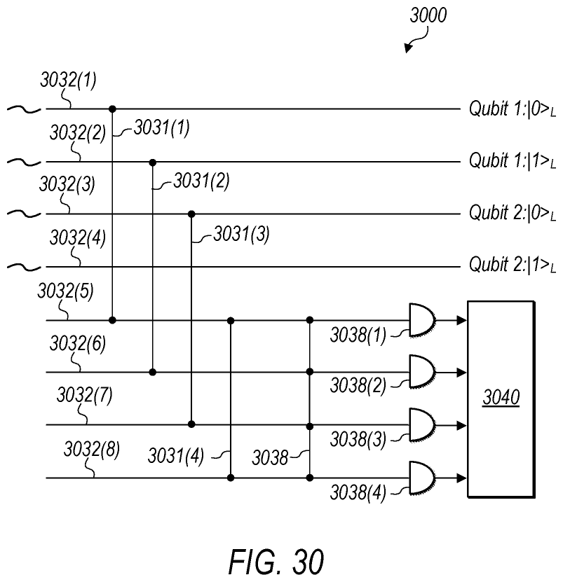

In some embodiments, entangled states of multiple photonic qubits can be created by coupling modes of two (or more) qubits and performing measurements on other modes. By way of example, FIG. 30 shows a circuit diagram for a Bell state generator 3000 that can be used in some dual-rail-encoded photonic embodiments. In this example, modes 3032(1)-3032(4) are initially each occupied by a photon (indicated by a wavy line); modes 3032(5)-3032(8) are initially vacuum modes. (Those skilled in the art will appreciate that other combinations of occupied and unoccupied modes can be used.)

A first-order mode coupling (e.g., implementing transfer matrix T of Eq. (4)) is performed on pairs of occupied and unoccupied modes as shown by mode couplers 3031(1)-3031(4). Thereafter, a mode-information erasure coupling (e.g., implementing a four-mode mode spreading transform as shown in FIG. 13) is performed on four of the modes (modes 3032(5)-3032(8)), as shown by mode coupler 3037. Modes 3032(5)-3032(8) act as “heralding” modes that are measured and used to determine whether a Bell state was successfully generated on the other four modes 3032(1)-3032(4). For instance, detectors 3038(1)-3038(4) can be coupled to the modes 3032(5)-3032(8) after second-order mode coupler 3037. Each detector 3038(1)-3038(4) can output a classical data signal (e.g., a voltage level on a conductor) indicating whether it detected a photon (or the number of photons detected). These outputs can be coupled to classical decision logic circuit 3040, which determines whether a Bell state is present on the other four modes 3032(1)-3032(4) based on the classical output data. For example, decision logic circuit 3040 can be configured such that a Bell state is confirmed (also referred to as “success” of the Bell state generator) if and only if a single photon was detected by each of exactly two of detectors 3038(1)-3038(4). Modes 3032(1)-3032(4) can be mapped to the logical states of two qubits (Qubit 1 and Qubit 2), as indicated in FIG. 30. Specifically, in this example, the logical state of Qubit 1 is based on occupancy of modes 3032(1) and 3032(2), and the logical state of Qubit 2 is based on occupancy of modes 3032(3) and 3032(4). It should be noted that the operation of Bell state generator 3000 can be non-deterministic; that is, inputting four photons as shown does not guarantee that a Bell state will be created on modes 3032(1)-3032(4). In one implementation, the probability of success is 4/32.

In some embodiments, it is desirable to form resource states of multiple entangled qubits (typically 3 or more qubits, although the Bell state can be understood as a resource state of two qubits). One technique for forming larger entangled systems is through the use of a “fusion” gate. A fusion gate receives two input qubits, each of which is typically part of an entangled system. The fusion gate performs a “fusion” operation on the input qubits that produces either one (“type I fusion”) or zero (“type II fusion”) output qubits in a manner such that the initial two entangled systems are fused into a single entangled system. Fusion gates are specific examples of a general class of two-particle projective measurements that can be employed to create entanglement between qubits and are particularly suited for photonic architectures. Examples of type I and type II fusion gates will now be described.

### E. Examples of Fusion Gate Photonic Circuits

FIGS. 31-36 show some embodiments of photonic circuit implementation of fusion gates, or fusion circuits, for photonic qubits that can be used according to some embodiments using Type II fusion. It should be understood that these example embodiments are illustrative and not limiting. More generally, as used herein, the term “fusion gate” refers a device that can implement a two-particle projective measurement, e.g., a Bell projection which, depending on the Bell basis chosen, can measure two operators e.g., the operators XX, ZZ, the operators XX, ZY, and the like. A Type II fusion circuit (or gate), in the polarization encoding, takes two input modes, mixes them at a polarization beam splitter (PBS) and then rotates each of them by 45 degrees before measuring them in the computational basis. FIG. 31 shows an example. In the path encoding, a Type II fusion circuit takes four modes, swaps the second and fourth, applies a 50:50 beamsplitter between the two pairs of adjacent modes and then detects them all. FIG. 32 shows an example.

Fusion gates can be used in the construction of larger entangled states by making use of the so-called “redundant encoding: of qubits. This consists in a single qubit being represented by multiple photons, i.e.

$${{α \vert 0 〉 + β \vert 1 〉 \to α \vert 0 〉}^{⊗ n} + β \vert 0 〉}^{⊗ n} ,$$

so that the logical qubit is encoded in n individual qubits. This is achieved by measuring adjacent qubits in the X basis.

This encoding, denoted graphically as n qubits with no edges between them (as in diagram (b) of FIG. 33), has the advantage that a Pauli measurement on the redundant qubits does not split the cluster, but rather removes the photon measured from the redundant encoding and combine the adjacent qubits into one single qubit that inherits the bonds of the input qubits, maybe adding a phase. In addition, another advantage of this type of fusion is that it is loss tolerant. Both modes are measured, so there is no way to obtain the detection patterns that herald success if one of the photons is lost. Finally, Type II fusion does not require the discrimination between different photon numbers, as two detectors need to click for the heralding of successful fusion and this can only happen if the photon count at each detector is 1.

The fusion succeeds with probability 50%, when a single photon is detected at each detector in the polarization encoding. In this case, it effectively performs a Bell state measurement on the qubits that are sent through it, projecting the pair of logical qubits into a maximally entangled state. When the gate fails (as heralded by zero or two photons at one of the detectors), it performs a measurement in the computational basis on each of the photons, removing them from the redundant encoding, but not destroying the logical qubit. The effect of the fusion in the generation of the cluster is depicted in FIG. 33, where (a) shows the measurement of a qubit in the linear cluster in the X basis to join it with its neighbor into a single logical qubit, and (c) and (c′) show the effect that success and failure of the gate have on the structure of the cluster. It can be seen that a successful fusion allows to build two-dimensional clusters.

A correspondence can be retrieved between the detection patterns and the Kraus operators implemented by the gate on the state. In this case, since both qubits are detected, these are the projectors:

$${h}_{1} {h}_{2} , {v}_{1} {v}_{2} \to \frac{{h}_{1} {h}_{2} + {v}_{1} {v}_{2}}{\sqrt{2}}$$

$${h}_{1} {v}_{2} , {v}_{1} {h}_{2} \to \frac{{h}_{1} {h}_{2} - {v}_{1} {v}_{2}}{\sqrt{2}}$$

$${h}_{1}^{2} , {v}_{1}^{2} \to \pm {h}_{1} {v}_{2}$$

$${h}_{2}^{2} , {v}_{2}^{2} \to \pm {v}_{1} {h}_{2} ,$$

where the first two lines correspond to ‘success’ outcomes, projecting the two qubits into a Bell state, and the bottom two to ‘failure’ outcomes, in which case the two qubits are projected into a product state.

In some embodiments, the success probability of Type II fusion can be increased by using ancillary Bell pairs or pairs of single photons. Employing a single ancilla Bell pair or two pairs of single photons allows to boost the success probability to 75%.

One technique used to boost the fusion gate comes from the realization that, when it succeeds, it is equivalent to a Bell state measurement on the input qubits. Therefore, increasing the success probability of the fusion gate corresponds to increasing that of the Bell state measurement it implements. Two different techniques to improve the probability of discriminating Bell states have been developed by Grice (using a Bell pair) and Ewert & van Loock (https://arxiv.org/pdf/1403.4841.pdf) (using single photons).

The former showed that an ancillary Bell pair allows to achieve a success probability of 75%, and the procedure can be iterated, using increasingly complex interferometers and large entangled states, to reach arbitrary success probability, in theory. However, the complexity of the circuit and the size of the entangled states necessary may make this impractical.

The second technique makes use of four single photons, input in two modes in pairs with opposite polarization, to boost the probability of success to 75%. It has also been shown numerically that the procedure can be iterated a second time to obtain a probability of 78.125%, but it has not been shown to be able to increase the success rate arbitrarily as the other scheme.

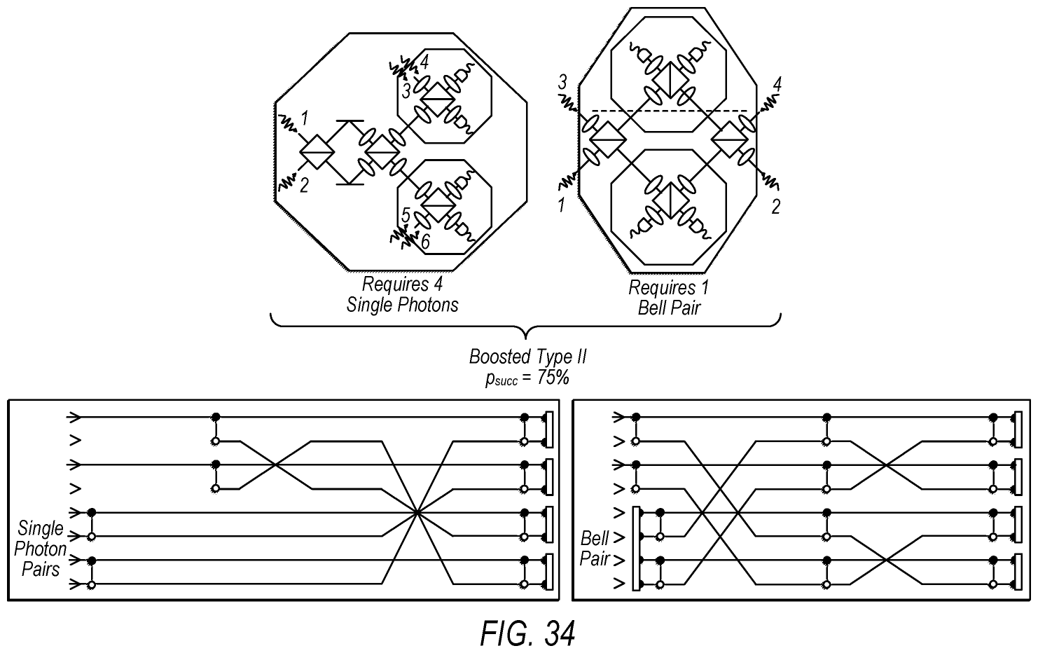

FIG. 34 shows the Type II fusion gate boosted once using these two techniques, both in polarization and path encoding. The success probability of both circuits is 75%.

The detection patterns that herald success of the fusion are described below for the two types of circuit.

When a Bell state is used to boost the fusion, the logic behind the ‘success’ detection patterns is best understood by considering the detectors in two pairs: the group corresponding to the input photon modes (modes 1 and 2 in polarization and the top 4 modes in path-encoding) and that corresponding to the Bell pair input modes (modes 3 and 4 in polarization and the bottom 4 modes in path-encoding). Call these the ‘main’ and ‘ancilla’ pairs respectively. Then a successful fusion is heralded whenever: (a) 4 photons are detected in total; and (b) fewer than 4 photons are detected in each group of detectors.

When 4 single photons are used as ancillary resources, success of the gate is heralded whenever: (a) 6 photons are detected overall; and (b) fewer than 4 photons are detected at each detector.

When the gates succeeds, the two input qubits are projected onto one of the four Bell pairs, as these can be all discriminated from each other thanks to the use of the ancillary resources. The specific projection depends on the detection pattern obtained, as before.

Both the boosted Type II fusion circuits, designed to take one Bell pair and four single photons as ancillae respectively, can be used to perform Type II fusion with variable success probabilities, if the ancillae are not present or if only some of them are (in the case of the four single photon ancillae). This is particularly useful because it allows to employ the same circuits to perform fusion in a flexible way, depending on the resources available. If the ancillae are present, they can be input in the gates to boost the probability of success of the fusion. If they are not, however, the gates can still be used to attempt fusion with a lower but non-zero success probability.

As far as the fusion gate boosted using one Bell pair is concerned, the only case to be considered is that of the ancilla being absent. In this case, the logic of the detection patterns heralding success can be understood by considering the detectors in the pairs described above again. The fusion is still successful when: (a) 2 photons are detected at different detectors; and (b) 1 photon is detected in the ‘principal’ pair and 1 photon is detected in the ‘ancilla’ pair of detectors.

In the case of the circuit boosted using four single photons, multiple modifications are possible, removing all or part of the ancillae. This is analogous to the Boosted Bell State Generator, which is based on the same principle.

First consider the case of no ancillae being present at all. As expected, the fusion is successful with probability 50%, which is the success rate of the non-boosted fusion. In this case, the fusion is successful whenever 2 photons are detected at any two distinct detectors.

As for the boosted BSG, the presence of an odd number of ancillae turns out to be detrimental to the success probability of the gate: if 1 photon is present, the gate only succeeds 32.5% of the time, whereas if 3 photons are present, the success probability is 50%, like the non-boosted case.

If only two of the four ancillae are present, two effects are possible.

If they are input in different modes in the polarization encoding, i.e. different adjacent pairs of ancillary modes in the path encoding, the probability of success is lowered to 25%.

However, if the two ancillae are input in the same polarization mode, i.e. in the same pair of adjacent modes in the path encoding, the success probability is boosted up to 62.5%. In this case, the patterns that herald success can be understood again by grouping the detectors in two pairs: the pair in the branch of the circuit where the ancillae are input (group 1) and the pair in the other branch (group 2). This distinction is particularly clear in the polarization-encoded diagram. Considering these groups, the fusion if successful when: (a) 4 photons are detected overall; (b) fewer than 4 photons are detected at each detector in group 1; and (c) fewer than 2 photons are detected at each detector in group 2.

In these examples, the fusion gates work by projecting the input qubits into a maximally entangled state when successful. The basis such a state is encoded in can be changed by introducing local rotations of the input qubits before they enter the gate, i.e. before they are mixed at the PBS in the polarization encoding. Changing the polarization rotation of the photons before they interfere at the PBS yields different subspaces onto which the state of the photons is projected, resulting in different fusion operations on the cluster states. In the path encoding, this corresponds to applying local beamsplitters or combinations of beamsplitters and phase shifts corresponding to the desired rotation between the pairs of modes that constitute a qubit (neighboring pairs in the diagrams above).

This can be useful to implement different types of cluster operations, both in the success and the failure cases, which can be very useful to optimize the construction of a big cluster state from small entangled states.

FIG. 35 shows a table with the effects of a few rotated variations of the Type II fusion gate used to fuse two small entangled states. The diagram of the gate in the polarization encoding, the effective projection performed and the final effect on the cluster state are shown.

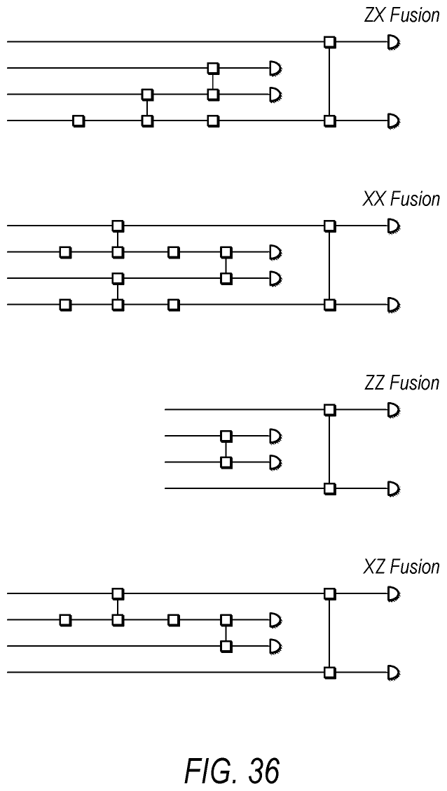

Rotation to different basis states is further illustrated in FIG. 36, which shows examples of photonic circuits for Type II fusion gate implementations using a path encoding. Shown are fusion gates for ZX fusion, XX fusion, ZZ fusion, and XZ fusion. In each instance a combination of beam splitters and phase shifters (e.g., as described above) can be used.

Those skilled in the art with access to this disclosure will appreciate that embodiments described herein are illustrative and not limiting and that many modifications and variations are possible. The measurements performed and the states on which they act can be chosen such that the measurement outcomes have redundancies that give rise to fault tolerance. For instance, a code can be directly entered with the measurements, or correlations can be generated in the measurements that directly deal with both the destructiveness of the measurement and the entanglement breaking nature of the measurement in a fault tolerant manner. This can be handled as part of the classical decoding; for instance, failed fusion operations can be dealt with as erasure by the code.

With reference to the appended figures, components that can include memory can include non-transitory machine-readable media. The terms “machine-readable medium” and “computer-readable medium” as used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, compact disc read-only memory (CD-ROM) or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A system comprising:
a first input coupled to a first qubit and a first switch, wherein the first switch includes a first output, a second output, and a third output;
a first single qubit measuring device coupled to the first output of the first switch;
a second single qubit measuring device coupled to a first output of a second switch;
a first two qubit measuring device coupled to the second output of the first switch and a second output of the second switch; and
a second two qubit measuring device coupled to the third output of the first switch and a third output of the second switch.

2. The system of claim 1, further comprising a fusion network controller circuit that is coupled to the first and second switch.

3. The system of claim 1, further comprising a decoder coupled to an output of the first single qubit measuring device, an output of the second single qubit measuring device, an output of the first two qubit measuring device, and an output of the second two qubit measuring device.

4. The system of claim 1, wherein the first qubit is entangled with one or more other qubits as part of a first resource state and the second qubit is entangled with one or more other qubits as part of a second resource state, wherein none of the qubits from the first resource state are entangled with any of the qubits from the second resource state.

5. The system of claim 1, wherein the first and second two qubit measuring device are configured to perform destructive joint measurements on the first qubit and the second qubit and to output classical information representing joint measurement outcomes.

6. The system of claim 1 wherein the first qubit and the second qubit are photonic qubits.

7. The system of claim of claim 6, wherein the coupling between the first and second qubits and the first and second switched includes a plurality of photonic waveguides.

8. The system of claim 1, wherein the first single qubit measuring device is configured to measure the first qubit in a Z basis.

9. The system of claim 1, wherein the second single qubit measuring device is configured to measure the second qubit in a Z basis.

10. The system of claim 1, wherein the first two qubit measuring device is configured to perform a projective Bell measurement between the first qubit and the second qubit.

11. The system of claim 1, wherein the second two qubit measuring device is configured to perform a projective Bell measurement between the first qubit and the second qubit.

12. The system of claim 10, wherein the projective Bell measurement is a linear optical Type II fusion measurement.

13. The system of claim 11, wherein the projective Bell measurement is a linear optical Type II fusion measurement.
